(19) United States
(12) Patent Application Publication
(10) Pub. No.: US 2021/0368139 A1
(43) Pub. Date: Nov. 25, 2021

(54) MONITORING SYSTEM, MONITORING SENSOR APPARATUS, MONITORING METHOD, AND PROGRAM

(71) Applicant: SONY CORPORATION, TOKYO (JP)

(72) Inventors: KYOKO ISHIDA, TOKYO (JP); TAKESHI MASUURA, KANAGAWA (JP)

(21) Appl. No.: 16/341,612

(22) PCT Filed: Nov. 1, 2017
(86) PCT No.: PCT/JP2017/039469

§ 371 Date: Apr. 12, 2019

(30) Foreign Application Priority Data
Nov. 14, 2016 (JP) 2016-221354

(51) Int. Cl. H04N 7/18; H04N 5/235; G06T 7/00; H04N 17/00; G06K 9/00; G08B 21/02

(52) U.S. Cl. CPC H04N 7/183; H04N 5/2354; G06T 7/0002; H04N 5/2351; G06T 7/97; G06T 2207/20021; G06K 9/00771; G08B 21/02; G06T 2207/30232; G06T 2207/10048; H04N 17/002

(57) ABSTRACT

The present technology relates to a monitoring system, a monitoring sensor apparatus, a monitoring method and a program that make it possible to detect a failure of IR illumination on the basis of picked up images. The monitoring sensor apparatus according to an aspect of the present technology includes an infrared light irradiation section irradiating infrared light to a range within which a monitoring target is capable of existing, an imaging section having sensitivity to the infrared light and imaging the range within which the monitoring target is capable of existing, a detection section detecting a state of the monitoring target based on the picked up image, a first transmission controlling section controlling presence or absence of execution of first transmission operation for transmitting a result of the detection to a different apparatus, a second transmission controlling section controlling presence or absence of execution of second transmission operation for transmitting the picked up image to the different apparatus, and a failure detection section detecting a failure of the infrared light irradiation section based on a comparison result when a plurality of picked up images are compared in a state in which execution of the second transmission operation is stopped by the second transmission controlling section. The present technology can be applied to a monitoring system installed in elderly care facilities or like facilities.

### TECHNICAL FIELD

The present technology relates to a monitoring system, a monitoring sensor apparatus, a monitoring method, and a program, and particularly to a monitoring system, a monitoring sensor apparatus, a monitoring method, and a program suitable for use in the case where monitoring is performed on the basis of images picked up by projecting infrared light (hereinafter referred to as IR light), which is invisible light, to an imaging range.

### BACKGROUND ART

For example, in elderly care facilitates or like facilities, in order for a monitoring person (a caregiver, a user of a nursing care system or a like person) to watch over a state (at bedtime, getting up, sitting down, toppling over, entering the room, leaving, in the bathroom or the like) of a monitoring target person (care receiver), a monitoring system is sometimes introduced in which a camera is installed in a room of a care receiver to image the care receiver and a moving image obtained by imaging the care receiver is transmitted to and displayed on a display apparatus a caregiver watches. The monitoring system performs imaging by projecting IR light of invisible light such that it may not interfere with sleep of the care receiver at night or the like when the illumination in the room of the care receiver is not on (for example, refer to PTL 1).

### CITATION LIST

### Patent Literature

[PTL 1]

Japanese Patent Laid-Open No. 1999-341474

### SUMMARY

### Technical Problem

The present technology makes it possible in such a monitoring system as described above to protect the privacy of a care receiver higher than a conventional monitoring system while the state of a monitoring target person is monitored. Further, the present technology makes it possible in a monitoring system protecting the privacy of a care receiver higher in this manner to detect, in a case where a failure occurs with an illumination section of the monitoring system, the failure and notify the failure to a monitoring person or a like person. Furthermore, the present technology makes it possible to detect a failure of the illumination section of the monitoring system correctly even if the environment in which the monitoring system is used or a condition of an imaging object changes.

### Solution to Problem

According to a first aspect of the present technology, there is provided a monitoring system including a monitoring sensor apparatus, a terminal apparatus presenting information acquired by the monitoring sensor apparatus to a user, and an external apparatus interposed between the monitoring sensor apparatus and the terminal apparatus. The monitoring sensor apparatus includes an infrared light irradiation section irradiating infrared light to a range within which a monitoring target is capable of existing, an imaging section having sensitivity to the infrared light and imaging the range within which the monitoring target is capable of existing under the irradiation of the infrared light by the infrared light irradiation section, a detection section detecting a state of the monitoring target based on the image picked up by the imaging section, a third transmission controlling section including a first transmission controlling section that controls presence or absence of execution of first transmission operation for transmitting a result of the detection by the detection section to the external apparatus or the terminal apparatus and a second transmission controlling section that controls presence or absence of execution of second transmission operation for transmitting the image picked up by the imaging section to the external apparatus or the terminal apparatus, and a failure detection section detecting a failure of the infrared light irradiation section based on a plurality of images picked up by the imaging section in a state in which execution of the second transmission operation is stopped by the second transmission controlling section.

The third transmission controlling section can further control presence or absence of execution of operation for transmitting a result of the failure detection by the failure detection section to the external apparatus or the terminal apparatus.

The monitoring sensor apparatus can further include an imaging controlling section performing at least one of control for activating or deactivating the imaging operation by the imaging section, control of an imaging condition when the imaging is to be performed by the imaging section, or control of a condition for an image process when the image process is to be performed for the picked up image.

The monitoring sensor apparatus can have a structure that inputs information from the imaging controlling section to the failure detection section.

The failure detection section of the monitoring sensor apparatus can detect a failure of the infrared light irradiation section based on information from the imaging controlling section.

The monitoring sensor apparatus can further include a stable image generation section, and the stable image generation section can compare, in regard to a plurality of picked up images included in a picked up image stream picked up for a fixed period by the imaging section, a change of imaging objects in the picked up images between the images and output a stable image that is an image including an imaging object that indicates a smaller amount of change.

The imaging controlling section can perform control of an imaging condition when the imaging section performs imaging and besides the failure detection section can compare, between a plurality of stable images outputted from the stable image generation section, imaging conditions when image pickup of each of images included in a picked up image stream on which the stable images are based is performed and detect a failure of the infrared light irradiation section based on a result of the comparison, or the imaging controlling section can perform control of an image processing condition when an image process is applied to an image picked up by the imaging section and besides the failure detection section can compare, between a plurality of stable images outputted from the stable image generation section, conditions of the image process applied to each of images included in a picked up image stream on which the stable images are based and detect a failure of the infrared light irradiation section based on a result of the comparison.

The imaging controlling section can perform control of an imaging condition when the imaging section performs imaging and besides the failure detection section can detect that a failure occurs with the infrared light irradiation section in a case where, between a plurality of stable images outputted from the stable image generation section, an imaging condition when image pickup of each of images included in a picked up image stream on which the stable images are based is performed changes in a direction suitable for an imaging object of lower illuminance, or the imaging controlling section can perform control of an image processing condition when an image process is applied to an image picked up by the imaging section and besides the failure detection section can detect that a failure occurs with the infrared light irradiation section in a case where, between a plurality of stable images outputted from the stable image generation section, a condition for the image process applied to each of images included in a picked up image stream on which the stable images are based changes in a direction suitable for an imaging object of lower illuminance.

The failure detection section can detect a failure of the infrared light irradiation section based on a result when, between a first plurality of stable images outputted from the stable image generation section, brightness of the first plurality of stable images are compared or on a result when each of the first plurality of stable images outputted from the stable image generation section is divided into a second plurality of subdivision regions and, for each of the second plurality of subdivision regions, brightness of images included in the subdivision region are compared.

The failure detection section can detect that a failure occurs with the infrared light irradiation section in a case where, between a first plurality of stable images outputted from the stable image generation section, brightness of the first plurality of stable images are compared and a result of the comparison indicates that a difference of an indicator representative of the brightness is greater than a threshold value determined in advance or in a case where each of the first plurality of stable images outputted from the stable image generation section is divided into a second plurality of subdivision regions and, for each of the second plurality of subdivision regions, brightness of images included in the subdivision region are compared, and a result of the comparison indicates that a difference of the indicator representative of the brightness is greater than a threshold value determined in advance.

The failure detection section can detect that a failure occurs with the infrared light irradiation section in a case where, in regard to a stable image outputted from the stable image generation section, a value of the indicator representative of the brightness of the stable image is lower than a threshold value determined in advance.

The failure detection section can detect, based on a result when values of the indicator representative of the brightness of stable images outputted by the stable image generation section are compared with a first threshold value determined in advance, a comparison result when, between a plurality of stable images outputted by the stable image generation section, the brightness of the plurality of stable images are compared, and a comparison result when, between the plurality of stable images for which the comparison is to be performed, an imaging condition of each of images included in a picked up image stream on which the plurality of stable images are based or a condition for an image process when the image process is applied to each of the images is compared, that a failure occurs with the infrared light irradiation section in any of

A) a case where the value of the indicator indicative of the brightness of each of the stable images is lower than the first threshold value determined in advance,

B) a case where at least one of the imaging condition of each of the images or the condition for the image process is changing in a direction suitable for an imaging object of lower illuminance, and

C) a case where a result when the values of the indicator representative of the brightness of the stable images are compared indicates that a difference of the indicator representative of the brightness is greater than a second threshold value determined in advance and besides any of the imaging condition of each of the images and the condition for the image process is not changing in a direction suitable for an imaging object of higher illuminance.

The monitoring sensor apparatus can further include a characteristic comparison section extracting, from each of the stable images, a characteristic of an imaging object in the stable image and comparing the characteristic between a plurality of the stable images.

The characteristic of the imaging object can be a contour of the imaging object.

The failure detection section can detect, based on a result when values of the indicator representative of the brightness of stable images outputted by the stable image generation section are compared with a first threshold value determined in advance, a comparison result when, between a plurality of stable images outputted by the stable image generation section, the brightness of the plurality of stable images are compared, a comparison result when, between the plurality of stable images for which the comparison is to be performed, an imaging condition of each of images included in a picked up image stream on which the plurality of stable images are based or a condition for an image process when the image process is applied to each of the images is compared, and a result when, from each of the stable images, a characteristic of an imaging object in the stable image is extracted and the characteristic is compared between the plurality of stable images, that a failure occurs with the infrared light irradiation section in a case where at least one of conditions (A) to (C) given below is satisfied:

condition (A) the value of the indicator indicative of the brightness of each of the stable images is lower than the first threshold value determined in advance;

condition (B) at least one of the imaging condition of each of the images or the condition for the image process is changing in a direction suitable for an imaging object of lower illuminance; and

condition (C) a result when the values of the indicator representative of the brightness of the stable images are compared indicates that a difference of the indicator representative of the brightness is greater than a second threshold value determined in advance and besides any of the imaging condition of each of the images and the condition for the image process is not changing in a direction suitable for an imaging object of higher illuminance and the difference of the indicator representative of the brightness does not arise from a change of a characteristic point of the stable images.

The monitoring sensor apparatus can further include a change detection section detecting how much time is required for occurrence of a change of the imaging object, which occurs between a latest stable image and a second latest stable image outputted from the stable image generation section.

The failure detection section can detect, based on a result when values of the indicator representative of the brightness of stable images outputted by the stable image generation section are compared with a first threshold value determined in advance, a comparison result when, between a plurality of stable images outputted by the stable image generation section, the brightness of the plurality of stable images are compared, a comparison result when, between the plurality of stable images for which the comparison is to be performed, an imaging condition of each of images included in a picked up image stream on which the plurality of stable images are based or a condition for an image process when the image process is applied to each of the images is compared, and a result when it is detected how much time is required for occurrence of a change of the imaging object, which occurs between the latest stable image and the second latest stable image outputted from the stable image generation section and the time is compared with a threshold value for a period of time for a change determined in advance, that a failure occurs with the infrared light irradiation section in a case where at least one of conditions (A) to (C) given below is satisfied:

condition (A) the value of the indicator indicative of the brightness of each of the stable images is lower than the first threshold value determined in advance;

condition (B) at least one of the imaging condition of each of the images or the condition for the image process is changing in a direction suitable for an imaging object of lower illuminance; and condition (C) a result when the values of the indicator representative of the brightness of the stable images are compared indicates that a difference of the indicator representative of the brightness is greater than a second threshold value determined in advance and besides any of the imaging condition of each of the images and the condition for the image process is not changing in a direction suitable for an imaging object of higher illuminance and a change of an imaging object occurring between the latest stable image and the second latest stable image occurs in a shorter period of time than the threshold value for the change time.

In the first aspect of the present technology, a range within which a monitoring target is capable of existing under irradiation of infrared light is imaged by the monitoring sensor apparatus, and a state of the monitoring target is detected on the basis of the picked up image. Then, in a state in which execution of second transmission operation for transmitting the picked up image to the external apparatus or the terminal apparatus is stopped, a failure of the infrared light irradiation section is detected on the basis of a plurality of picked up images.

According to a second aspect of the present technology, there is provided a monitoring sensor apparatus including an infrared light irradiation section irradiating infrared light to a range within which a monitoring target is capable of existing, an imaging section having sensitivity to the infrared light and imaging the range within which the monitoring target is capable of existing under the irradiation of the infrared light by the infrared light irradiation section, a detection section detecting a state of the monitoring target based on the image picked up by the imaging section, a first transmission controlling section controlling presence or absence of execution of first transmission operation for transmitting a result of the detection by the detection section to a different apparatus, a second transmission controlling section controlling presence or absence of execution of second transmission operation for transmitting the image picked up by the imaging section to the different apparatus, and a failure detection section detecting a failure of the infrared light irradiation section based on a comparison result when a plurality of images picked up by the imaging section are compared in a state in which execution of the second transmission operation is stopped by the second transmission controlling section.

According to the second aspect of the present technology, there is further provided a monitoring method of a monitoring sensor apparatus, including, by the monitoring sensor apparatus, an infrared light irradiation step of irradiating infrared light to a range within which a monitoring target is capable of existing, an imaging step of having sensitivity to the infrared light and imaging the range within which the monitoring target is capable of existing under the irradiation of the infrared light by the infrared light irradiation section, a detection step of detecting a state of the monitoring target based on the image picked up by the imaging step, a first transmission controlling step of controlling presence or absence of execution of first transmission operation for transmitting a result of the detection by the detection section to a different apparatus, a second transmission controlling step of controlling presence or absence of execution of second transmission operation for transmitting the image picked up by the imaging section to the different apparatus, and a failure detection step of detecting a failure of the infrared light irradiation section based on a comparison result when a plurality of images picked up by the imaging step are compared in a state in which execution of the second transmission operation is stopped by the second transmission controlling step.

According to the second aspect of the present technology, there is further provided a program causing a computer to function as an infrared light irradiation section irradiating infrared light to a range within which a monitoring target is capable of existing, an imaging section having sensitivity to the infrared light and imaging the range within which the monitoring target is capable of existing under the irradiation of the infrared light by the infrared light irradiation section, a detection section detecting a state of the monitoring target based on the image picked up by the imaging section, a first transmission controlling section controlling presence or absence of execution of first transmission operation for transmitting a result of the detection by the detection section to a different apparatus, a second transmission controlling section controlling presence or absence of execution of second transmission operation for transmitting the image picked up by the imaging section to the different apparatus, and a failure detection section detecting a failure of the infrared light irradiation section based on a comparison result when a plurality of images picked up by the imaging section are compared in a state in which execution of the second transmission operation is stopped by the second transmission controlling section.

In the second aspect of the present technology, a range within which a monitoring target is capable of existing under irradiation of infrared light is imaged, and a state of the monitoring target is detected on the basis of the picked up image. Then, in a state in which execution of second transmission operation for transmitting the picked up image to the external apparatus or the terminal apparatus is stopped, a failure of the infrared light irradiation section is detected on the basis of a plurality of picked up images.

### Advantageous Effects of Invention

With the first and second aspects of the present technology, the privacy of a care receiver who is a monitoring target person or the like can be protected more assuredly while the state of the care receiver is monitored.

Further, with the first and second aspect of the present technology, in a case where a failure occurs with the illumination section, the failure can be notified to a caregiver or a like person.

### BRIEF DESCRIPTION OF DRAWINGS

FIG. 1 is a view depicting a configuration example of a monitoring system according to an embodiment of the present technology.

FIG. 2 is a view depicting an example of installation of a monitoring sensor apparatus.

FIG. 3 is a view depicting a configuration example of a front appearance of the monitoring sensor apparatus.

FIG. 4 is a view depicting an example of installation in the case where an IR illumination section is separated.

FIG. 5 is a block diagram depicting a first embodiment of the monitoring sensor apparatus.

FIG. 6 is a view illustrating a modification to the first embodiment of the monitoring sensor apparatus.

FIG. 7 is a block diagram depicting a second embodiment of the monitoring sensor apparatus.

FIG. 8 is a view illustrating a case in which a failure of the IR illumination section is overlooked and a case in which it is decided in error that a failure occurs with the IR illumination section.

FIG. 9 is a block diagram depicting a third embodiment of the monitoring sensor apparatus.

FIG. 10 is a view illustrating a problem of an IR illumination failure detection section in the first and second embodiments.

FIG. 11 is a view illustrating the problem of the IR illumination failure detection section in the first and second embodiments.

FIG. 12 is a view illustrating the problem of the IR illumination failure detection section in the first and second embodiments.

FIG. 13 is a view illustrating a method of creating a stable image from a picked up image stream.

FIG. 14 is a view illustrating the method of creating a stable image from a picked up image stream.

FIG. 15 is a view illustrating the method of creating a stable image from a picked up image stream.

FIG. 16 is a view illustrating the method of creating a stable image from a picked up image stream.

FIG. 17 is a view illustrating the method of creating a stable image from a picked up image stream.

FIG. 18 is a view illustrating the method of creating a stable image from a picked up image stream.

FIG. 19 is a view illustrating the method of creating a stable image from a picked up image stream.

FIG. 20 is a view illustrating the method of creating a stable image from a picked up image stream.

FIG. 21 is a view illustrating the method of creating a stable image from a picked up image stream.

FIG. 22 is a view depicting a first example of a stable image.

FIG. 23 is a view depicting a second example of a stable image.

FIG. 24 is a block diagram depicting a first configuration example of a failure decision section.

FIG. 25 is a view illustrating operation of the failure decision section.

FIG. 26 is a view illustrating operation of the failure decision section.

FIG. 27 is a block diagram depicting a second configuration example of the failure decision section.

FIG. 28 is a view illustrating differences of image comparison by an image comparison section and a characteristic comparison section of the second configuration example.

FIG. 29 is a view illustrating differences of image comparison by the image comparison section and the characteristic comparison section of the second configuration example.

FIG. 30 is a block diagram depicting a third configuration example of the failure decision section.

FIG. 31 is a view illustrating a state change of an imaging object.

FIG. 32 is a view illustrating a change of the emission light amount of a light source.

FIG. 33 is a flow chart illustrating a process for generating first and second picked up images.

FIG. 34 is a flow chart illustrating a process for generating a picked up image by removing a moving imaging object.

FIG. 35 is a flow chart illustrating a process for generating a stable image.

FIG. 36 is a flow chart illustrating a process for deciding whether or not there is a failure on the basis of the brightness of an image.

FIG. 37 is a flow chart illustrating a report failure countermeasure process.

FIG. 38 is a flow chart illustrating a misinformation countermeasure process.

FIG. 39 is a flow chart illustrating a process for deciding whether or not there is a failure on the basis of time dependent deterioration.

FIG. 40 is a flow chart illustrating a process for deciding whether or not there is a failure on the basis of an absolute value of the brightness of an image.

FIG. 41 is a flow chart illustrating a process for deciding whether or not there is a failure on the basis of a characteristic point of a stable image.

FIG. 42 is a flow chart illustrating a process for deciding whether or not there is a failure on the basis of a speed of a change of a picked up image.

FIG. 43 is a flow chart illustrating common operation by the first to third embodiments.

FIG. 44 is a flow chart illustrating operation by the first embodiment.

FIG. 45 is a flow chart illustrating different operation by the first embodiment.

FIG. 46 is a flow chart illustrating operation by the second embodiment.

FIG. 47 is a flow chart illustrating different operation by the second embodiment.

FIG. 48 is a flow chart illustrating further different operation by the second embodiment.

FIG. 49 is a flow chart illustrating operation in the case where the failure decision section 41 in the third embodiment has the first configuration example.

FIG. 50 is a flow chart illustrating different operation in the case where the failure decision section 41 in the third embodiment has the first configuration example.

FIG. 51 is a flow chart illustrating further different operation in the case where the failure decision section 41 in the third embodiment has the first configuration example.

FIG. 52 is a flow chart illustrating operation in the case where the failure decision section 41 in the third embodiment has the second configuration example.

FIG. 53 is a flow chart illustrating different operation in the case where the failure decision section 41 in the third embodiment has the second configuration example.

FIG. 54 is a flow chart illustrating further different operation in the case where the failure decision section 41 in the third embodiment has the second configuration example.

FIG. 55 is a flow chart illustrating operation in the case where the failure decision section 41 in the third embodiment has the third configuration example.

FIG. 56 is a flow chart illustrating different operation in the case where the failure decision section 41 in the third embodiment has the third configuration example.

FIG. 57 is a flow chart illustrating further different operation in the case where the failure decision section 41 in the third embodiment has the third configuration example.

FIG. 58 is a block diagram depicting a configuration example of a computer.

### DESCRIPTION OF EMBODIMENTS

In the following, a mode for carrying out the present technology (hereinafter referred to as embodiment) is described. It is to be noted that the description is given in the following order.

### 1. Monitoring System That Is Embodiment of Present Technology

1-1. Configuration of Monitoring System

1-2. Operation Mode of Monitoring System

1-3. Control of Operation of Monitoring System

### 2. Monitoring Sensor Apparatus Provided in Monitoring System of Present Technology

2-1. Disposition of Monitoring Sensor Apparatus

2-2. Appearance of Monitoring Sensor Apparatus

2-3. Embodiments of Monitoring Sensor Apparatus
2-3-1. First Embodiment of Monitoring Sensor Apparatus
   2-3-1A. Overview of Configuration of First Embodiment
   2-3-1B. Imaging Function Section
   2-3-1C. IR Illumination Failure Detection Section
   2-3-1D. State Detection Section
   2-3-1E. Modification to First Embodiment of Monitoring Sensor Apparatus
2-3-2. Second Embodiment of Monitoring Sensor Apparatus
   2-3-2A. Overview of Configuration of Second Embodiment
   2-3-2B. Characteristic of Second Embodiment
   2-3-2C. IR Illumination Failure Detection Section
   2-3-2D. Contrivance for Detecting Time Dependent Change
2-3-3. Third Embodiment of Monitoring Sensor Apparatus
   2-3-3A. Overview of Configuration of Third Embodiment
   2-3-3B. Characteristic of Third Embodiment
   2-3-3C. Stable Image Generation Section
   2-3-3D. Types of Stable Image
   2-3-3E. Overview of Failure Decision Section
   2-3-3F. First Configuration Example of Failure Decision Section
   2-3-3G. Second Configuration Example of Failure Decision Section
   2-3-3H. Third Configuration Example of Failure Decision Section

2-4. Monitoring Sensor Apparatus in Which Software Processing Is Used

<1. Monitoring System that is Embodiment of Present Technology>

### <1-1. Configuration of Monitoring System>

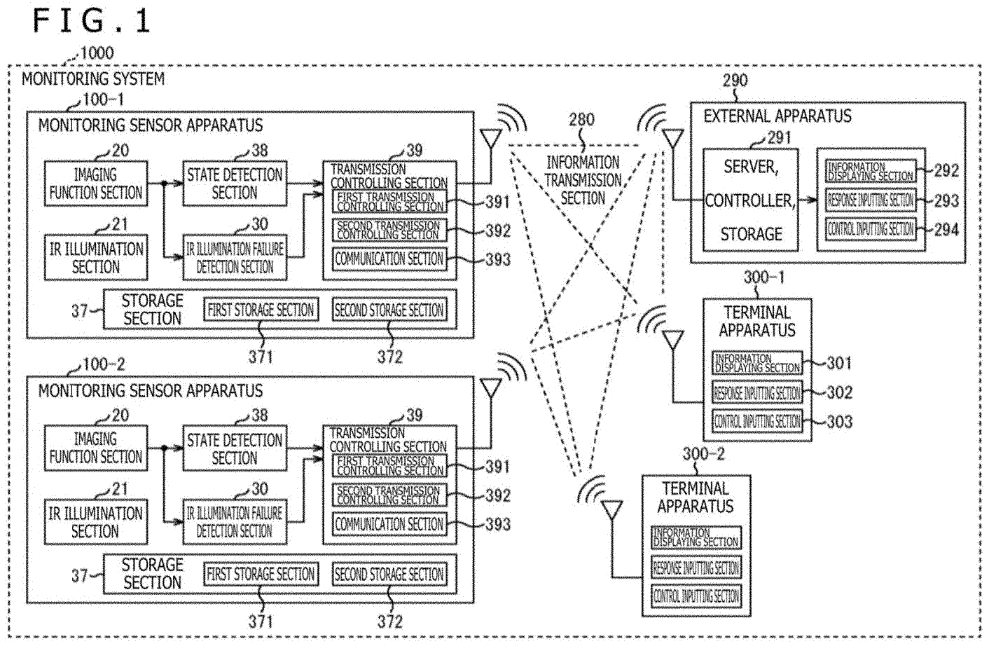

FIG. 1 depicts a configuration example of a monitoring system that is an embodiment of the present technology.

It is supposed that the monitoring system 1000 is provided in facilities in which a plurality of care receivers individually and separately occupy a plurality of rooms and are cared by caregivers such as, for example, elderly care facilities, a hospital or like facilities.

The monitoring system 1000 is used to:

(1) watch or monitor care receivers (monitoring target persons) in the rooms;

(2) detect (decide) whether or not a state of a care receiver (in other words, a posture or a physical position of the care receiver) is a state that is to be notified to a caregiver, for example, whether a care receiver sleeps in the bed, is off the bed, is moving in the room, sits on a chair or the like and is not moving, or lies on the floor; and

(3) notify, in a case where it is decided that a state of a care receiver is a state that is to be notified to a caregiver, the state of the care receiver that is a result of the detection (decision) to a caregiver (user of the monitoring system). Here, in the case where it is decided that the state of the care receiver is a state that is to be notified to a caregiver, the monitoring system 1000 may notify only the information that the state of the care receiver is a state to be notified to a caregiver. Further, the monitoring system 1000 may usually notify a state of a care receiver that is a result of detection (decision) not only in the case where it is decided that the state of the care receiver is a state to be notified to the caregiver but also at all times.

It is to be noted that it is desirable to configure the monitoring system 1000 such that,

(4) in the case where it is decided that a state of a care receiver is a state that is to be notified to a caregiver, a moving image (picked up image stream) obtained by imaging a state of the care receiver can be notified to the caregiver.

As depicted in FIG. 1, the monitoring system 1000 includes one or a plurality of monitoring sensor apparatus 100 provided in each room, an external apparatus 290 that receives information transmitted from the monitoring sensor apparatus 100 and a plurality of terminal apparatus 300 that receive a report from the external apparatus 290. It is supposed that each caregiver individually holds a terminal apparatus 300.

Further, the monitoring system 1000 includes an information transmission section 280 that transmits (sends, transfers) information between the monitoring sensor apparatus 100 and the external apparatus 290 and between the external apparatus 290 and the terminal apparatus 300. Any one of the existing wireless communication technology and wired communication technology may be adopted for the information transmission section 280. In particular, in a case where information to be communicated is digital data, a line by which the digital data can be communicated serially or in parallel and that is a standardized line such as, for example, Ethernet (registered trademark) or Wi-Fi (trademark) can be used. Naturally, a unique line that is not standardized may be used. In a case where information to be communicated is analog data, a common analog line may be used.

In the monitoring system 1000, as information to be transferred among the monitoring sensor apparatus 100, external apparatus 290 and terminal apparatus 300 through the information transmission section 280, principally two types of information are available.

First information is information relating to a state of a care receiver. If the information is, for example, digital data, then in the case where the information to be transferred is one kind of information indicating that “a state of a care receiver is a state to be notified to a caregiver,” the data amount of the information requires only one bit. In the case where the information to be transferred is “information indicative of a state of a care receiver,” if states of care receivers are classified into 16 kinds or less, then the data amount of the information is sufficient if it requires at most four bits. It is to be noted that also a result when failure of an IR illumination section 21 is detected by an IR illumination failure detection section 30 hereinafter described and provided in the monitoring sensor apparatus 100 may be included in and transmitted together with the first information from the monitoring sensor apparatus 100 to the external apparatus 290 and the terminal apparatus 300.

Second information is a moving image obtained by continually imaging the state of a care receiver (picked up image stream). The data amount of this information is significantly greater than that of the first information. It is to be noted that also sound data collected by using a microphone (not depicted) provided in the terminal apparatus 300 and a microphone (not depicted) provided in the monitoring sensor apparatus 100 can be communicated as the second information.

Each monitoring sensor apparatus 100 includes a transmission controlling section 39 that performs control regarding whether transmission (sending, transfer) of the first and second information described above from the monitoring sensor apparatus 100 to the external apparatus 290 or a terminal apparatus 300 through the information transmission section 280 is executed or stopped.

The transmission controlling section 39 provided in the monitoring sensor apparatus 100 includes a first transmission controlling section 391 for controlling execution or stopping of transmission relating to the first information, a second transmission controlling section 392 for controlling execution or stopping of transmission relating to the second information, and a communication section 393 that physically sends the first and second information.

The external apparatus 290 includes an information displaying section 292 that displays information transmitted from a monitoring sensor apparatus 100, a response inputting section 293 for inputting a response by a caregiver to information transmission from the monitoring sensor apparatus 100 and a control inputting section 294 that inputs an instruction for controlling operation of the monitoring system 1000 by the caregiver. Similarly, each terminal apparatus 300 includes an information displaying section 301 that displays information transmitted by a monitoring sensor apparatus 100, a response inputting section 302 for inputting a response by a caregiver to information transmission from the monitoring sensor apparatus 100 and a control inputting section 303 that inputs an instruction for controlling operation of the monitoring system 1000 by the caregiver.

Further, the monitoring sensor apparatus 100 includes an IR illumination section 21 that irradiates, in order to image a care receiver to decide a state of the care receiver, IR light in a situation in which illumination of visible light provided in the room is off at night and an imaging function section 20 that has sensitivity to the IR light and suitably images an imaging object on which the IR light is irradiated. It is to be noted that the imaging function section 20 of the monitoring sensor apparatus 100 has sensitivity also to the visible light and can suitably image an imaging object on which the visible light is irradiated.

Furthermore, the monitoring sensor apparatus 100 includes a state detection section 38 that decides a state of a care receiver on the basis of a picked up image and generates the first and second information described above.

The imaging function section 20 includes a built-in imaging controlling section 24 that performs control for activating or deactivating the imaging function, control of an imaging condition (exposure time, aperture or the like) and control of an image processing condition (gain to be applied to an image) for a picked up image. Further, the monitoring sensor apparatus 100 may include a built-in visible light illuminance detection section (not depicted) that measures the illuminance of the visible light.

The imaging controlling section 24 can control the imaging function of the imaging function section 20 and activation and deactivation of the IR illumination of the IR illumination section 21 on the basis of one of a result of the detection by the visible light illuminance detection section, an input from the control inputting section 294 of the external apparatus 290, and an input from the control inputting section 303 of the terminal apparatus 300.

### <1-2. Operation Mode of Monitoring System>

Incidentally, where a moving image obtained by imaging a care receiver is transmitted usually to the caregiver in the elderly care facilities or the like, the privacy of the care receiver cannot be protected. Therefore, the monitoring system 1000 includes four kinds of operation modes (first to fourth operation modes) that can implement protection of the privacy of the care receiver. In the following, the first to fourth operation modes are described.

The first operation mode is a monitoring mode. In the first operation mode, any monitoring sensor apparatus 100 images a care receiver to detect a state of the care receiver. Then, in the case where it is decided that the first information indicating a state of the care receiver or a state of the care receiver is a state to be notified to the caregiver, the first information indicating that “the state of the care receiver is a state to be notified to the caregiver” is transmitted from the monitoring sensor apparatus 100 to the external apparatus 290. In response to reception of the first information, the external apparatus 290 transfers the first information to a terminal apparatus 300.

In this case, the information to be transmitted from the monitoring sensor apparatus 100 to the external apparatus 290 and then transferred to the terminal apparatus 300 is the first information representing the state of the care receiver or the first information indicating that “the state of the care receiver is a state to be notified to the caregiver” but is not a moving image obtained by imaging the care receiver (second information). Accordingly, in comparison with the conventional system transmitting a moving image obtained by imaging a care receiver is transmitted as it is, the privacy of the care receiver can be protected at a higher level.

The second operation mode is a speech communication mode. The second operation mode is an operation mode in which, for example, after the state of the care receiver becomes a state to be notified to the caregiver by the first operation mode (monitoring mode) and this is notified to the caregiver, taking the notification as a trigger, the caregiver and the care receiver perform speech communication with each other using a microphone and a speaker (not depicted) provided in the terminal apparatus 300 and a microphone and a speaker (not depicted) the monitoring sensor apparatus 100 in the room of the care receiver has.

In the second operation mode, when speech communication is performed, the communication may be performed using a speech signal as it is as analog data or the speech signal may be compression encoded such that resulting data is communicated as digital data. Further, the speech data may be communicated directly by the terminal apparatus 300 and monitoring sensor apparatus 100 or may be communicated through the external apparatus 290.

The third operation mode is an image transfer mode. In the third operation mode, for example, after a state of the care receiver becomes a state to be notified to the caregiver by the first operation mode and this is notified to the caregiver, taking the notification as a trigger, the monitoring sensor apparatus 100 installed in the room of the care receiver picks up a moving image (picked up image stream) of the care receiver and transmits the image obtained as a result of the imaging to the external apparatus 290 and then transfers the image to the terminal apparatus 300. It is to be noted that the image picked up and transmitted by the monitoring sensor apparatus 100 in the third operation mode may not be a moving image but may be one or a plurality of still pictures.

In the third operation mode, when an image is to be transmitted and transferred, the image may be transmitted and transferred as it is or may be transmitted and transferred after it is compression encoded in the monitoring sensor apparatus 100 or the external apparatus 290.

The fourth operation mode is an image accumulation mode. In the fourth operation mode, moving images usually picked up are buffered into and accumulated in a first storage section 371 provided in the monitoring sensor apparatus 100 for a fixed period of time. Then, for example, by the first operation mode (monitoring mode), the state of the care receiver becomes a state to be notified to the caregiver and is notified to the caregiver, and, at the same time, taking the notification as a trigger, moving images within a predetermined period of time before and after the trigger from among the buffered moving images are transmitted to the external apparatus 290. According to the fourth operation mode, in the case where an accident such as, for example, falling down occurs, moving images before and after the falling down can be checked.

As an alternative, if the state of the care receiver becomes a state to be notified to the caregiver and is notified to the caregiver by the first operation mode (monitoring mode), then taking the notification as a trigger, moving images within a predetermined period of time before and after the trigger from among the buffered moving images may be accumulated into a second storage section 372, which can accumulate data for a longer period of time than that of the first storage section 371 of the monitoring sensor apparatus 100 such that the accumulated moving images can be checked later.

In the fourth operation mode, the accumulated moving images may remain in a state in which they are obtained as a result of imaging as it is or may be in a compression encoded state.

It is to be noted that the monitoring system 1000 as a modification can include, from among the first to fourth operation modes described above, the first operation mode as an essential operation mode and include the second to fourth operation modes in a suitable combination.

In particular, the modification to the monitoring system 1000 may include only the first mode from among the first to fourth operation modes described above.

As an alternative, the modification to the monitoring system 1000 may include the first mode and the second mode from among the first to fourth operation modes described above.

As another alternative, the modification to the monitoring system 1000 may include the first mode, second mode and third operation mode from among the first to fourth operation modes described above.

As a further alternative, the modification to the monitoring system 1000 may include the first mode, second operation mode and fourth operation mode from among the first to fourth operation modes described above.

As a still further alternative, the modification to the monitoring system 1000 may include the first mode and the third operation mode from among the first to fourth operation modes described above.

As a yet further alternative, the modification to the monitoring system 1000 may include the first mode, third operation mode and fourth operation mode from among the first to fourth operation modes described above.

As a yet further alternative, the modification to the monitoring system 1000 may include the first mode and the fourth mode from among the first to fourth operation modes described above.

As a yet further alternative, the modification to the monitoring system 1000 may include all of the first to fourth operation modes described above.

### <1-3. Control of Operation of Monitoring System>

Control of operation of the monitoring system 1000 is described. Here, as an example, a mode in which the monitoring system 1000 includes the operation mode 1 and the operation mode 3 is assumed, and control of operation in the mode is described.

(1) During the daytime during which sunlight is incident or the illumination is on, the monitoring system 1000 watches or monitors the state of the care receiver in the room by the imaging function section 20 and the state detection section 38 provided in the monitoring sensor apparatus 100. More particularly, imaging of the care receiver is performed using the imaging function section 20 and it is detected (decided) by the state detection section 38 whether or not the state of the care receiver is to be notified to the caregiver.

(2) In the nighttime in which the illumination is off, the caregiver inputs an activation instruction for the IR illumination section 21 provided in the monitoring sensor apparatus 100 from the control inputting section 294 or 303 provided in the external apparatus 290 or the terminal apparatus 300, and the monitoring sensor apparatus 100 receives the input and activates the IR illumination section 21.

Separately from this, not the caregiver may issue the activation instruction but a visible light illuminance detection section provided in the monitoring sensor apparatus 100 may detect that visible light illumination provided in the room is turned off by the care receiver or the like such that the monitoring sensor apparatus 100 activated the IR illumination section 21 on the basis of a result of the detection. At the point of time at which the IR illumination section 21 is activated, the monitoring system 1000 is operating in the first operation mode (monitoring mode). In the first operation mode, operation for transferring the second information such as speech or an image to the external apparatus 290 or the terminal apparatus 300 through the information transmission section 280 is placed and held in a stopped state under the control of a second transmission controlling section 392.

(3) If the state of the care receiver becomes a state to be notified to the caregiver while the monitoring system 1000 is operating in the first operation mode, then the state detection section 38 detects this state on the basis of an image picked up under the IR light by the imaging function section 20 and notifies the external apparatus 290 and terminal apparatus 300 of the caregiver that the state of the care receiver is a state to be notified to the caregiver to.

(4) If the notification described in (3) is issued, then, taking the notification as a trigger, the monitoring system 1000 transits to and executes the third operation mode (image transfer mode). In the third mode, the operation for transferring the second information to the external apparatus 290 or the terminal apparatus 300 through the information transmission section 280 is placed in a state in which the transfer is executed under the control of the second transmission controlling section 392.

(5) If the caregiver receives the notification described in (3) above and the caregiver checks the situation of the care receiver by the third operation mode described in (4) above, then the caregiver decides whether or not some treatment need be performed for the care receiver.

In the case where the caregiver decides that no treatment need be performed for the care receiver, the caregiver inputs an instruction to return the monitoring system 1000 to the first operation mode from the control inputting section 294 or 303 provided in the external apparatus 290 or the terminal apparatus 300. Consequently, the monitoring system 1000 returns to the first operation mode and performs monitoring of the care receiver.

In the case where the caregiver decides that some treatment need be performed for the care receiver, the caregiver enters the room of the care receiver and tries necessary treatment. The caregiver after ending of the treatment inputs an instruction to return the monitoring system 1000 to the first operation mode from the control inputting section 294 or 303 provided in the external apparatus 290 or the terminal apparatus 300. Consequently, the monitoring system 1000 returns to the first operation mode and performs monitoring of the care receiver.

It is to be noted that, if visible light illumination is turned off after the caregiver enters the room of the care receiver and turns on visible light illumination and then performs necessary treatment, then since the visible light illuminance detection section provided in the monitoring sensor apparatus 100 can detect this, the monitoring system 1000 may return to the first operation mode to perform monitoring of the care receiver on the basis of a result of the detection.

It is to be noted that the monitoring system 1000 can execute a method like that described above by suitably combining the first to fourth operation modes. The description of this is omitted here.

### <2. Monitoring Sensor Apparatus 100 Provided in Monitoring System of Present Technology>

Embodiments of the monitoring sensor apparatus 100 provided in the monitoring system 1000 are described below.

### <2-1. Disposition of Monitoring Sensor Apparatus 100>

First, an example of installation of the monitoring sensor apparatus 100 is described as a first articles common to the embodiments of the monitoring sensor apparatus 100.

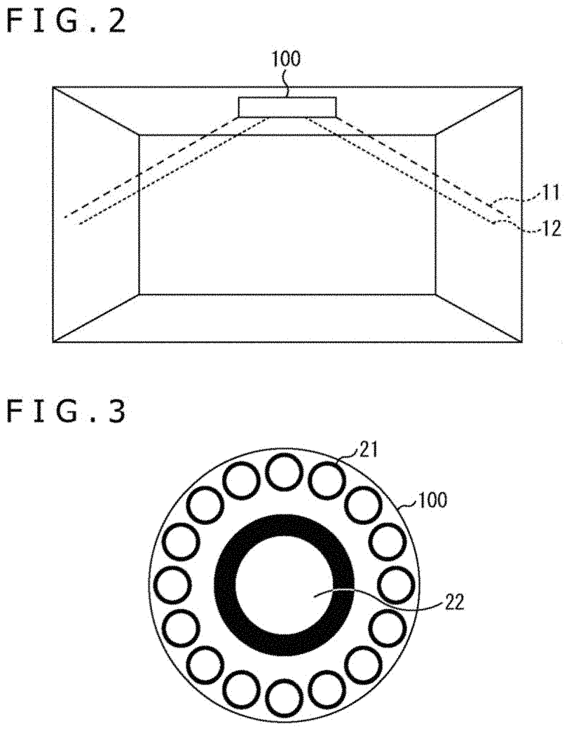

FIG. 2 depicts an example of installation of the monitoring sensor apparatus 100. The monitoring sensor apparatus 100 is to be installed, for example, in each room in which a care receiver of the elderly care facilities is and has a function for irradiating IR light to perform imaging and detecting a state of the care receiver on the basis of an image obtained as a result of the imaging and then notifying a result of the detection to the caregiver side.

### <2-2. Appearance of Monitoring Sensor Apparatus 100>

Now, a configuration example of an appearance of the monitoring sensor apparatus 100 is described as a second article common to the embodiments of the monitoring sensor apparatus 100.

FIG. 3 depicts a configuration example of a front appearance of the monitoring sensor apparatus 100. The IR illumination section 21 included in the monitoring sensor apparatus 100 may be configured from a single IR light source (LED or the like) or may be configured from a plurality of IR light sources as depicted in the figure.

The imaging section 22 disposed at the center of the front of the monitoring sensor apparatus 100 has a sensitivity to visible light and IR light and converts such light into electric signals to pick up an image.

Consequently, the monitoring sensor apparatus 100 can clearly image the state of the care receiver in the room in both a state in which the inside of the room of the care receiver is sufficiently bright with visible light by incidence of light in the daytime and lighting of visible light illumination at night and another state in which the visible light illumination is turned off and IR illumination is turned on at night. It is to be noted that a lighting range 11 of IR light by the IR illumination section 21 includes an overall imaging range 12 by the imaging section 22.

The imaging section 22 may include an image sensor having sensitivity to visible light and another image sensor having sensitivity to IR light separately from each other. Further, the IR illumination section 21 may be disposed separately from the monitoring sensor apparatus 100.

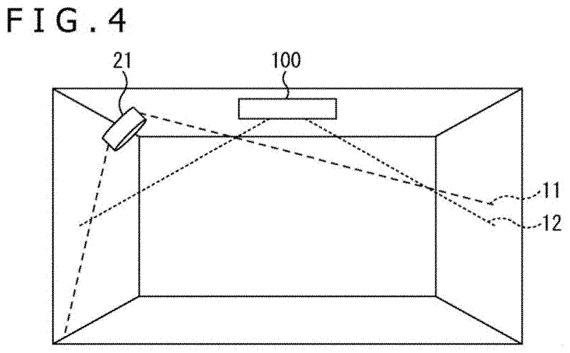

FIG. 4 depicts an example of installation in the case where the IR illumination section 21 is separate from the monitoring sensor apparatus 100. As depicted in the figure, also in the case where the IR illumination section 21 is separate from the monitoring sensor apparatus 100, the IR illumination section 21 and the monitoring sensor apparatus 100 from which the IR illumination section 21 is separated are installed such that the lighting range 11 includes the imaging range 12 as depicted in FIG. 4.

### <2-3. Embodiments of Monitoring Sensor Apparatus 100>

In the following, first to third embodiments of the monitoring sensor apparatus 100 are described.

### <2-3-1> First Embodiment of Monitoring Sensor Apparatus 100>

The first embodiment of the monitoring sensor apparatus 100 is described.

### <2-3-1A. Overview of Configuration of First Embodiment>

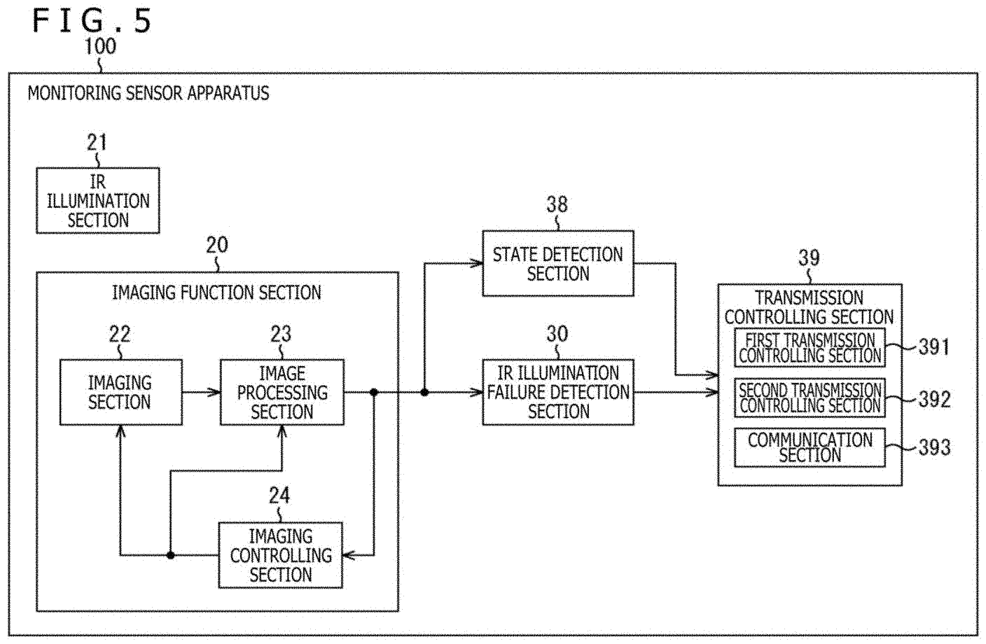

FIG. 5 is a block diagram depicting the first embodiment of the monitoring sensor apparatus 100. The first embodiment includes an IR illumination section 21, an imaging function section 20, a state detection section 38, an IR illumination failure detection section 30 and a transmission controlling section 39.

### <2-3-1B. Imaging Function Section 20>

The imaging function section 20 includes an imaging section 22, an image processing section 23 and an imaging controlling section 24.

The IR illumination section 21 is configured, for example, from a plurality of LEDs and emits IR light to the room. The imaging section 22 is configured from an image sensor or a like element having sensitivity to visible light and IR light, and continually images the imaging range 12 in accordance with a predetermined frame rate and outputs a moving image obtained as result of the imaging to the image processing section 23.

The image processing section 23 performs predetermined image processes (development process, gradation correction process, color tone correction process, noise reduction process, distortion correction process, size conversion process and so forth) for the moving image inputted thereto from the imaging section 22 and outputs an image-processed moving image obtained as a result of the image processes to the IR illumination failure detection section 30 and the state detection section 38. In the following description, the moving image outputted from the imaging function section 20 is referred to as picked up image stream, and each of frame images configuring the picked up image stream is referred to merely as picked up image.

The imaging controlling section 24 automatically controls imaging conditions (exposure time, aperture and so forth) for the imaging section 22 and the gain to be applied to images in the image processing section 23 in response to imaging environments and conditions of an imaging object (illuminance of the imaging object, reflection factor of light by the surface of the imaging object and so forth) such that an appropriate picked up image stream can be obtained.

### <2-3-1C. IR Illumination Failure Detection Section 30>

The IR illumination failure detection section 30 monitors picked up images included in a picked up image stream outputted from the imaging function section 20, and compares a plurality of picked up images included in the picked up image stream and decides whether or not there is a failure of the IR illumination section 21 on the basis of a result of the comparison. For example, the IR illumination failure detection section 30 compares a first picked up image imaged at a first point of time and a second picked up image imaged at a second point of time with each other to decide whether or not there is a failure of the IR illumination section 21.

It is to be noted that, in addition to the decision of whether or not there is a failure of the IR illumination section 21 on the basis of a result of comparison of a plurality of picked up images, a process for deciding whether or not there is a failure of the IR illumination section 21 on the basis of an absolute value of the brightness of one picked up image may be added. The process for deciding whether or not there is a failure of the IR illumination section 21 on the basis of an absolute value of the brightness of one picked up image is hereinafter described with reference to FIG. 40.

<A. First Example of Failure Decision Method>

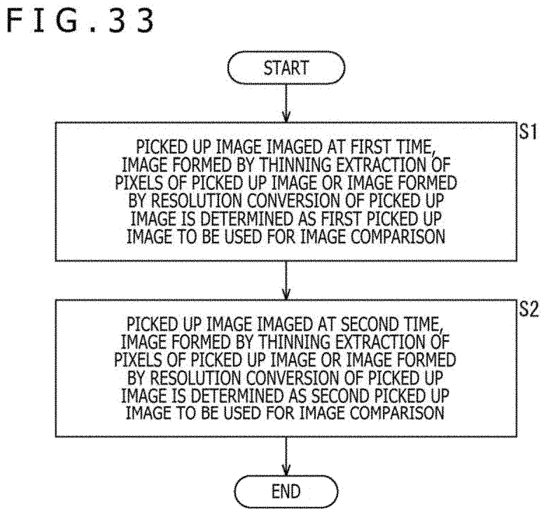

Two examples of the method for comparing a first picked up image and a second picked up image with each other to decide whether or not there is a failure of the IR illumination section 21 are described. It is to be noted that a method for creating first and second picked up images is hereinafter described with reference to FIG. 33.

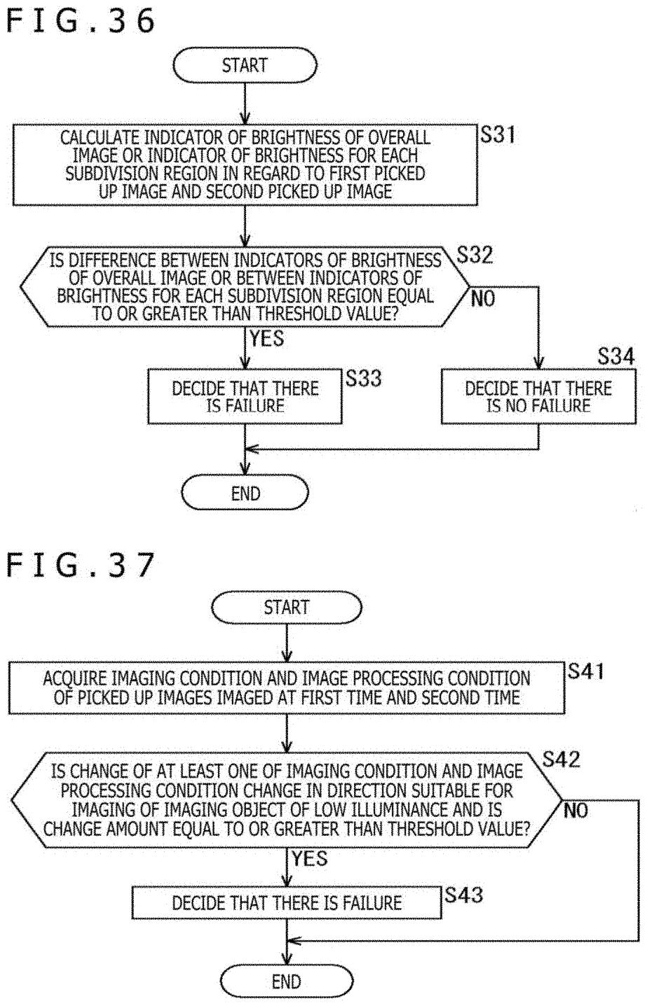

The first method is a method that calculates, for each picked up image, a brightness of a picked up image (for example, an average value of luminances of all pixels included in the picked up image or a plurality of pixels extracted by thinning from among the pixels (such average value is hereinafter referred to as average luminance)) and compares the average values of the picked up images with each other. It is to be noted that a method for deciding whether or not there is a failure of the IR illumination section 21 on the basis of the brightnesses of the first and second picked up images is hereinafter described with reference to FIG. 36.

In the case where a failure that the emission light amount from the IR illumination section 21 decreases occurs between the first point of time and the second point of time, the second picked up image sometimes is darker than the first picked up image. In this case, an indicator representative of the brightness of the second picked up image (for example, an average luminance) is lower than that of the first picked up image. Therefore, when the difference between the indicators representative of the brightnesses of the first and second picked up images becomes greater than a predetermined threshold value, the IR illumination failure detection section 30 decides that a failure occurs with the IR illumination section 21.

It is to be noted that, as a method for calculating an indicator (for example, an average luminance) representative of the brightness of a picked up image, an average value in brightness of pixels may be calculated targeting all pixels included in the picked up image. As an alternative, pixels may be extracted by suitable thinning over an overall area of a picked up image such that an average value of indicators is calculated targeting the pixels extracted by thinning. In the case where the method of calculating an average value of indicators targeting pixels extracted by thinning is used, an action is brought about that the data processing amount required for calculation of an average luminance and the data processing amount required for image comparison for failure detection are reduced.

It is to be noted that, as a mode for reducing the data processing amount required for calculation of an average luminance or the data processing amount required for image comparison for failure detection, in addition to the method of extracting pixels by thinning, image comparison may be performed using, on the basis of a picked up image, an image of a reduced resolution from that of the picked up image (in other words, an image of a smaller image size) created separately from the picked up image using a popular image resolution changing technology.

<B. Second Example of Failure Decision Method>

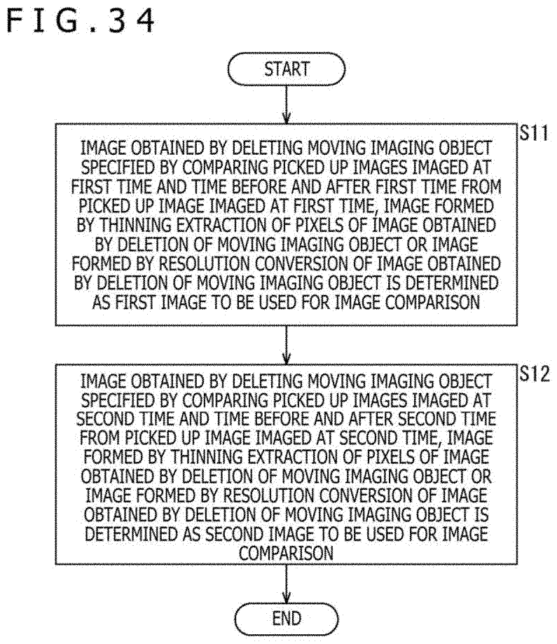

The second example of the method for comparing a plurality of picked up images included in a picked up image stream to decide whether or not there is a failure of the IR illumination section 21 is a method that deletes, from each picked up image included in a picked up image stream, a portion in which a moving body (dynamic imaging object) is imaged, calculating an indicator (for example, an average luminance) representative of a brightness of a portion of each picked up image in which any other imaging object (static body, static imaging object) is picked up and comparing resulting indicators of the picked up images. It is to be noted that a method of removing a moving imaging object to create a picked up image is hereinafter described with reference to FIG. 34.

For example, in the case where an indicator indicative of the brightness of a picked up image in the nth frame and an indicator indicative of the brightness of a picked up image in the mth frame from within a picked up image stream are compared with each other to decide whether or not there is a failure of the IR illumination section 21, an indicator of the brightness of a portion from which a moving body is deleted can be calculated in the following manner to decide whether or not there is a failure of the IR illumination section 21.

In particular,

(1) Three images of the (n−1)th frame to the (n+1)th frame are compared with each other. Then, image data of each of pixels included in an image is compared among the three images, and in the case where the differences are equal to or greater than a predetermined threshold value, it is decided that a moving body is imaged by the pixel. In the case where the differences are equal to or smaller than the threshold value, it is decided that a static body is imaged by the pixel.
(2) The position of each pixel decided to image a static body and pixel data of the pixel in the three images of the (n−1)th frame to the (n+1)th frame are retained as information regarding the first picked up image into a memory (not depicted) included in the IR illumination failure detection section 30. For example, in the case where it is decided that each picked up image outputted from the imaging function section 20 is an image of 2,000,000 pixels and 200,000 pixels among them image a moving body, the positions and the pixel data of the remaining 1,800,000 pixels are retained.
(3) Similarly, also in regard to three images of the (m−1)th frame to the (m+1)th frame, it is decided which one of a moving body and a static body is imaged by each pixel, and the positions and the pixel data of pixels decided to image a still body are retained as information regarding the second picked up image into the memory.
(4) The information of the first and second picked up images is compared to extract pixels decided to image a still body in both images in common.
(5) An average luminance among the extracted pixels in each of the first and second picked up images is calculated.
(6) The resulting average luminances of the first and second picked up images are compared with each other to decide whether or not there is a failure of the IR illumination section 21. In particular, in the case where the difference between the average luminances is greater than a threshold value determined in advance, the IR illumination failure detection section 30 decides that a failure occurs with the IR illumination section 21.

It is to be noted that, also in the second example of the method for deciding whether or not there is a failure, similarly as in the first example, in order to reduce the data processing amount required for calculation of an average luminance or the data processing amount required for image comparison for failure detection, images may be compared with each other with pixels extracted by thinning, or image comparison may be performed using, on the basis of a picked up image, an image of a reduced resolution from that of the picked up image (in other words, an image of a smaller image size) created separately from the picked up image using a popular image resolution changing technology.

### <2-3-1D. State Detection Section 38>

The state detection section 38 detects a state of a care receiver on the basis of a picked up image and notifies a result of the detection to the transmission controlling section 39. As an example of the state of a care receiver to be detected (in other words, of a posture or a physical position of the care receiver), whether the care receiver sleeps in the bed, is off the bed, is moving in the room, sits on a chair or the like and is not moving, lies on the floor, lying in the bed and so forth other than falling down are supposed.

The transmission controlling section 39 notifies a result of the decision (whether or not there is a failure of the IR illumination section 21) by the IR illumination failure detection section 30 to the external apparatus 290. Further, the transmission controlling section 39 notifies a result of detection of the state detection section 38 (state of the care receiver) to the external apparatus 290.

### <2-3-1E. Modification to First Embodiment of Monitoring Sensor Apparatus 100>

Now, a modification to the first embodiment of the monitoring sensor apparatus 100 is described. Although the present modification includes components similar to those of the first embodiment, it is different in the contrivance for detecting a failure of the IR illumination section 21 by the IR illumination failure detection section 30 from that of the first embodiment of the monitoring sensor apparatus 100.

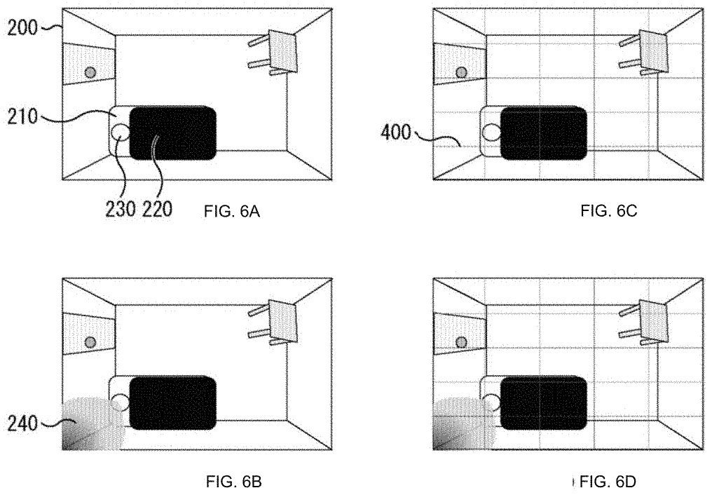

FIG. 6 is a view illustrating the contrivance for detecting a failure of the IR illumination section 21 by the IR illumination failure detection section 30 provided in the monitoring sensor apparatus 100 of the first embodiment and the modification to the first embodiment.

A of FIG. 6 is a view illustrating the contrivance for detecting a failure of the IR illumination section 21 by the IR illumination failure detection section 30 in the first embodiment of the monitoring sensor apparatus 100.

The IR illumination failure detection section 30 in the first embodiment of the monitoring sensor apparatus 100 calculates, over an overall imaging range (room) 200 recorded in each of picked up images of a picked up image stream inputted to the IR illumination failure detection section 30, an indicator (for example, an average luminance) representative of the brightness of the region for each picked up image. Then, in the case where a plurality of picked up images picked up at different points of time indicate a difference in the indicator representative of the brightness equal to or greater than a predetermined threshold value, it is decided that there is a failure in the IR illumination section 21.

B of FIG. 6 is a view illustrating a problem in the case where the IR illumination failure detection section 30 in the first embodiment of the monitoring sensor apparatus 100 detects a failure of the IR illumination section 21.

In the case where the IR illumination section 21 provided in the monitoring sensor apparatus 100 is configured from a plurality of IR light sources as depicted in FIG. 3, even if a failure that the emission light amount decreases should occur with a very small number of IR light sources among them, the range in which the failure influences is only part of the imaging range 200. Even if the emission light amount of the IR light sources decreases in part of the imaging range 200, if the indicator representative of the brightness of the region is calculated over the overall imaging range 200, then the indicator indicates only a small decrease, and as a result, it can be conceived that the decreasing amount of the indicator does not reach the threshold value for the decision of a failure of the IR illumination section 21, which leads to overlooking of the failure.

Therefore, the IR illumination failure detection section 30 in the present modification divides the imaging range 200 recorded in a picked up image into a plurality of subdivision regions 400 and calculates an indicator representative of the brightness in each of the subdivision regions 400 as depicted in C of FIG. 6. Further, the IR illumination failure detection section 30 decides, for each of the subdivision regions 400 of the picked up image, whether or not the difference in indicator representative of the brightness (for example, the difference in average luminance) between a plurality of picked up images picked up at different points of time is not equal to or greater than a threshold value to decide whether or not there is a failure of the IR illumination section 21. Here, in the case where the difference in indicator representative of the brightness is greater than a predetermined threshold value, the IR illumination failure detection section 30 decides that a failure occurs with the IR illumination section 21.

D of FIG. 6 is a view illustrating an operational effect provided by the IR illumination failure detection section 30 in the present modification.

In the case where the IR illumination section 21 is configured from a plurality of IR light sources as depicted in FIG. 3, if a failure of decrease of the emission light amount should occur with a very small number of IR light sources from among the plurality of IR light sources, then the indicator representative of the brightness of a subdivision region 400 including the range irradiated by the failed IR light sources changes by a greater amount than the indicator indicative of the brightness of the overall imaging range 200. Therefore, in the case where a plurality of picked up images picked up at different points of time are compared with each other, the sensitivity with which a change of the brightness of the subdivision region 400 is detected is higher, and the sensitivity with which a failure of the IR illumination section 21 is detected is higher.

It is to be noted that, also in the present modification, similarly as in the first embodiment, in order to reduce the data processing amount required for calculation of an average luminance or the data processing amount required for image comparison for failure detection, images may be compared with each other for each subdivision region 400 with pixels extracted by thinning, or comparison may be performed for each subdivision region 400 after creating, on the basis of a picked up image, an image having a lower resolution than that of the picked up image (in other words, an image of a smaller image size) separately from the picked up image using a popular image resolution changing technology.

### <2-3-2. Second Embodiment of Monitoring Sensor Apparatus 100>

Now, a second embodiment of the monitoring sensor apparatus 100 is described.

### <2-3-2A. Overview of Configuration of Second Embodiment>

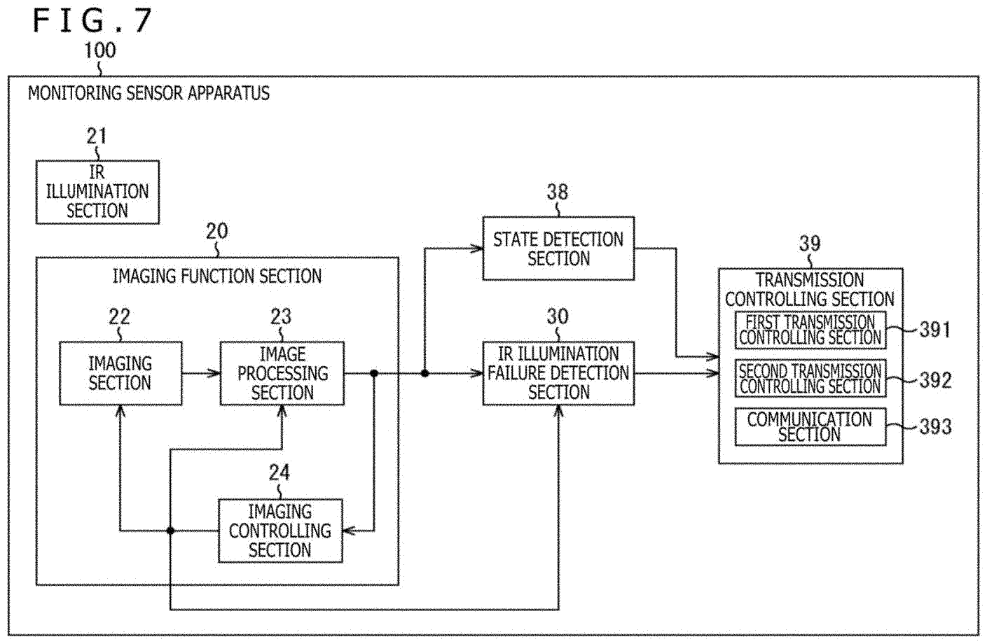

FIG. 7 is a block diagram depicting the second embodiment of the monitoring sensor apparatus 100. Description of components of the second embodiment common to those of the first embodiment and the modification to the same is suitably omitted.

The present second embodiment is configured such that, in addition to the configuration of the first embodiment, from within information outputted from the imaging controlling section 24, information relating to an imaging condition in the case where the imaging section 22 images a picked up image and information relating to an image processing condition in the case where the image processing section 23 performs an image process (for example, a process for applying a gain) for a picked up image are inputted to the IR illumination failure detection section 30.

### <2-3-2B. Characteristic of Second Embodiment>

As described hereinabove, the IR illumination failure detection section 30 in the first embodiment and the modification to the same monitors each of picked up images included in a picked up image stream outputted from the imaging function section 20 and compares a plurality of picked up images picked up at different points of time with each other to decide whether or not there is a failure of the IR illumination section 21. However, the monitoring sensor apparatus 100 automatically picks up an image with an appropriate imaging condition by the imaging controlling section 24. Since the imaging controlling section 24 automatically picks up an image with an appropriate exposure condition, the possibility seems presumable that a failure of the IR illumination section 21 may be overlooked, and further, the possibility seems presumable that, although no failure occurs with the IR illumination section 21, it may be decided in error that a failure occurs with the IR illumination section 21.

<A. Possibility that Failure of IR Illumination Section 21 May be Overlooked>

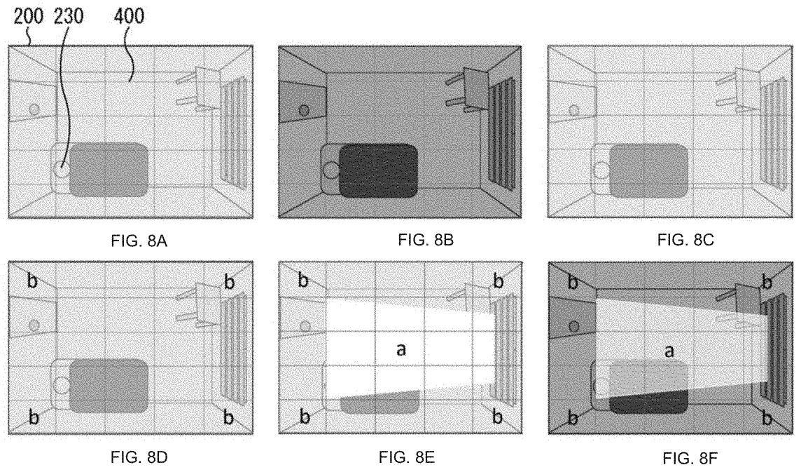

FIG. 8 is a view illustrating a case in which a failure of the IR illumination section 21 is overlooked and a case in which it is decided in error that a failure occurs with the IR illumination section 21. First, the possibility that the monitoring sensor apparatus 100 of the first embodiment may overlook a failure of the IR illumination section 21 is described with reference to A of FIG. 8 to C of FIG. 8.

A of FIG. 8 and B of FIG. 8 are views illustrating situations of an imaging object to be imaged by the monitoring sensor apparatus 100 of the first embodiment at first and second points of time, respectively.

A of FIG. 8 depicts a situation in which IR light of an appropriate light amount is irradiated from the IR illumination section 21 and the imaging object is placed in an appropriate illuminance condition at the first point of time. In this case, the imaging controlling section 24 sets an appropriate exposure condition, and consequently, the imaging function section 20 picks up an image as depicted in the figure and outputs the picked up image to the IR illumination failure detection section 30.

B of FIG. 8 depicts a situation in which a failure occurs with the IR illumination section 21 at the second point of time and the light amount emitted from the IR illumination section 21 reduces to some degree such that the imaging object is placed under this reduced illuminance. If the imaging object placed under a reduced illuminance as depicted in B of FIG. 8 is imaged in accordance with an imaging condition same as that for the imaging object placed under an illuminance higher than the reduced illuminance (A of FIG. 8), then the resulting image becomes dark as a whole. As a result, an image from which it is not easily decided what imaging object is imaged is picked up.

In order to avoid such an image from being imaged, if the average value of the brightness of an imaging object over the overall imaging region 200 becomes low, then the imaging controlling section 24 sometimes changes the exposure condition in a direction suitable for imaging of an imaging object whose illuminance is low (in other words, such that the image to be imaged becomes brighter). In particular, in the case where an imaging object of a low illuminance is to be imaged (in the case where the average value of the brightness of the imaging object in the overall imaging region 200 is low), the imaging controlling section 24 sometimes makes the imaging sensitivity (ISO sensitivity) of the imaging section 22 higher, makes the exposure time of the imaging section 22 longer, makes the opening of the aperture provided in the imaging section 22 larger or makes the gain to be applied to the image by the image processing section 23 higher than that in the case in which an imaging object of a high illuminance is to be imaged (in the case where the average value of the brightness of the imaging object over the overall imaging region is high).

Even in a case in which, as a result of such change of the imaging condition performed by the imaging controlling section 24, an imaging object of a low illuminance depicted in B of FIG. 8 is imaged, an image that is equally bright to that in A of FIG. 8 can be picked up as depicted in C of FIG. 8. If, although an imaging object under a low illuminance (B of FIG. 8) is imaged by automatic control of an imaging condition performed by the imaging controlling section 24, an image that is bright (C of FIG. 8) similarly as in the case where an imaging object of an illuminance higher than that (A of FIG. 8) is imaged and the image is outputted to the IR illumination section failure detection section 30, then the IR illumination failure section 30 cannot detect a difference in brightness of an image between the two images. Therefore, even if a failure of decrease of the emission light amount occurs with the IR illumination section 21, this cannot be detected and the possibility is presumable that the failure of the IR illumination section 21 may be overlooked.

<B. Possibility that IR Illumination Section 21 that is not in Failure May be Decided in Error as being in Failure>

Now, the possibility that the first embodiment of the monitoring sensor apparatus 100 may decide that the IR illumination section 21 is in failure although the IR illumination section 21 is not in failure is described with reference to D of FIG. 8 to F of FIG. 8.

D of FIG. 8 and E of FIG. 8 are views illustrating situations of an imaging object imaged by the first embodiment at third and fourth points of time, respectively.

D of FIG. 8 represents a situation in which IR light of an appropriate amount is irradiated from the IR illumination section 21 and an imaging object is placed under an appropriate illuminance condition at a third point of time. In this case, the imaging controlling section 24 sets an appropriate exposure condition, and on the basis of this, the imaging function section 20 picks up an image as depicted in the figure and outputs the picked up image to the IR illumination failure detection section 30.

E of FIG. 8 represents a situation in which light (for example, external light) different from that from the IR illumination section 21 is incident to the room of a care receiver of an imaging object and the illuminance of the subdivision region a that is part of the inside of the room at a fourth point of time. This is, for example, a state in which the day breaks and ambient light is incident to the room from a window of the room or a state in which there is car traffic outdoors at night and the light of the headlamp of the car enters the room.

If an imaging object having a bright region (subdivision region a illuminated by ambient light) at part thereof is imaged under an imaging condition same as that of D of FIG. 8 in which no such bright region exists as depicted in E of FIG. 8, then pixels that image the bright subdivision region a are saturated in output, resulting in failure to represent a shape of an object originally existing in the region. A so-called white-out image is picked up.

In order to prevent such an image as described above from being imaged, if a bright region enters part of an imaging object and the average value of the brightness of the imaging object in an overall imaging region becomes high, then the imaging controlling section 24 sometimes changes the exposure condition in a direction suitable for imaging of an imaging object of a high illuminance (in other words, such that the image to be picked up may become dark). In particular, in the case where an imaging object of a high illuminance is to be imaged (in the case where the average value of the brightness of an imaging object in an overall image pickup region is high), the imaging controlling section 24 sometimes makes the imaging sensitivity (ISO sensitivity) of the imaging section 22 lower, makes the exposure time period of the imaging section 22 shorter, makes the opening of the aperture provided in the imaging section 22 smaller or makes the gain to be applied to the image by the image processing section 23 smaller than that in the case where an imaging object of a low illuminance is to be imaged (in the case where the average value of the brightness of an imaging object in an overall imaging region is low).

Even in the case where, as a result of such change of the imaging condition as described above by the imaging controlling section 24, an imaging object in which the average value of the brightness of the imaging object in the overall imaging region becomes high due to the presence of the bright subdivision region a in the imaging range 200 as depicted in E of FIG. 8 is imaged, an image (F of FIG. 8) in which the average value of the brightness in the overall image is equal to that in the case where such an imaging object as depicted in D of FIG. 8 in which a bright region like the subdivision region a does not exist can be picked up.

However, in the case where the imaging object of E of FIG. 8 is to be imaged, since the image depicted in F of FIG. 8 is obtained by changing the imaging condition such that the picked up image becomes darker than that in the case where the imaging object of D of FIG. 8 is imaged, if images in a subdivision region (for example, a subdivision region b) other than the subdivision region a in F of FIG. 8 are compared between D of FIG. 8 and F of FIG. 8, then the image in the subdivision region b of F of FIG. 8 is a darker image (image of a lower brightness, an image of a lower average luminance) than the image of the subdivision region b of D of FIG. 8. If the two images depicted in D of FIG. 8 and F of FIG. 8 are compared each other and a change that the brightness of the subdivision region b decreases is found, then the possibility is presumable that the IR illumination failure detection section 30 may decide this change as a failure of part of the light sources provided in the IR illumination section 21, which irradiates the subdivision region b.

<C. Characteristic of Second Embodiment>

Therefore, in the second embodiment of the monitoring sensor apparatus 100, in addition to that the IR illumination failure detection section 30 monitors a picked up image outputted from the imaging function section 20 and decides from a change of the picked up image whether or not there is a failure of the IR illumination section 21, the IR illumination failure detection section 30 decides whether or not there is a failure of the IR illumination section 21 also from a change of the information of an imaging condition and an image processing condition outputted from the imaging controlling section 24. In the case where the IR illumination failure detection section 30 decides that a failure occurs with the IR illumination section 21, it outputs this to the transmission controlling section 39. The transmission controlling section 39 outputs the decision result that a failure occurs with the IR illumination section 21 to a terminal apparatus 300 through the external apparatus 290.

### <2-3-2C. IR Illumination Failure Detection Section 30>

<A. Lighting State of Illumination and Incidence State of Ambient Light in and into Room of Care Receiver>

In the case where the monitoring sensor apparatus 100 is used, the lighting state of illumination and the incidence state of ambient light to and into the room of a care receiver who is a monitoring target and the operation state of the monitoring sensor apparatus 100 are such as described below.

(1) Before the care receiver goes to bed, the illumination of visible light is lit in the room.

At this time, the monitoring sensor apparatus 100 monitors the care receiver using a visible light image.

(2) Immediately before the care receiver goes to bet, the illumination of visible light in the room is turned off.

At this time, the monitoring sensor apparatus 100 detects a decrease of illuminance of visible light and starts irradiation of IR light and monitoring of the care receiver using an IR light image.

(3) During a period of time while the care receiver is in the bed till the sunrise, in the room, fixed IR light is irradiated by the IR illumination section 21, and consequently, the illuminance of the imaging object in the room is kept fixed.

(4) When ambient light enters the room through a clearance of a blind of a window or a curtain together with the sunrise, the visible light illuminance in the room increases partly. The monitoring sensor apparatus 100 continues the irradiation of IR light and monitoring of the care receiver by an IR light image.

(5) If the care receiver wakes up and opens the blind of the window or the curtain or turns on the illumination of visible light in the room, then the inside of the room becomes sufficiently bright with visible light. The monitoring sensor apparatus 100 detects a rise of the illuminance of visible light in the room and ends the irradiation of IR light and monitoring of the care receiver by an IR light image.

<B. Contrivance for Preventing Overlooking of Failure of IR Illumination Section 21>

After irradiation of IR light and monitoring of the care receiver using an IR light image are started by (2) above, the illuminance of the room is subject to only one of a change that it is either kept at a fixed illuminance by the IR illumination section 21 and another change that it is increased by incidence of ambient light. If the IR illumination section 21 normally operates, then a change in a direction in which the illuminance decreases does not occur. In other words, in the case where a change in a direction in which the illuminance decreases is detected, it can be considered that the possibility that a failure may occur with the IR illumination section 21 is high.

Therefore, even if there is no difference in brightness in each subdivision region 400 between the first image imaged at the first point of time and depicted in A of FIG. 8 and the second image imaged at the second point of time and depicted in C of FIG. 8, the imaging condition and the image processing condition in the imaging function section 20 in the case where the first image is imaged and the imaging condition and the image processing condition in the imaging function section 20 in the case where the second image is imaged are compared with each other. Then, in the case where any of the conditions indicates a change in a direction in which it is suitable for imaging of an imaging object of a lower illuminance, it can be considered that the possibility that a failure may occur with the IR illumination section 21 is high.

Therefore, the IR illumination failure detection section 30 in the second embodiment is configured such that it compares the imaging condition and the image processing condition in the imaging function section 20 in the case where different picked up images are imaged are compared between the picked up images and decides, in the case where any of the conditions varies exceeding a predetermined threshold value in a direction suitable for imaging of an imaging object of a lower illuminance, that a failure occurs with the IR illumination section 21.

For example, in the case where one of a change that the imaging sensitivity (ISO sensitivity) of the imaging section 22 changes in an increasing direction, another change that the exposure time in the imaging section 22 changes in an elongating direction, a further change that the opening of the aperture provided in the imaging section 22 changes in an increasing direction in size, or a still further change that the gain to be applied to an image by the image processing section 23 changes in an increasing direction is detected and besides the magnitude of the change is equal to or greater than a predetermined threshold value (for example, 20% or more), it is decided that the illuminance of the imaging object decreases, and it is decided that a failure occurs with the IR illumination section 21.

It is to be noted that a method for preventing overlooking of a failure that occurs with the IR illumination section 21 (hereinafter referred to also as report failure countermeasure) is hereinafter described with reference to FIG. 37.

<C. Contrivance for Preventing Decision in Error Arising from Ambient Temperature>

As described hereinabove, after irradiation of IR light and monitoring of the care receiver using and an IR light image are started by (2) above, the illuminance of the room is subject to only one of a change that it is either kept at a fixed illuminance by the IR illumination section 21 and another change that it is increased by incidence of ambient light. Besides, in the case where the IR illumination section 21 fails, it can be considered that it very seldom occurs that the IR illumination section 21 fails in a direction in which the irradiation light amount increases.

Accordingly, even if there is a difference in brightness of some subdivision regions 400 between the third image picked up at the third point of time and depicted in D of FIG. 8 and the fourth image picked up at the fourth point of time and indicated in F of FIG. 8, in the case where the imaging condition and the image processing condition in the imaging function section 20 in the case where the third image is picked up and the imaging condition and the image processing condition in the imaging function section 20 in the case where the fourth image is picked up are compared with each other and some of the conditions changes in a direction in which it is suitable for imaging of an imaging object of higher illuminance, it can be considered that the possibility that not a change in illuminance due to a failure of the IR illumination section 21 but a change in illuminance of an imaging object due to light other than that from the IR illumination section 21 may occur is high.

Therefore, the IR illumination failure detection section 30 in the second embodiment compares the imaging condition and the image processing condition in the imaging function section 20 in the case where picked up images are picked up between the picked up images. Then, in the case where some of the conditions changes by a great amount from a predetermined threshold value in a direction in which it is suitable for imaging of an imaging object of a higher illuminance, even if there is a difference in brightness of some subdivision region 400 as a result of the comparison of the images, this is not decided as a failure of the IR illumination section 21.

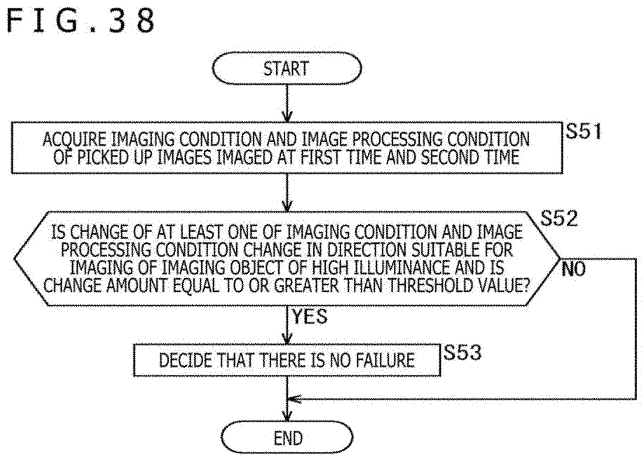

It is to be noted that a method for preventing a decision in error described above (hereinafter referred to as misinformation countermeasure) is hereinafter described with reference to FIG. 38

By performing such decision as described above, the possibility that a change by a failure of the IR illumination section 21 as depicted in A of FIG. 8 to C of FIG. 8 may be overlooked is reduced. Further, the possibility that a change of a picked up image by ambient light as depicted in D of FIG. 8 to F of FIG. 8 may be decided as a failure of the IR illumination section 21 in error can be reduced.

### <2-3-2D. Contrivance for Detecting Time Dependent Change>

The IR illumination failure detection section 30 in the second embodiment can monitor an imaging condition for a picked up image picked up at a fixed point of time every day and decide, on the basis of this information, whether or not time dependent abnormality occurs with the IR illumination section 21.

For example, in the case where the point of time for measurement is set to 12 o'clock in the evening every day, the IR illumination failure detection section 30 determines an imaging condition for a picked up image at 12 o'clock in the first day of system operation as an initial value for the imaging condition and thereafter compares an imaging condition of a picked up image picked up at 12 o'clock in the evening every day with the initial value. Then, in the case where the imaging condition (for example, exposure time) in a picked up image picked up newly changes by an amount equal to or greater than a fixed amount from the initial value, for example, by 20% or more, this is detected as occurrence of a failure based on time dependent abnormality (time dependent deterioration).

Consequently, for example, in the case where the illuminance decreases by time dependent deterioration of the IR light source or the illuminance reduces by continuous accumulation of dust on a glass cover provided in the IR illumination section 21, it is possible to detect this as occurrence of a failure by time dependent deterioration. It is to be noted that the setting of an imaging condition that is to be used as an initial value is not limited to the first day of system operation, but, for example, in the case where an input switch for resetting the initial value is provided and is depressed by a user of the system, the imaging condition upon imaging later at the next setting time can be made an initial value.

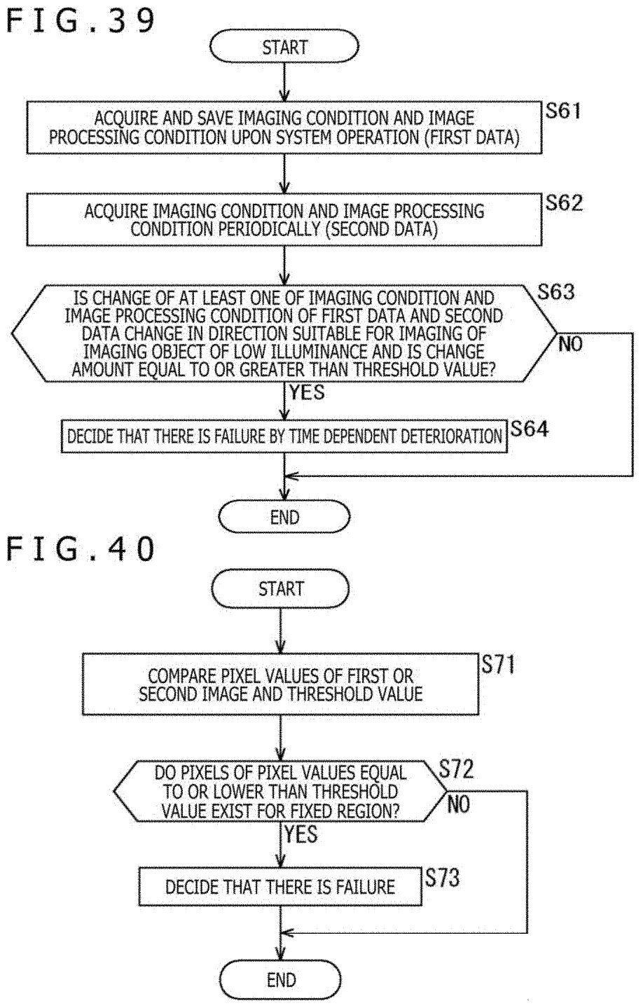

It is to be noted that a method for detecting time dependent deterioration of the IR illumination section 21 is hereinafter described with reference to FIG. 39.

### <2-3-3. Third Embodiment of Monitoring Sensor Apparatus 100>

Now, a third embodiment of the monitoring sensor apparatus 100 is described.

### <2-3-3A. Overview of Configuration of Third Embodiment>

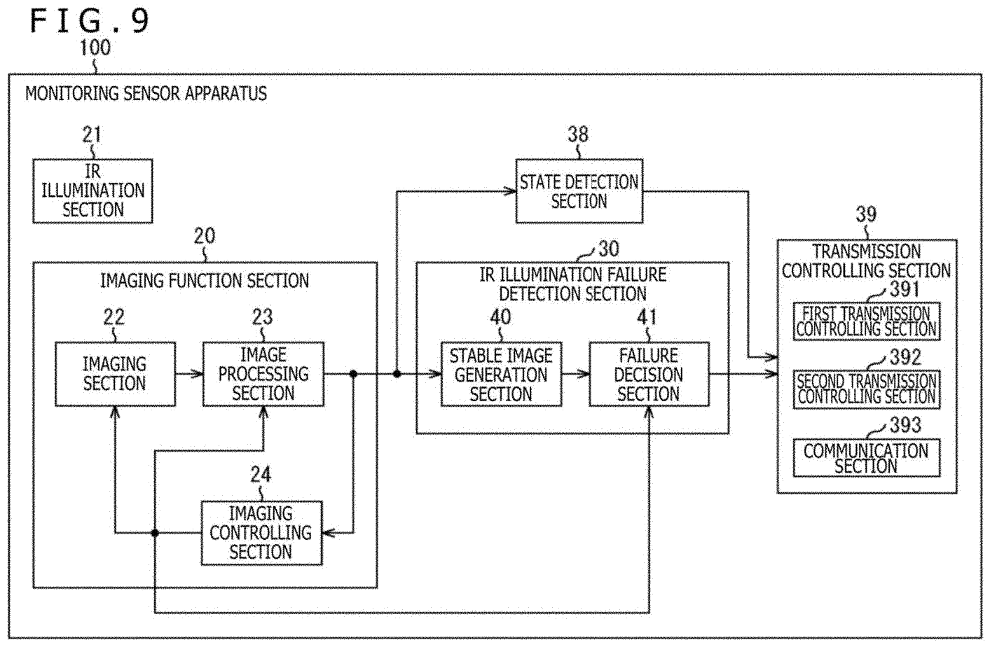

FIG. 9 is a block diagram depicting the third embodiment of the monitoring sensor apparatus 100. Description of components common to those in the second embodiment from among components of the third embodiment is suitably omitted. In the third embodiment, the IR illumination failure detection section 30 includes a stable image generation section 40 and a failure decision section 41.

### <2-3-3B. Characteristic of Third Embodiment>

As described hereinabove, the IR illumination failure detection section 30 in the first and second embodiments detects, in the case where a moving body is imaged in a picked up image stream, a portion in which the moving body (moving imaging object) is imaged from each of picked up images included in the picked up image stream and compares the images after the moving body is deleted with each other as the second example of the method for deciding whether or not there is a failure of the IR illumination section 21.

More particularly, from within a picked up image stream,

(1) three images from the (n−1)th frame to the (n+1)th frame are compared with each other and a portion in which a moving body is imaged is deleted from the three images to obtain a first picked up image, and

(2) three images from the (m−1)th frame to the (m+1)th frame are compared with each other and a portion in which a moving body is imaged is deleted from the three images to obtain a second picked up image, and then

(3) an average luminance is calculated from pixel data of subdivision regions remaining in common to the first and second picked up images for each of the first and second picked up images, and the average luminances are compared with each other.

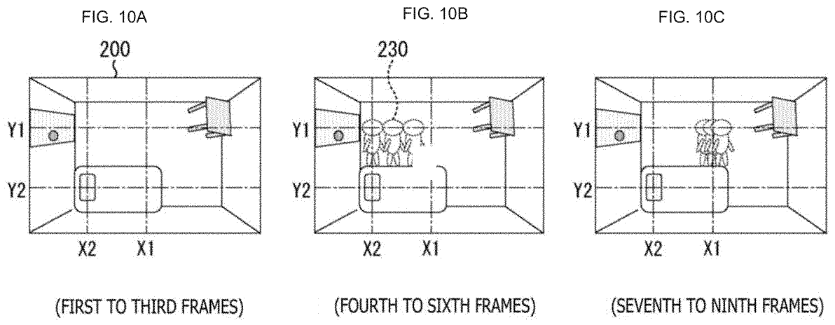

Problems conceivable from this method are described with reference to FIGS. 10 to 12. FIGS. 10 to 12 represent picked up images for 27 frames picked up successively in a picked up image stream when a room 200 used by a care receiver 230 is imaged in a superimposed relation three by three frames.

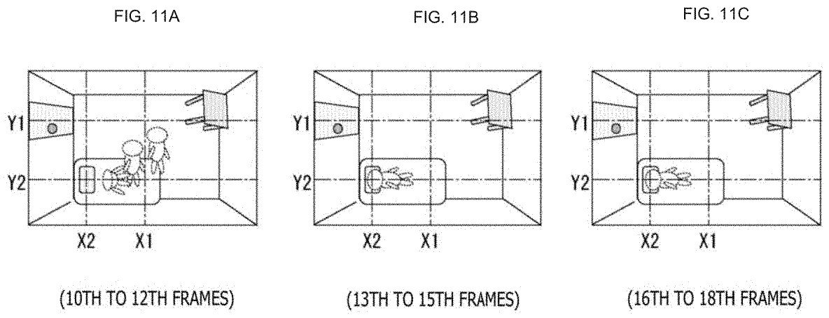

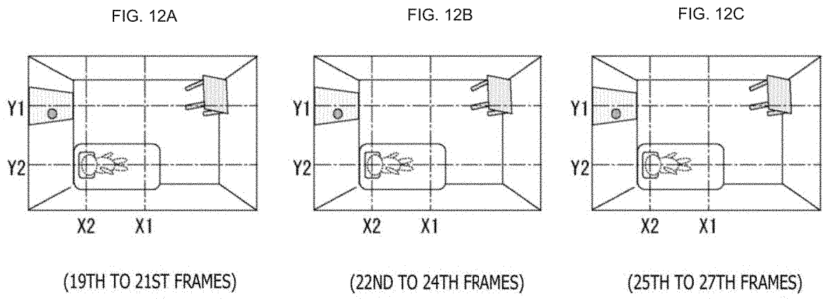

A of FIG. 10 represents first to third frames; B of FIG. 10 represents fourth to sixth frames; C of FIG. 10 represents seventh to ninth frames; D of FIG. 11 represents tenth to 12th frames; E of FIG. 11 represents 13th to 15th frames; F of FIG. 11 represents 16th to 18th frames; G of FIG. 12 represents 19th to 21st frames; H of FIG. 12 represents 22nd to 24th frames; and I of FIG. 12 represents 25th to 27th frames. In B of FIG. 10, C of FIG. 10 and D of FIG. 11, the care receiver 230 is represented changing its position in a horizontal direction three by three images. This represents that the care receiver 230 in the room 200 continuously moves during a period of time of the fourth frame to the 12th frame.

In the seventh to ninth frames depicted in C of FIG. 10, the imaging object picked up by pixels by which the place of coordinates (X1, Y1) is imaged is the head of the care receiver 230. If, in such a situation as just described, the IR illumination failure detection section 30 in the first and second embodiments uses the second example of the method for deciding whether or not there is a failure of the IR illumination section 21, then it can be conceived that no change is found between the data of the pixels by which the place of the coordinates (X1, Y1) is imaged in the seventh to ninth frames and, as a result, it is decided that the imaging object is stationary.

However, actually within a period from the seventh to ninth frames, the care receiver was moving continuously, and therefore, it is not necessarily appropriate to decide that the imaging object is stationary at the position of the coordinates (X1, Y1) within the period from the seventh to ninth frames.

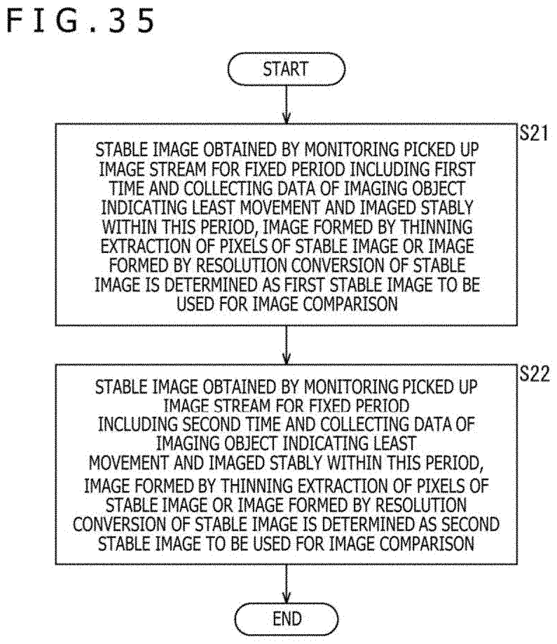

Therefore, in the third embodiment of the monitoring sensor apparatus 100, the IR illumination failure detection section 30 includes the stable image generation section 40 and the failure decision section 41. The stable image generation section 40 first separates a moving body (dynamic imaging object) and any other imaging object (static imaging object) with a higher degree of accuracy and then generates a plurality of images (stable images) that do not include a dynamic body. It is to be noted that a method for generating a stable image is hereinafter described with reference to FIG. 35. The failure decision section 41 compares the plurality of generated stable images to decide whether or not there is a failure of the IR illumination section 21.

In the first embodiment of the monitoring sensor apparatus 100, especially in the second example of the method for deciding whether or not there is a failure of the IR illumination section 21, it is decided which one of a moving body and a static body is imaged by each of the pixels of two picked up images picked up at different points of time, and pixels decided to image a static body in both of the two picked up images are extracted, and then average luminances of the pixels extracted from each of the two images are calculated and compared with each other.

In contrast, the stable image generation section 40 provided in the third embodiment continues to monitor a picked up image stream outputted from the imaging function section 20 for a fixed period of time and besides continues to analyze pixel data during the time to measure what the imaging object that indicates the least movement and continues to be imaged stably within this fixed period is. As a result, the stable image generation section 40 collects data of the imaging object decided to indicate the least movement and continue to be imaged stably during the fixed period in regard to all pixels included in the picked up images and outputs them as a stable image to the failure decision section 41 at the succeeding stage.

### <2-3-3C. Stable Image Generation Section 40>

A method performed by the stable image generation section 40 provided in the third embodiment for creating an image from which a moving body is removed (stable image) from within a picked up image stream inputted from the imaging function section 20 is described.

The stable image generation section 40 monitors and analyses a noticed pixel continually over a plurality of frames. As regards which one of pixels included in a picked up image is determined as a noticed pixel, all pixels included in the picked up image may be determined as noticed pixels such that monitoring and analysis are performed continually for each of the pixels. As an alternative, pixels may be extracted suitably by thinning over an overall area of a picked up image such that the pixels extracted by thinning may be determined as noticed pixels so as to be monitored and analyzed continually. As another alternative, on the basis of a picked up image, an image of a resolution lower than that of the picked up image (in other words, an image of a smaller image size) may be created using a general image resolution changing technology and all pixels of the image of the lower resolution or pixels thinned suitably are extracted and determined as noticed pixels to be monitored and analyzed continually.

Here, for the simplified description, assuming two pixels by which places of the coordinates (X1, Y1) and (X2, Y2) depicted in FIGS. 10 to 21 are imaged as noticed pixels, a method performed by the stable image generation section 40 for creating an image (stable image) from which a moving body is removed is described.

After the stable image generation section 40 sets the first pixel that images the place of the coordinates (X1, Y1) and the second pixel that images the place of the coordinates (X2, Y2) as noticed pixels, it continuously monitors data of the first and second pixels on each of picked up images included in a picked up image stream. Then, the stable image generation section 40 cumulatively measures, for example, what luminance values are imaged in how many frames, as indicators representative of an imaging object imaged by the first and second pixels.

It is to be noted that the following description is given assuming a case in which, as an example of a form of the stable image generation section 40, the imaging object luminance cumulative measurement period for which the stable image generation section 40 cumulatively measures the luminance of an imaging object is 9 frames.

Further, for the convenience of description, it is assumed that the luminance of a first imaging object (here, the floor of the room) disposed at the coordinates (X1, Y1) has a luminance level 1, the luminance of a second imaging object (here, the pillow) disposed at the coordinates (X2, Y2) has a luminance level 2, and the luminance of a third imaging object (here, the head of the care receiver) existing in the room has a luminance level 3.

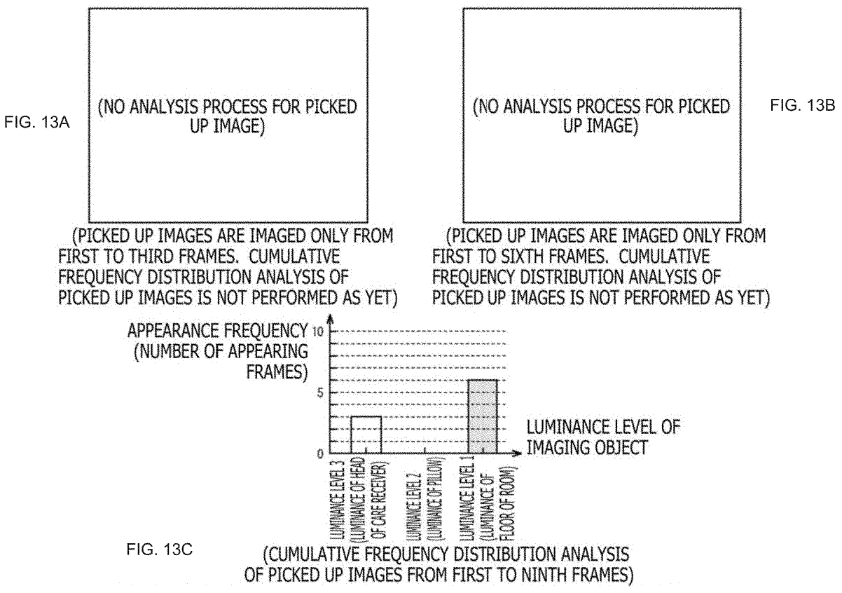

FIGS. 13 to 15 represent results of measurement by the stable image generation section 40 as a distribution of the luminance of the imaging object imaged by the first pixel in the first to 27th frames depicted in FIGS. 10 to 12 such that the results are represented in a cumulative frequency distribution graph in which their accumulation periods are successively displaced three by three frames for the convenience of description.

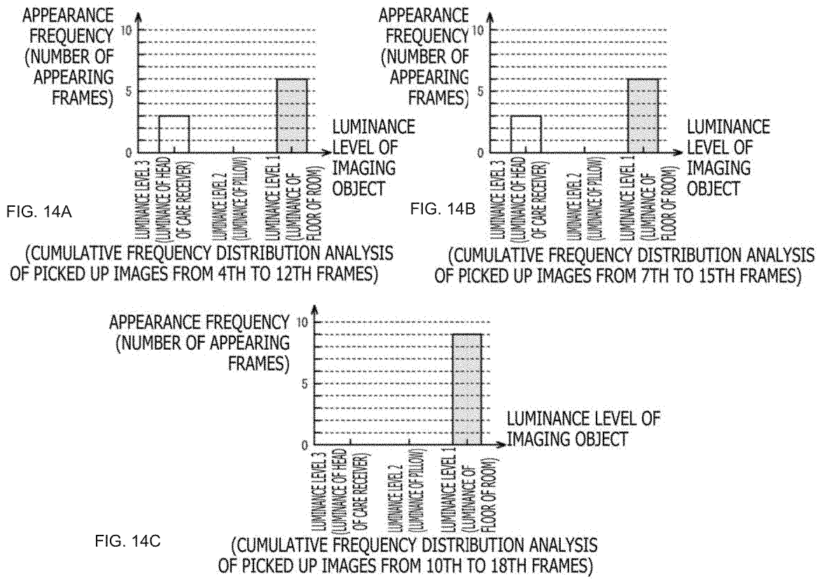

C of FIG. 13 represents that, within a period from the first to ninth frames, by the first pixel, the first imaging object (floor of the room) is imaged six times and the third imaging object (head of the care receiver) is imaged three times. F of FIG. 14 represents that, within a period from the tenth to 18th frames, by the first pixel, the first imaging object (floor of the room) is imaged nine times. Since the other figures included in FIG. 13 to FIG. 15 are similar to those described above, description of them is omitted here.

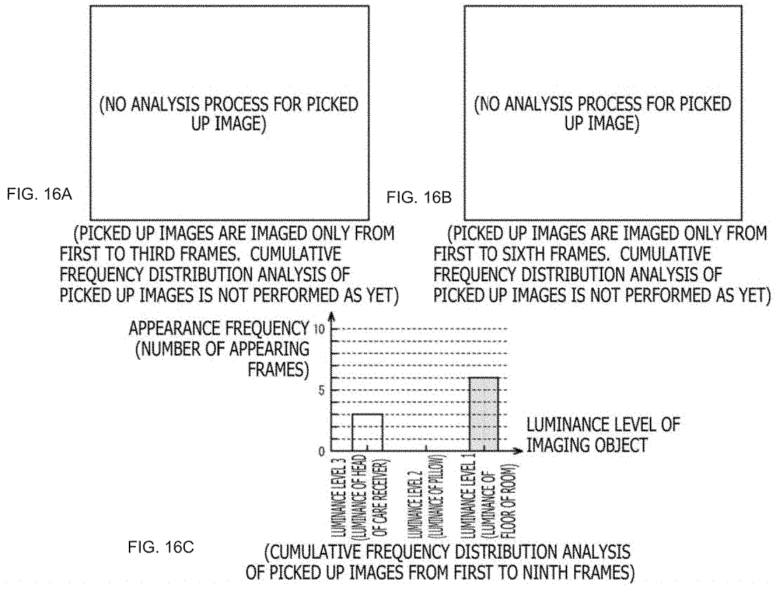

FIGS. 16 to 18 represent results of measurement by the stable image generation section 40 as a distribution of the luminance of the imaging object imaged by the second pixel in the first to 27th frames depicted in FIGS. 10 to 12 such that the results are represented in a cumulative frequency distribution graph in which their accumulation periods are successively displaced three by three frames for the convenience of description.

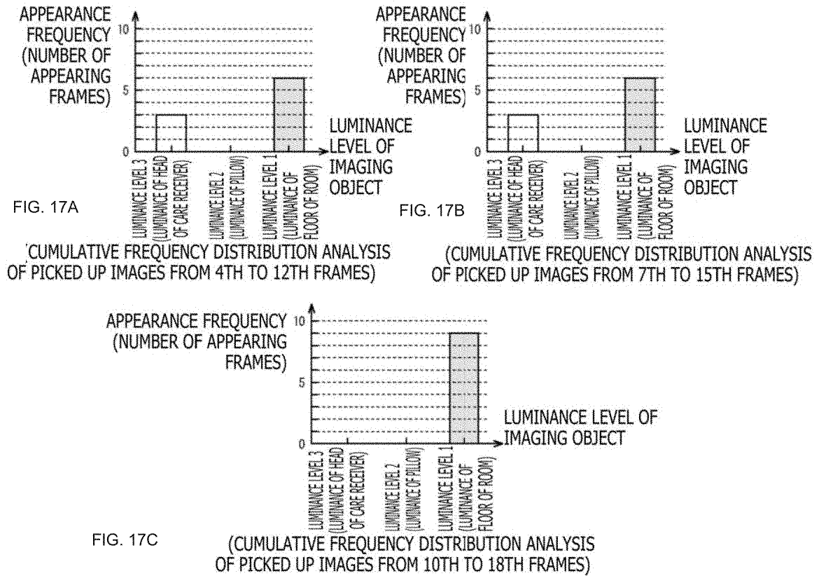

C of FIG. 16 represents that, within a period from the first to ninth frames, at the second pixel, the second imaging object (pillow) is imaged nine times. F of FIG. 17 represents that, within a period from the tenth to 18th frames, by the second pixel, the second imaging object (pillow) is imaged three times and the third imaging object (head of the care receiver) is imaged six times. Since the other figures included in FIG. 16 to FIG. 18 are similar to those described above, description of them is omitted here.

Now, description is given of in what manner, from measurement results by the stable image generation section 40 described hereinabove with reference to FIGS. 13 to 18, the stable image generation section 40 separates a moving body (dynamic imaging object) and any other imaging object (static imaging object) and outputs an image that does not include the moving body (stable image).

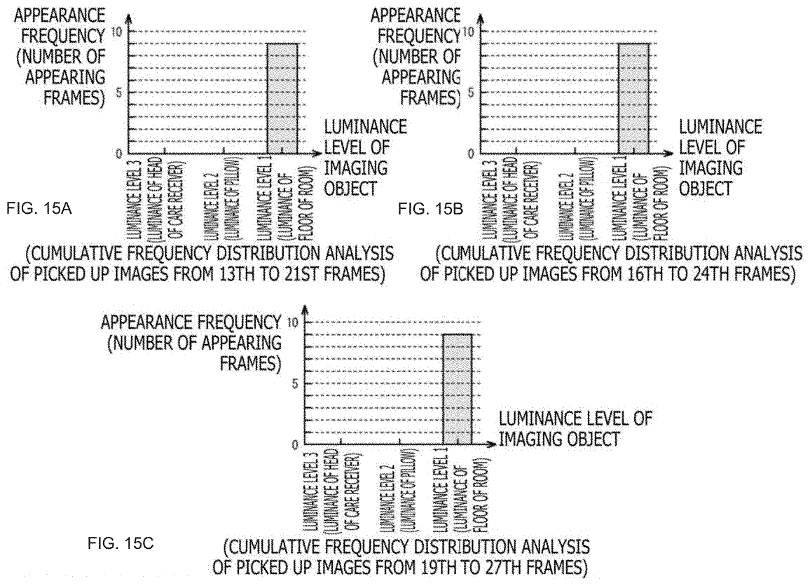

As depicted in A of FIG. 13 to I of FIG. 15, the stable image generation section 40 measures that the first pixel most frequently images the first imaging object (floor of the room) within all imaging object luminance cumulative measurement periods (for nine frames) from the first frame to the 27th frame. As a result, the stable image generation section 40 outputs, as an image that does not include a moving body (stable image), picked up image data of the first imaging object (floor of the room) at the portion of the first pixel in and after the first frame.

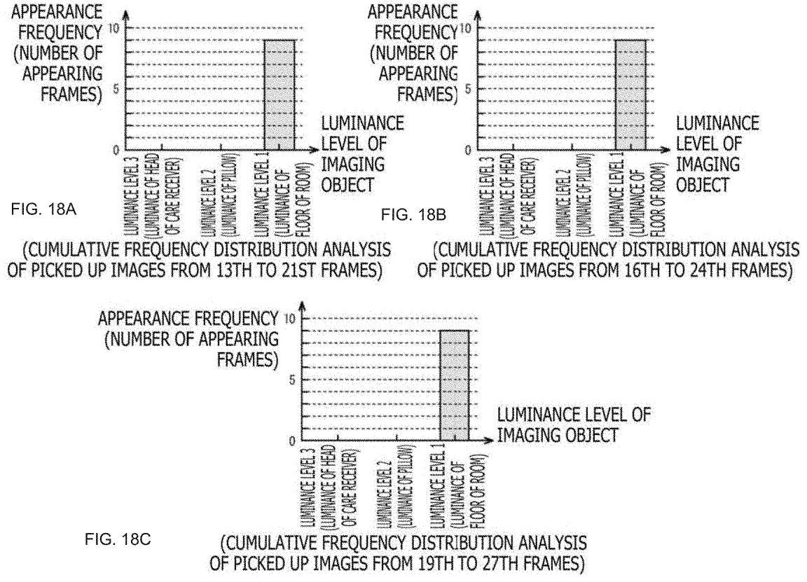

On the other hand, as depicted from A of FIG. 16 to I of FIG. 18, although, within a period from the first frame to the 15th frame, within any imaging object luminance cumulative measurement period, the stable image generation section 40 measures that the second pixel most frequently images the second imaging object (pillow), in and after the 18th frame, the stable image generation section 40 measures that the third imaging object (head of the care receiver) is imaged most frequently also within any imaging object luminance cumulative measurement period. As a result, the stable image generation section 40 outputs, at the portion of the second pixel as an image that does not include a moving body, picked up image data of the second imaging object (pillow) for a period from the first frame to the 18th frame, but thereafter outputs picked up image data of the third imaging object (head of the care receiver).

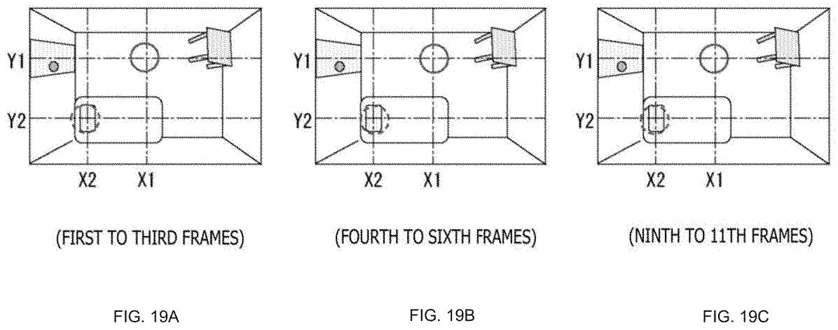

FIGS. 19 to 21 represent images (stable images), which are outputted within a period from the first to 27th frames on the basis of the images of the first to 27th frames depicted in FIGS. 10 to 12 from the stable image generation section 40 and do not include a moving body, such that they are superimposed three by three frames.

The stable image generation section 40 outputs, as images that do not include a moving body (stable images), for the first pixel that images the place of the coordinates (X1, Y1), picked up image data of the first imaging object (floor of the room) in and after the first frame to the failure decision section 41.

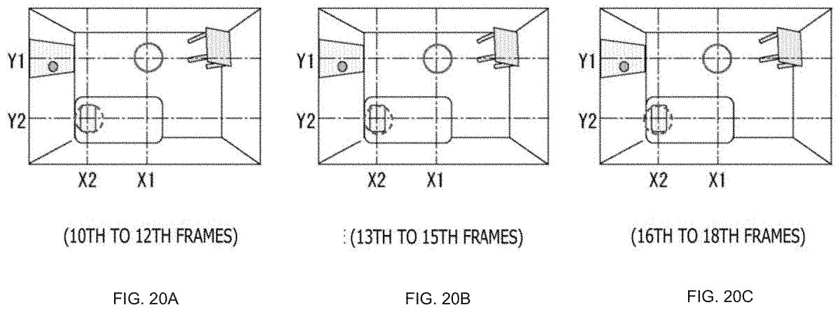

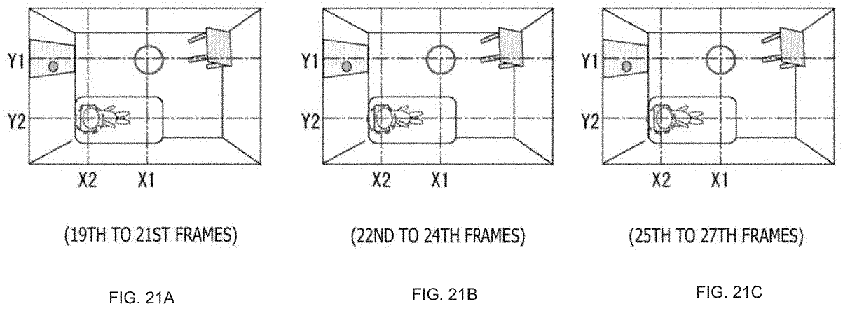

Further, the stable image generation section 40 outputs, as images that do not include a moving body (stable images), for the second pixel that images the place of the coordinates (X2, Y2), picked up image data of the second imaging object (pillow) till the 18th frame (to F of FIG. 20) to the failure decision section 41 and thereafter (in and after G of FIG. 21) outputs the picked up image data of the third imaging object (head of the care receiver) to the failure decision section 41.

It is to be noted that, although the foregoing description is directed to an example in which the stable image generation section 40 monitors all frame images (picked up images) included in a picked up image stream inputted from the imaging function section 20 to perform cumulative measurement of the imaging object luminance, there is no necessity to monitor all frame images (picked up images) to perform cumulative measurement of the imaging object luminance, and a plurality of temporally discrete frame images (picked up images) may be monitored to perform cumulative measurement of the imaging object luminance.

### <2-3-3D. Types of Stable Image>

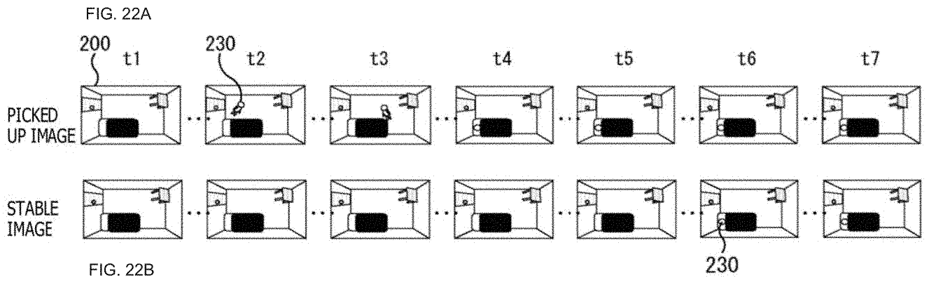

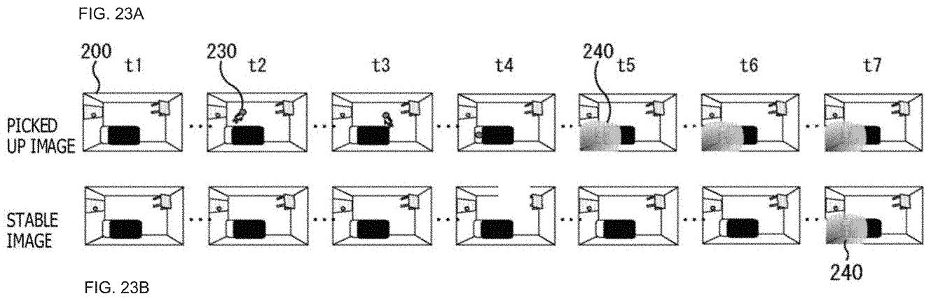

Now, a method of deciding a failure of the IR illumination section 21 by the failure decision section 41 in the third embodiment is described using two examples (FIGS. 22 and 23) of a stable image outputted from the stable image generation section 40.

<A. First Example of Stable Image>

FIG. 22 depicts picked up images picked by the imaging function section 20 in the third embodiment of the monitoring sensor apparatus 100 and a first example of a stable image created by the stable image generation section 40 on the basis of the picked up image.

Imaging operation of the monitoring sensor apparatus 100 is started at time t1. The picked up image picked up at time t1 that is an imaging operation start point becomes a stable image first (first stable image) outputted from the stable image generation section 40. After time t1, the stable image generation section 40 performs cumulative measurement of the imaging object luminance described above and outputs a stable image that does not include a moving body.

In picked up images picked up after time t1 till time t4, the care receiver continues to move. Therefore, the stable image generation section 40 removes, as an image that does not include a moving body, from picked up images picked up during the period from time t1 to time t4, the moving care receiver and fills the subdivision region, in which the care receiver has been, with a static article (background) existing behind the care receiver as an image thereby to create a stable image and successively outputs such stable images during the period from time t1 to time t4.

More particularly, it is sufficient if, in FIG. 22, after the stable image generation section 40 outputs the first stable image at time t1, the state in which the first stable image is outputted is maintained till time t4 without updating the stable image thereafter. Alternatively, during the period from time t1 to t4, every time a picked up image is picked up, the stable image generation section 40 may repetitively output the first stable image (first stable image).

The care receiver goes to bed and stops its movement at time t4 and continues to keep the same posture after time t4. As a result when the cumulative measurement of the imaging object luminance is continued, the stable image generation section 40 detects that, during a period from time t4 to time t6, the care receiver continues to assume the same posture and no moving body is included in the picked up images during the period. As a result, at time t6, the stable image generation section 40 outputs a picked up image including the care receiver who continues to keep the same posture as a second stable image (second stable image) to the failure decision section 41 and outputs that the stable image is changed to the failure decision section 41. The stable image generation section 40 thereafter outputs the second stable image continuously. In other words, it is sufficient if, after the stable image generation section 40 outputs the second stable image at time t6, the state in which the second stable image is outputted is maintained without updating the stable image thereafter. Alternatively, after time t6, every time a picked up image is picked up, the stable image generation section 40 may repetitively output the second stable image.

<B. Second Example of Stable Image>

FIG. 23 depicts a picked up image picked up by the imaging function section 20 in the third embodiment of the monitoring sensor apparatus 100 and a second example of a stable image created by the stable image generation section 40 on the basis of the picked up image.

In the second example, similarly as in the first example, an imaging operation of the monitoring sensor apparatus 100 is started at time t1, and the stable image generation section 40 outputs a first stable image at time t1.

Further, in the second example, similarly as in the first example, the care receiver continues to move in picked up images picked up after time t1 to time t4. Therefore, the stable image generation section 40 continues to output the first stable image during the period from time t1 to time t4. In particular, in FIG. 23, it is sufficient if, after the stable image generation section 40 outputs the first stable image at time t1, it maintains the state in which the first stable image is outputted till time t4 without updating the stable image later. Alternatively, during the period from time t1 to time t4, every time a picked up image is picked up, the stable image generation section 40 may repetitively output the first stable image (first stable image).

Further, in the second example, similarly as in the first example, the care receiver goes to bed and stops its movement at time t4 and continues to keep the same posture after time t4. However, in the second example, part of the IR illumination section 21 fails at time t5, and the illuminance of part of the imaging object indicates some decrease after time t5. Since the IR illumination section 21 fails and a portion 240 at which the imaging object illuminance decreases appears in the picked up image during the period from t4 to t5, the stable image generation section 40 decides that the imaging object is still in motion at time t6 and outputs the first stable image continuously also at time t6.

After time t5, both the illuminance of the imaging object and the posture of the care receiver indicate no change. Therefore, as a result when cumulative measurement of the imaging object luminance is continued, the stable image generation section 40 detects that no moving body is included in the picked up images during the period from time t5 to time t7. As a result, at time t7, the stable image generation section 40 outputs a picked up image, in which the imaging object illuminance decreases as a result of failure of part of the IR illumination section 21 and besides the care receiver continues to assume the same posture, as a stable image for the second stable image (second stable image) to the failure decision section 41 and outputs that the stable image is changed to the failure decision section 41. The stable image generation section 40 thereafter continues to output the second stable image. In other words, it is sufficient if, after the stable image generation section 40 outputs the second stable image at time t7, the state in which the second stable image is outputted is maintained without updating the stable image thereafter. Alternatively, after time t7, every time a picked up image is picked up, the stable image generation section 40 may repetitively output the second stable image.

As described above, as images that are outputted from the stable image generation section 40 to the failure decision section 41, two types are available.

An image of the first type outputted from the stable image generation section 40 to the failure decision section 41 is a stable image that is obtained by imaging a new imaging object and is outputted because the IR illumination section 21 is not in failure and besides the state of an imaging object (shape of the imaging object, reflection factor of the surface of the imaging object or the like) has become a state different from that of the imaging object that has been imaged in stable images till then (stable image displayed newly at time t6 of FIG. 22).

The two types of images outputted from the stable image generation section 40 to the failure decision section 41 are picked up images that are picked up because the illuminance of the imaging object decreases due to a failure in the IR illumination section 21 and are different from a stable image till that time (stable image displayed newly at time t7 of FIG. 23).

### <2-3-3E. Overview of Failure Decision Section 41>

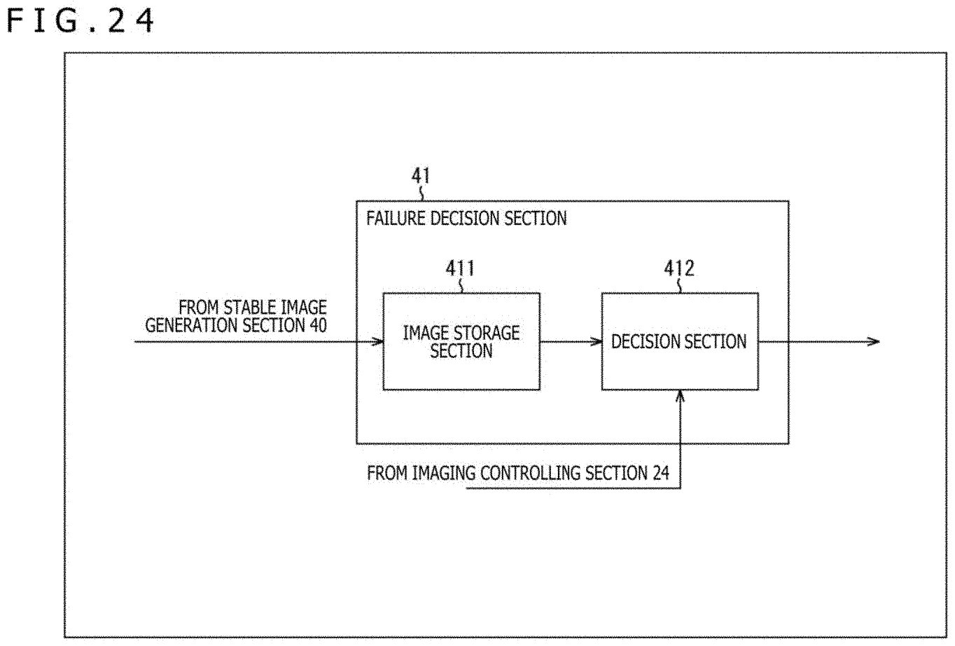

Now, a method performed by the failure decision section 41 in the third embodiment of the monitoring sensor apparatus 100 for deciding whether or not there is a failure of the IR illumination section 21 on the basis of an output from the stable image generation section 40 is described with reference to FIGS. 24 to 32.

The failure decision section 41 includes an image storage section 411 for storing at least two stable images outputted from the stable image generation section 40. As described hereinabove, every time the stable image generation section 40 changes a stable image to be outputted to the failure decision section 41, it notifies the failure decision section 41 that the stable image is changed. Every time the failure decision section 41 receives the notification that the stable image is changed from the stable image generation section 40, it stores the latest stable image into the image storage section 411 and compares, for example, the latest stable image and the second latest stable image with each other to decide whether or not a failure occurs with the IR illumination section 21.

It is to be noted that the comparison of stable images for failure decision by the failure decision section 41 is not limited to the example described above. In particular, the failure decision section 41 may sample at least two stable images to be made comparison targets displaced by a time interval from each other from among a plurality of stable images outputted from the stable image generation section 40 and compares the stable images of the comparison targets with each other. For example, the failure decision section 41 may sample and compare stable images at fixed time intervals (after every five minutes). As an alternative, the stable images may be sampled and compared at predetermined number of intervals (100 images or the like). As another alternative, even in the case where there is no change in stable image, in the case where, every time a picked up image is picked up by the imaging section 22, a stable image is outputted in synchronism with this from the stable image generation section 40 (in the case where the stable image has no change and the same stable image is outputted repetitively), every time a stable image is outputted, the latest stable image and the second latest stable image may be compared with each other irrespective of whether or not there is a change of the stable image.

The failure decision section 41 detects a failure of the IR illumination section 21 such that, from changes of the two types of stable images outputted from the stable image generation section 40, (1) a change of a stable image arising from decrease of an imaging object is not decided as a failure of the IR illumination section 21, but (2) a change of the stable image arising from decrease of the imaging object illuminance by a failure of the IR illumination section 21 is determined as a failure of the IR illumination section 21.

### <2-3-3F. First Configuration Example of Failure Decision Section 41>

FIG. 24 is a block diagram depicting a first example of the configuration of the failure decision section 41.

<A. Overview of First Configuration Example>

The first configuration example of the failure decision section 41 includes an image storage section 411 and an image comparison section 412.

To the image storage section 411 of the failure decision section 41, image data of a plurality of stable images and, in the case where a new stable image is generated, information for notifying this are inputted from the stable image generation section 40. To the image comparison section 412 of the failure decision section 41, information regarding an imaging condition of each picked up image in the case where a picked up image stream is picked up by the imaging section 22 and information regarding an image processing condition in the case where an image process (for example, a process for applying a gain) is performed for a picked up image by the image processing section 23 are inputted from the imaging controlling section 24.

The image storage section 411 has a capacity capable of storing at least two stable images of the latest stable image and the second latest stable image from stable images outputted from the stable image generation section 40 and stores them.

The image comparison section 412 compares images of the at least two stable images stored in the image storage section 411. In the case where the difference between the stable images is greater than a predetermined threshold value, the image comparison section 412 decides that the change of the stable image is (2) a change of the stable image arising from decrease of the imaging object illuminance by the failure of the IR illumination section 21 described hereinabove. As a result, the image comparison section 412 decides that a failure occurs with the IR illumination section 21. The failure decision section 41 outputs the decision result that a failure occurs with the IR illumination section 21 to the transmission controlling section 39. The transmission controlling section 39 outputs the decision result that a failure occurs with the IR illumination section 21 to the terminal apparatus 300 through the external apparatus 290.

<B. Details of Image Comparison Section 412>

The image comparison section 412 divides each of at least two stable images stored in the image storage section 411 into a plurality of subdivision regions 400 and calculates an indicator representative of a brightness (for example, an average luminance) of each of the plurality of subdivision regions 400.

Further, the failure decision section 41 decides, for each of the plurality of subdivision regions 400 included in the at least two stable images, whether or not the difference in indicator (for example, difference in average luminance) indicative of a brightness between the at least two stable images is equal to or greater than a threshold value. In the case where the difference in indicator representative of a brightness is equal to or smaller than a first threshold value determined in advance, the failure decision section 41 decides that the “difference is small,” but in the case where the difference in indicator representative of a brightness is greater than the first threshold value, the failure decision section 41 decides that the “difference is great.”

In the case where a subdivision region 400 decided that the “difference is great” is detected, the image comparison section 412 decides that the change that occurs between the at least two stable images is not (1) the change of the stable image arising from a change of the imaging object but (2) the change of the stable image arising from decrease of the imaging object illuminance by a failure of the IR illumination section 21, and decides that a failure occurs with the IR illumination section 21.

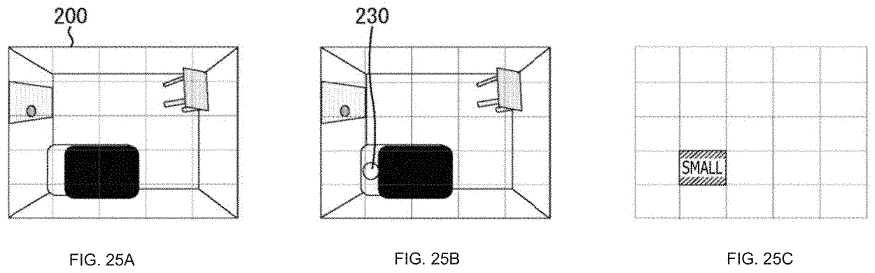

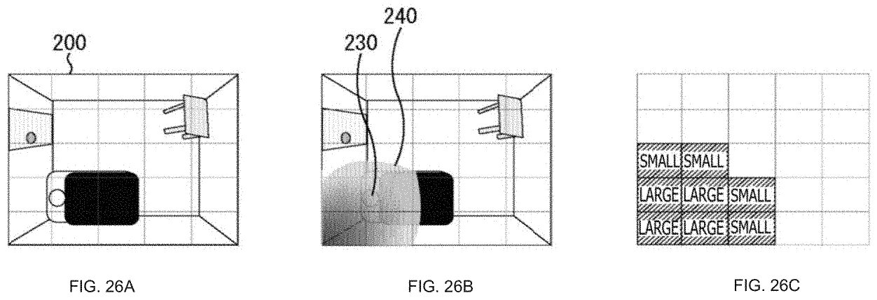

Operation of the failure decision section 41 in the case where the stable image generation section 40 outputs the first example (FIG. 22) and the second example (FIG. 23) of the stable image is described with reference to FIGS. 25 and 26.

A of FIG. 25 depicts a first stable image outputted at t1 in the first example (FIG. 22) of a stable image, and B of FIG. 25 depicts a second stable image outputted at t6 of FIG. 22. C of FIG. 25 depicts a decision result when A of FIG. 25 and B of FIG. 25 are compared with each other by the image comparison section 412. Where A of FIG. 25 and B of FIG. 25 are compared with each other, in B of FIG. 25, the care receiver who sleeps on the bed is newly imaged as an imaging object.

In the subdivision region 400 in which the care receiver is imaged, it is detected that there is a difference in indicator (for example, average luminance) representative of the brightness of the subdivision region 400 between the stable images of A of FIG. 25 and B of FIG. 25. However, the magnitude of the care receiver imaged newly in B of FIG. 25 is smaller than the magnitude of the subdivision region 400. Therefore, even if the care receiver is newly imaged as an imaging object in B of FIG. 25, the magnitude by which the indicator representative of the brightness of the subdivision region 400 changes is restrictive. Accordingly, the image comparison section 412 decides that the indicator representative of the brightness of the subdivision region 400 is decided that the “difference is small” between A of FIG. 25 and B of FIG. 25. In the case where the image comparison section 412 does not detect a subdivision region 400 that is decided that the “difference is great,” it decides that a failure does not occur with the IR illumination section 21 and decides that the change of the stable image during the period is (1) the change of the stable image arising from the change of the imaging object.

A of FIG. 26 depicts a first stable image outputted at t1 of the second example (FIG. 23) of the stable image and B of FIG. 26 depicts a second stable image outputted at t7 of FIG. 23. C of FIG. 26 depicts a decision result when A of FIG. 26 and B of FIG. 26 are compared with each other by the image comparison section 412. As a result of comparison between A of FIG. 26 and B of FIG. 26, in B of FIG. 26, an imaging object whose illuminance decreases by a failure of the IR illumination section 21 is imaged over a plurality of subdivision regions 400.

In the plurality of subdivision regions 400, it is detected that there is a difference in indicator (for example, average luminance) representative of the brightness of the subdivision region 400 between the stable images of A of FIG. 26 and B of FIG. 26. Besides, the range imaged under a low illuminance in B of FIG. 26 is greater than that of one subdivision region 400. Therefore, the change of the imaging object newly appearing in B of FIG. 26 covers, in the plurality of subdivision regions 400, the overall range of each subdivision region 400. By the change of the imaging object over the overall range of the subdivision region 400, the changing amount of the indicator representative of the brightness of the subdivision region 400 is great. Accordingly, the image comparison section 412 decides that the indicator representative of the brightness of each of the plurality of subdivision regions 400 indicates that the “difference is great” between A of FIG. 26 and B of FIG. 26 in the plurality of subdivision regions 400. In the case where the image comparison section 412 detects a subdivision region 400 decided that the “difference is great,” the image comparison section 412 decides that a failure of the IR illumination section 21 occurs.

It is to be noted that, in the case where the number of subdivision regions 400 decided that the “difference is great” is greater than a second threshold value determined in advance, the image comparison section 412 decides that a large scale change in image occurs between at least two stable images. In this case, the image comparison section 412 may decide that the change occurring between the at least two stable images is not (1) the change of the stable image arising from a change of the imaging object but (2) the change of the stable image arising from an illuminance decrease of the imaging object by a failure of the IR illumination section 21, and is a failure of the IR illumination section 21.

For example, in the case where the second threshold value is set to 2 (subdivision regions), in C of FIG. 25, the subdivision region 400 decided that the “difference is great” does not exist, and naturally, the number of subdivision regions 400 decided that the “difference is great” is smaller than the second threshold value. In this case, the image comparison section 412 decides that a failure of the IR illumination section 21 does not occur and decides that the change of the stable image during the period is (1) the change of the stable image arising from the change of the imaging object.

On the other hand, in C of FIG. 26, the number of subdivision regions 400 decided that the “difference is great” is four, and this number is greater than the second threshold value (two) determined in advance. In this case, the image comparison section 412 decides that the change is (2) the change of the stable image arising from illuminance decrease of the imaging object by a failure of the IR illumination section 21 and decides that a failure occurs with the IR illumination section 21.

As an alternative, the image comparison section 412 may have a third threshold value determined in advance and evaluate a stable image using the third threshold value to decide that a failure occurs with the IR illumination section 21.

A case in which the image comparison section 412 has the third threshold value is described with reference to FIG. 26. In B of FIG. 26, a case is supposed in which the emission light amount of some light sources of the IR illumination section 21 does not decrease restrictively but the light amount decreases significantly or little light is emitted. In this case, an image when an irradiation range of the failed IR light sources is imaged indicates a so-called almost pitch black state and data of pixels that image the range indicate a state almost proximate to zero.

In the case of such a state as just described, needless to compare stable images before and after failure (in short, A of FIG. 26 and B of FIG. 26) with each other, only by evaluating values of data of pixels in the image of B of FIG. 26 to evaluate whether or not the value of each pixel is lower than the third threshold value, it is possible to detect that a failure occurs with the IR illumination section 21. If the failure decision section 41 detects a failure of the IR illumination section 21 using the third threshold value before the stable images of A of FIG. 26 and B of FIG. 26 are compared with each other, then in the case where a significant failure occurs with the IR illumination section 21, the failure can be detected before the stable images of A of FIG. 26 and B of FIG. 26 are compared with each other. This makes it possible to reduce processes to be executed by the failure decision section 41 to detect a failure and reduce the power consumption involved in operation of the failure decision section 41.

It is to be noted that the size of the subdivision region 400 may be set in the following manner. In particular, the size of the subdivision region 400 may be set such that the range to be irradiated by one IR illumination section includes a plurality of subdivision regions 400. Furthermore, the size of the subdivision region 400 may be set such that the range irradiated by one IR illumination section includes a plurality of subdivision regions 400 in a longitudinal direction and a lateral direction on a plane of an imaging object to be imaged.

The size of the subdivision region 400 may be set to the desirable size described above at a point of time at which the monitoring sensor apparatus 100 is fabricated. As an alternative, after the monitoring sensor apparatus 100 is attached in a site in which it is to be actually used, a person who has performed the attachment or a person who is to use the monitoring sensor apparatus 100 may set the size of the subdivision region 400 to the desirable size described above while checking the range to be irradiated by each of a plurality of IR light sources included in the IR illumination section. As another alternative, while the monitoring sensor apparatus 100 itself causes the plurality of IR light sources provided in the apparatus to irradiate in order, it may pick up an image in each of the irradiation states to grasp the size irradiated by each of the IR light sources such that the size of the subdivision region 400 can be automatically set to the desirable size described above.

It is to be noted that, as another method for comparing the brightness of a plurality of stable images, the image comparison section 412 may perform comparison in a similar manner as in the first example of the failure decision method in the first embodiment without subdividing the stable images. In particular, for each of stable images to be made a comparison target, the value of an indicator representative of the brightness over the overall stable image may be determined such that resulting indicators are compared with each other.

<C. Details of Configuration for Monitoring Imaging Condition>

As described above, to the failure decision section 41, information regarding an imaging condition of each picked up image in the case where a picked up image stream is picked up by the imaging section 22 and information regarding an image processing condition in the case where an image process (for example, a process for applying a gain) is performed for a picked up image by the image processing section 23 are inputted from the imaging controlling section 24.

The failure decision section 41 monitors the information mentioned and decides that a failure occurs with the IR illumination section 21 in the case where, while a plurality of stable images to be compared by the image comparison section 412 are picked up, one of the imaging condition and the image processing condition changes by a greater amount than a predetermined threshold value in a direction suitable for imaging of an imaging object of a lower illuminance similarly as in the second embodiment of the monitoring sensor apparatus 100.

Further, the failure decision section 41 monitors the information mentioned above and, in the case where, while a plurality of stable images to be compared by the image comparison section 412 are picked up, one of the imaging condition and the image processing condition changes by a greater amount than a predetermined threshold value in a direction suitable for imaging of an imaging object of a higher illuminance, even if a result of the comparison of the images indicates that there is a difference in brightness of some subdivision region 400, the failure decision section 41 does not decide this as a failure of the IR illumination section 21 but decides that operation of the IR illumination section 21 is normal similarly as in the second embodiment of the monitoring sensor apparatus 100.

### <2-3-3G. Second Configuration Example of Failure Decision Section 41>

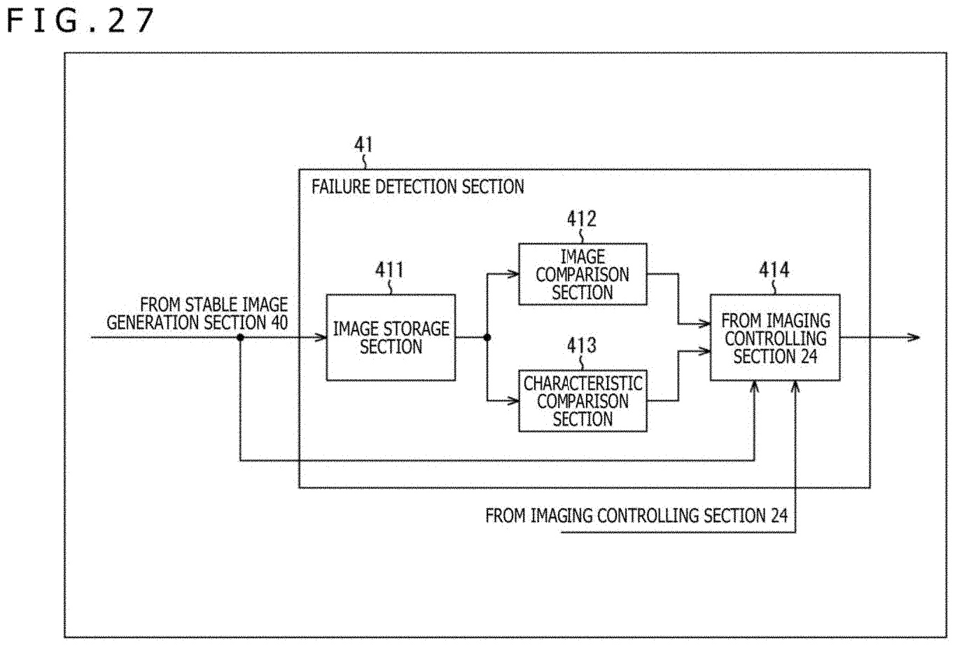

FIG. 27 is a view illustrating a second example of the configuration of the failure decision section 41. From among components of the second configuration example of the failure decision section 41, description of those that are common to those of the first configuration example is omitted.

<A. Overview of Second Configuration Example>

The second configuration example of the failure decision section 41 includes a characteristic comparison section 413 and a decision section 414 in addition to the components of the first configuration example. In the present second configuration example, similarly to the first configuration example, image data of a plurality of stable images and, in the case where a stable image is generated newly, information for notifying this from the stable image generation section 40 are inputted to the image storage section 411. Further, information regarding an imaging condition of each picked up image in the case where a picked up image stream is picked up by the imaging section 22 and information regarding an image processing condition in the case where an image process (for example, a process for applying a gain) for the picked up image by the image processing section 23 from the imaging controlling section 24 are inputted to the decision section 414. Furthermore, update information of a stable image from the stable image generation section 40 (information that a stable image is generated newly and outputted) is inputted to the decision section 414.

The image storage section 411 in the second configuration example stores, from among stable images outputted from the stable image generation section 40, at least the latest stable image and the second latest stable image similarly to that in the first configuration example.

The image comparison section 412 in the second configuration example compares images of at least two stable images stored in the image storage section 411 for each subdivision region 400 similarly as in the first configuration example. The image comparison section 412 notifies the decision section 414 of whether or not the difference of each subdivision region 400 between the stable images is greater than a first threshold value determined in advance as a result of the comparison. As an alternative, the image comparison section 412 notifies the decision section 414 of whether or not the number of subdivision regions 400 of the stable images in regard to which the difference is greater than the first threshold value determined in advance is greater than a second threshold value determined in advance.

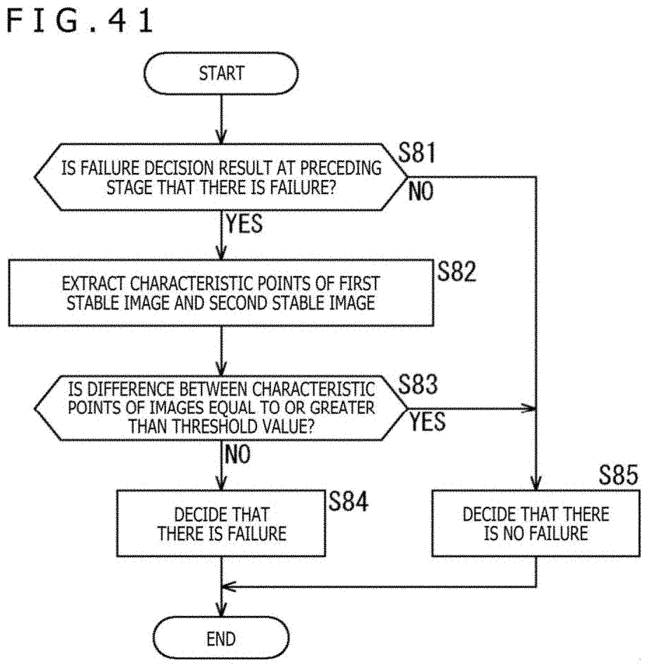

In parallel to this, the characteristic comparison section 413 in the second configuration example extracts, from each of a plurality of stable images outputted from the stable image generation section 40, characteristic points of an imaging object included in the image and compares the differences of the characteristic points between the stable images. Then, the characteristic comparison section 413 notifies a result of the comparison of the characteristic points between the stable images to the decision section 414. It is to be noted that a decision of whether or not there is a failure of the IR illumination section 21 based on the difference of characteristic points between a plurality of stable images is hereinafter described with reference to FIG. 41.

<B. Characteristic of Second Configuration Example>

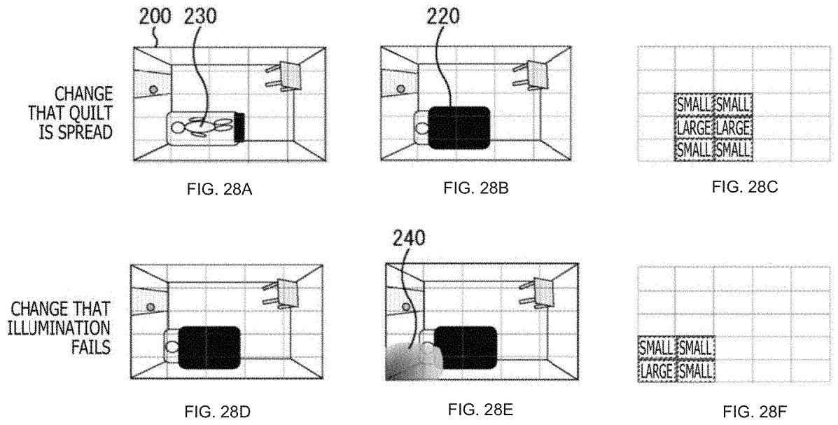

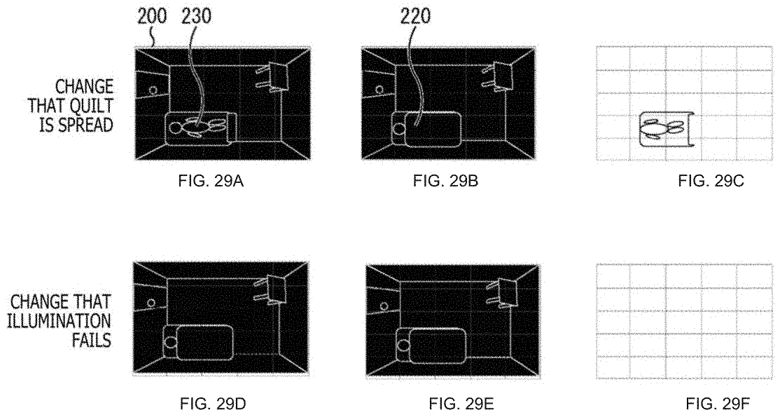

FIGS. 28 and 29 are views illustrating a difference in image comparison by the image comparison section 412 and the characteristic comparison section 413 in the second configuration example and a difference in operational effect provided by the difference.

FIG. 28 is a view illustrating a result obtained in the case where the image comparison section 412 in the second configuration example compares a plurality of stable images similarly to the image comparison section 412 in the first configuration example.

In regard to two types of stable images to be created by the stable image generation section 40, A of the figure, B of the figure and C of the figure depict cases in which, because (1) the IR illumination section 21 is free from a failure and besides the state of the imaging object (shape of the imaging object, reflection factor of the surface of the imaging object or the like) changes significantly, a new stable image is outputted. D of the figure, E of the figure and F of the figure depict cases in which, because (2) the IR illumination section 21 is in failure and consequently an image to be picked up changes, a new stable image is outputted.

It is to be noted that A of the figure represents a state in which a care receiver who is an imaging object lies on a sheet of a bed. Here, it is assumed that the sheet is an example of a cloth having the highest reflection factor among cloths existing in the room of the care receiver such as bedding, carpets and so forth. B of the figure represents a state in the case where the care receiver at bedtime spreads a piece of bedding having a lower reflection factor than the sheet such as a blanket over a wide range on the bed. D of the figure represents a state in which the care receiver of an imaging object lies in the bedding. E of the figure represents a state in which, although the imaging object is in a state same as that in D of the figure, since a failure occurs partly with the IR illumination section 21 and the emission light amount of the IR illumination section 21 decreases, the image in the range irradiated by the failed IR illumination section 21 becomes darker.

In B of the figure, since the bedding of a lower reflection factor is spread in the wide range on the bed, the image comparison section 412 outputs that, as a result of comparison of each subdivision region 400 included in A of the figure and B of the figure, the indicator of the brightness (for example, average luminance) in each of the two subdivision regions 400 decreases significantly as depicted in C of the figure and besides, also in the four subdivision region 400 around the two subdivision regions 400, the indicator of the brightness of the regions decreases to some degree.

On the other hand, in E of the figure, although the emission light amount decreases at part of the IR light sources provided in the IR illumination section, the magnitude of the region in which the illuminance of the imaging object decreases is smaller than the area in which the imaging object of a low reflection factor is spread as depicted in B of the figure. The image comparison section 412 outputs that, as a result of comparison of each subdivision region 400 included in D of the figure and E of the figure, the indicator of the brightness (for example, average luminance) in one subdivision region 400 decreases significantly as depicted in F of the figure and besides, also in the three subdivision region 400 around the subdivision region 400, the indicator of the brightness of the regions decreases to some degree.

It is to be noted that the image comparison section 412 in the second configuration example has a third threshold value similarly to the image comparison section 412 in the first configuration example. In particular, in the case where a new stable image is outputted from the stable image generation section 40 to the failure decision section 41, before the image comparison section 412 performs a process for comparing the latest stable image and the second latest stable image described hereinabove with each other, it evaluates whether or not the image data of the latest stable image is lower than the third threshold value determined in advance. This brings about an operational effect that, in the case where a serious failure occurs with the IR illumination section 21, it can be detected that a failure occurs with the IR illumination section 21 only by evaluating the magnitude of the image data of the latest stable image.

Here, a result that is obtained in the case where the image comparison section 412 in the second configuration example compares a plurality of stable images similarly to the image comparison section 412 in the first configuration example is considered. If it is assumed that a second threshold value is set in advance such that a change of the stable image detected in F of the figure can be decided as a failure of the IR illumination section 21, then a situation is conceivable in which also a change of the stable image detected in C of the figure is decided as a failure of the IR illumination section 21 in error.

Therefore, the second configuration example is characterized in that, in order to decide whether or not a failure occurs with the IR illumination section 21, the characteristic comparison section 413 is provided separately from the image comparison section 412.

<C. Details of Characteristic Comparison Section 413>

To the characteristic comparison section 413, a plurality of stable images stored in the image storage section 411 are inputted similarly to the image comparison section 412. The characteristic comparison section 413 extracts, from the inputted stable images, a characteristic of an imaging object imaged in the images. Further, the characteristic comparison section 413 compares the extraction result described above between the plurality of stable images and decides as a result of the comparison whether or not a significant difference exists between the plurality of stable images.

As an example of a method for extracting, comparing and deciding characteristics of an imaging object, any one of the following (1) to (3) may be applied.

(1) A contour component of an image is extracted for each of the subdivision regions 400 of a stable image. For example, the stable image is passed through a high pass filter. An extracted contour component is, for example, binarized. Then, a change of the binarized contour component is measured between subdivision regions 400 of each of a plurality of stable images. For example, a change in number of pixels extracted as a contour is measured. As an alternative, the number of pixels changed from pixels extracted as a contour to pixels that become not extracted as a contour as a result of comparison and the number of pixels indicating a change reverse to that are measured. Whether or not there is a difference in image is decided from the magnitude of the measurement result of one of the numbers.

(2) For each of the subdivision regions 400 of a stable image, contour components of the image are extracted. For example, the stable image is passed through a high pass filter. As an alternative, known texture extraction means may be used to extract a texture. Then, the shape of the extracted contour components or shape of the texture is compared between the subdivision regions 400 provided in each of the stable images to decide whether or not there exists a difference.

(3) For each of the subdivision regions 400 of a stable image, a frequency distribution of pixel data included in each region (pixel data before YC conversion) or a frequency distribution of luminance data of pixels after YC conversion is measured for each value of data. Then, the frequency distribution of each value of the measured data is compared between the subdivision regions 400 provided in each of the plurality of stable images to decide whether or not there is a difference.

FIG. 29 is a view illustrating results obtained in the case where the characteristic comparison section 413 provided in the failure decision section 41 of the second configuration example compares a plurality of stable images with each other. It is to be noted that FIG. 29 depicts, as an example of the characteristic comparison section 413, an example in which (1) contour components of a stable image are extracted and the number of pixels changed from pixels extracted as a contour to pixels that become not extracted as a contour and the number of pixels indicating a change reverse to that are measured, whereafter whether or not there is a difference in image is decided from the magnitude of the measurement result of one of the numbers. Description of common items to those in FIG. 28 from within the information relating to FIG. 29 is omitted as described above.

A of FIG. 29 and B of FIG. 29 represent results when, from among two types of stable images created by the stable image generation section, stable images in which a state of an imaging object (shape of the imaging object, reflection factor of the surface of the imaging object or the like) changes significantly similarly as in A of FIG. 28 and B of FIG. 28 are inputted to the characteristic comparison section 413 to perform a process for extracting a characteristic of the imaging object. It is to be noted that A of FIG. 29 and B of FIG. 29 depict results of binarization of contour components obtained by passing the two stable images through a high pass filter (not depicted) provided in the characteristic comparison section 413 as an example of a process performed by the characteristic comparison section 413.

Therefore, A of FIG. 29 and B of FIG. 29 indicate binarized images representative of whether each component is a high frequency component (so-called contour component). C of FIG. 29 represents a result when a difference between the image of A of FIG. 29 and the image of B of FIG. 29 is determined by the characteristic comparison section 413. As a result when the care receiver performs operation of spreading a piece of bedding having a low reflection factor, the shape of the imaging object changes, and this is indicated as a change of the contour of the imaging object in C of FIG. 29.

D of FIG. 29 and E of FIG. 29 represent results when, from between two types of stable images created by the stable image generation section 40, the stable image in which the imaging object illuminance changes as a result of a failure in the IR illumination section 21 similarly as in D of FIG. 28 and E of FIG. 28 is inputted to the characteristic comparison section 413 and the characteristic comparison section 413 performs a process for extracting a characteristic of the imaging object.

It is to be noted that D of FIG. 29 and E of FIG. 29 depict results of binarization of contour components obtained by passing two stable images through the high pass filter (not depicted) provided in the characteristic comparison section 413 as an example of a process performed by the characteristic comparison section 413. Therefore, D of FIG. 29 and E of FIG. 29 represent binarized images representative of whether each component is a high frequency component (so-called contour component). F of FIG. 29 represents a result when a difference between the image of D of FIG. 29 and the image of F of FIG. 29 is determined by the characteristic comparison section 413. It is indicated in F of FIG. 29 that, although a failure that the emission light amount decreases occurs with part of the IR illumination section 21, since there is no difference in shape of the room and the care receiver that are an imaging object, a change of the contour of the imaging object is not detected.

In the case where a change occurs with a stable image due to a change of a state of an imaging object (shape of the imaging object, reflection factor of the surface of the imaging object or the like) from between two types of stable images created by the stable image generation section 40 as depicted in A of FIG. 29 and B of FIG. 29, the characteristic comparison section 413 in the second configuration example obtains a comparison result that there is a change in contour component of the imaging object as depicted in C of FIG. 29 and notifies the obtained result to the decision section 414.

On the other hand, in the case where a failure occurs with the IR illumination section 21 and an image picked up in this case changes to cause a change in the stable image as depicted in D of FIG. 29 and E of FIG. 29, the characteristic comparison section 413 obtains a comparison result that there is no change in the contour components of the imaging object as depicted in F of FIG. 29 and notifies the obtained result to the decision section 414.

<D. Details of Decision Section 414>

The decision section 414 in the second configuration example uses four different inputs, namely, update information of a stable image (information that a new stable image is generated and outputted) from the stable image generation section 40, a decision result by the image comparison section 412, a decision result by the characteristic comparison section 413 and information regarding an imaging condition from the imaging controlling section 24 to decide whether or not a failure occurs with the IR illumination section 21, and outputs, in the case where a failure occurs, this fact to the terminal apparatus 300 through the external apparatus 290.

An example of a method of deciding whether or not a failure occurs with the IR illumination section 21 by the decision section 414 in the second configuration example is described.

The decision section 414 in the second configuration example includes, as a first stage of the configuration for performing the decision described above, a first decision section (not depicted) for deciding whether or not there is a failure of the IR illumination section 21 using the imaging condition and the information regarding the image processing condition from the imaging controlling section 24. If update information (information that a new stable image is created and outputted) from the stable image generation section 40 is inputted, then the first decision section decides presence or absence of a change, namely, whether or not a change occurs with the imaging condition for a picked up image in the imaging section 22 and the image processing condition in the case where an image process (for example, a process for applying a gain) is performed for the picked up image by the image processing section 23 within the period after a picked up image on which the second latest stable image is to be based begins to be imaged till the image pickup of a picked up image on which the latest stable image is to be based ends, on the basis of the imaging condition and the information regarding the image processing condition from the imaging controlling section 24.

Then, similarly as in the first configuration example of the failure detection section 41 described hereinabove, in the case where one of the imaging condition and the image processing condition indicates a change by an amount greater than a predetermined threshold value in a direction in which it is suitable for imaging of an imaging object of a lower illuminance within a period after imaging of a picked up image on which the second latest stable image is to be based is started until the imaging of a picked up image on which the latest stable image is to be based is ended, the decision section 414 decides that a failure occurs with the IR illumination section 21.

Further, similarly as in the first configuration example of the failure detection section 41 described hereinabove, in the case where one of the imaging condition and the image processing condition indicates a change by an amount greater than a predetermined threshold value in a direction in which it is suitable for imaging of an imaging object of a higher illuminance within a period after imaging of a picked up image on which the second latest stable image is to be based is started until the imaging of a picked up image on which the latest stable image is to be based is ended, even if a result of the comparison of the images indicates that there is a difference in brightness of some subdivision region 400, the decision section 414 does not decide this as a failure of the IR illumination section 21 but decides that operation of the IR illumination section 21 is normal.

The decision section 414 in the second configuration example further includes, at a next stage of the first decision section, a second decision section (not depicted) that monitors an imaging condition of a picked up image picked up at a time determined in advance every day and decides on the basis of the information whether or not a time dependent abnormality occurs with the IR illumination section 21.

For example, in the case where the measurement time is 12 o'clock at night, the IR illumination failure detection section 30 sets the imaging condition of a picked up image at 12 o'clock at night on the first day of system operation as an initial value for the imaging condition and compares the imaging condition of a picked up image picked up at 12 o'clock at night every day after that with the initial value. Then, in the case where the imaging condition (for example, exposure time) of the picked up image picked up newly changes by a fixed value or more, for example, 20% or more, from the initial value, the IR illumination failure detection section 30 detects this as a failure. Consequently, for example, in the case where the illuminance decreases by time dependent deterioration of the IR light source or the illuminance decreases by continuous accumulation of dust on a glass cover provided in the IR illumination section 21, an operational effect that this can be detected as an abnormality is brought about. It is to be noted that the setting of an imaging condition that is to be used as an initial value is not limited to the first day of system operation, but, for example, in the case where an input switch for resetting the initial value is provided and is depressed by a user of the system, the imaging condition upon imaging later at the next setting time can be made an initial value.

The decision section 414 of the second configuration example includes, at the following stage of the second decision section, a third decision section (not depicted) that decides whether or not there is a failure of the IR illumination section 21 utilizing a decision result that uses a third threshold value in the image comparison section 412. If a notification that image data of the latest stable image outputted from the stable image generation section 40 is lower than the third threshold value is notified from the image comparison section 412 to the third decision section, then the third decision section decides that a failure that the emission light amount decreases significantly occurs in the IR illumination section 21.

Here, a further operational effect by the third decision section is described. If a failure that the emission light amount decreases significantly in part of the light sources provided in the IR illumination section 21, then it becomes difficult for the characteristic comparison section 413 in the second configuration example to extract a contour or a texture of an imaging object. If, although a contour or a texture is detected at first time before occurrence of a failure, a contour or a texture cannot be detected at all at second time after occurrence of a failure, then since the characteristic comparison section 413 decides a change of a characteristic of the image, it may decide in error that a large scale shape change of the imaging object occurs within a period between the first time and the second time and the contour or the texture of the imaging object may decrease significantly, resulting the possibility that a failure of the IR illumination section 21 may be overlooked.

In contrast, where the decision section 414 uses also a decision result of the third decision section, even in the case where a failure that the illuminance of IR light decreases to such a degree that it is difficult for the characteristic comparison section 413 to detect a contour or a texture occurs with the IR illumination section 21, the failure of the IR illumination section 21 can be detected correctly.

The decision section 414 in the second configuration example includes, at the following stage of the third decision section, a fourth decision section (not depicted) that decides whether or not there is a failure of the IR illumination section 21 using a decision result where the first and second threshold values are used in the image comparison section 412 and a decision result by the characteristic comparison section 413.

The fourth decision section refers, in response to a notification of a decision result that the difference in image between the latest stable image and the second latest stable image is great by the decision where the first and second threshold values are used by the image comparison section 412, to a decision result by the characteristic comparison section 413. Then, in the case where a decision result that the difference in image occurring between the latest stable image and the second latest stable image does not arise from a change of the state of the imaging object (shape of the imaging object, reflection factor of the surface of the imaging object or the like) is obtained, the fourth decision section decides that a failure occurs with the IR illumination section 21.

It is to be noted that, as a different method by the image comparison section 412 for comparing the brightness of a plurality of stable images, the stable images may be compared without being subdivided similarly as in the case of the first example of the failure decision method in the first embodiment. In particular, for each of stable images to be made a comparison target, a value of an indicator representative of the brightness over an overall stable image may be determined, and such determined indicators may be compared with each other.

<E. Output of Decision Result to Outside>

In the case where the first, second, third or fourth decision section decides that a failure occurs with the IR illumination section 21, the decision section 414 outputs the decision to the transmission controlling section 39. The transmission controlling section 39 outputs the decision result that a failure occurs with the IR illumination section 21 to the terminal apparatus 300 through the external apparatus 290.

### <2-3-3H. Third Configuration Example of Failure Decision Section 41>

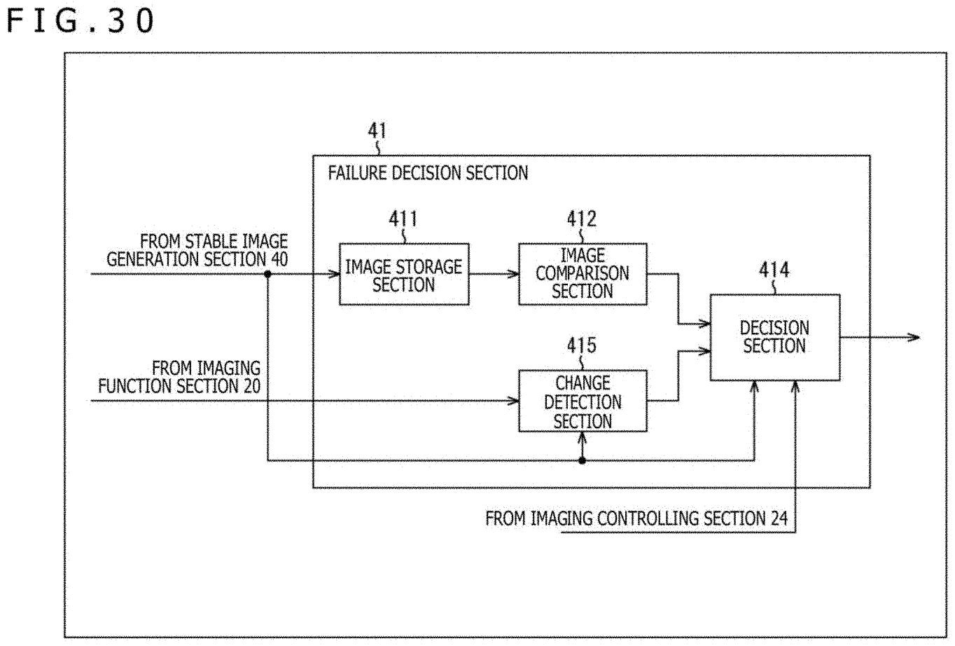

FIG. 30 is a view depicting a third configuration example of the failure decision section 41. In describing the third configuration example of the failure decision section 41, matters common to those of the second configuration example are described at part thereof with reference to the figures relating to the second configuration example, and description of the other part is omitted.

<A. Characteristic of Third Configuration Example>

The second configuration example of the failure decision section 41 described above includes the image comparison section 412 for detecting a change of the brightness of each subdivision region 400 of a stable image in order to decide, in the case where a change occurs with a stable image, whether the change is a change arising from a change of the imaging object or a change arising from a failure of the IR illumination section 21.

The image comparison section 412 compares images of a plurality of stable images to decide whether or not a change in image of a level equal to or higher than a level that can be regarded as a failure of the IR illumination section 21 occurs. Here, if the decision level is set such that the change of a stable image described in F of FIG. 28 can be detected, then a first subject is conceivable that it is decided in error that also the change of the stable image detected in C of FIG. 28 is a failure of the IR illumination section 21.

Therefore, the second configuration example of the failure decision section 41 is configured such that it further includes the characteristic comparison section 413 and that a decision of whether or not a change occurs with a contour of an imaging object or a shape of a texture is added to prevent erroneous detection of a failure of the IR illumination section 21.

However, if a failure that the emission light amount from part of the light sources provided in the IR illumination section 21 decreases significantly occurs, then it becomes difficult for the characteristic comparison section 413 in the second configuration example to extract a contour or a texture of an imaging object. Therefore, a second subject is conceivable that the characteristic comparison section 413 in the second configuration example decides in error that a large scale shape change of the imaging object occurs through comparison of stable images acquired before and after occurrence of a failure of the IR illumination section 21.

Therefore, the failure decision section 41 of the second configuration example is configured such that, in the case where the emission light amount of the IR illumination section 21 decreases exceeding a threshold value, the third decision section provided in the decision section 414 detects this as a failure of the IR illumination section thereby to prevent erroneous decision based on an output from the characteristic comparison section 413.

The third configuration example of the failure decision section 41 depicted in FIG. 30 solves the first and second subjects described above by a method different from that by the failure decision section 41 of the second configuration example.

<B. Overview of Third Configuration Example>

As depicted in FIG. 30, the failure decision section 41 of the third configuration example includes an image storage section 411, an image comparison section 412, a change detection section 415 and a decision section 414. In the third configuration example, to the image storage section 411, image data of a plurality of stable images and, in the case where a new stable image is generated, information for notifying this are inputted from the stable image generation section 40.

To the decision section 414, information of an imaging condition of each picked up image in the case where a picked up image stream is picked up by the imaging section 22 and information regarding an image processing condition in the case where an image process (for example, a process for applying a gain) for a picked up image by the image processing section 23 are inputted from the imaging controlling section 24. Further, to the decision section 414, update information of a stable image (information that a new stable image is generated and outputted) from the stable image generation section 40 is inputted. Meanwhile, to the change detection section 415, update information of a stable image (information that a new stable image is generated and outputted) from the stable image generation section 40 is inputted and a picked up image stream picked up by the imaging function section 20 is inputted from the imaging function section 20.

The image storage section 411 in the third configuration example stores, from among stable images outputted from the stable image generation section 40, images of the latest stable image and the second latest stable image similarly to the image storage section 411 in the second configuration example.

The image comparison section 412 in the third configuration example compares images of at least two stable images stored in the image storage section 411 and decides from the magnitude of the difference between them whether or not a failure occurs with the IR illumination section 21 similarly to the image comparison section 412 in the second configuration example.

In regard to the image comparison section 412, a subject is conceivable that, if the decision level is set such that a change of a stable image detected in F of FIG. 28 can be decided as a failure of the IR illumination section 21, then also a change of a stable image detected in C of FIG. 28 is decided as a failure of the IR illumination section 21 in error. In order to solve this, the third configuration example further includes the change detection section 415.

The change detection section 415 compares picked up images included in a picked up image stream inputted from the imaging function section 20 to detect a change of an image. On the basis of a result of the detection, the change detection section 415 decides whether a change of a stable image inputted from the imaging function section 20 has occurred in a short period of time or has occurred over a certain amount of time. In particular, in the case where the stable image is updated to a new stable image, whether the change of the imaging object occurred between the latest stable image and the second latest stable image has occurred in a short period of time or over a certain amount of time is decided by comparing picked up images picked up between the latest stable image and the second latest stable image with each other to detect a change between them.

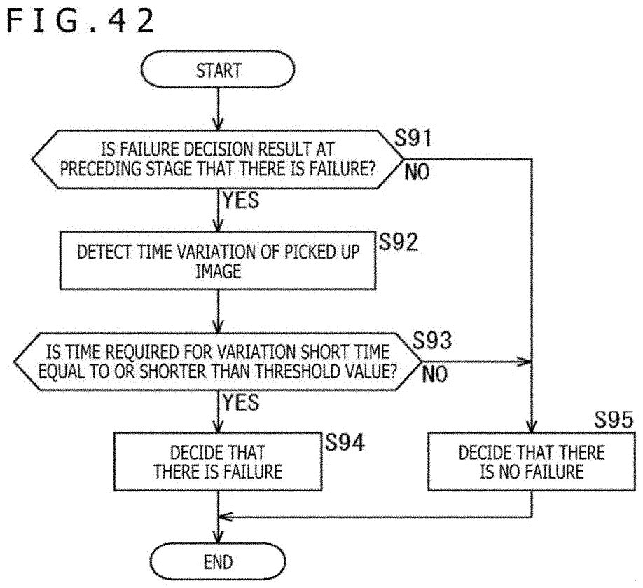

The decision section 414 in the third configuration example uses also a decision result by the change detection section 415 in addition to a decision result by the image comparison section 412 to prevent such a large scale change of the imaging object as depicted in C of FIG. 28 from being detected as a failure of the IR illumination section 21 in error thereby to detect a failure more correctly. It is to be noted that the decision of whether or not there is a failure of the IR illumination section 21 based on the speed of a change of a picked up image is hereinafter described with reference to FIG. 42.

<C. Details of Change Detection Section 415>

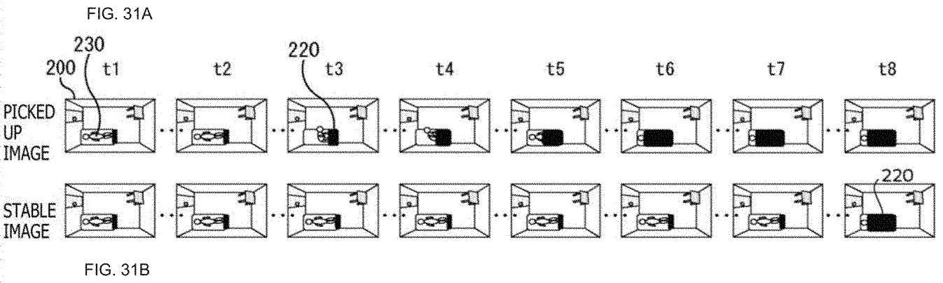

FIG. 31 is a view illustrating generally in what time lapse a large scale change of the state of an imaging object (shape of the imaging object, reflection factor of the surface of the imaging object or the like), which is caused by that the care receiver puts on a piece of bedding as depicted in A of FIG. 28 to B of FIG. 28, occurs.

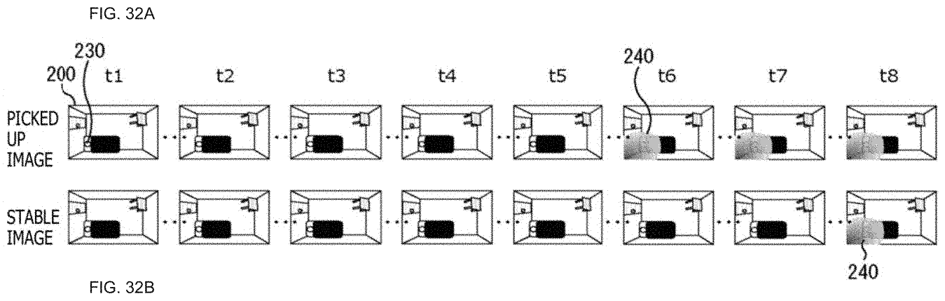

FIG. 32 is a view illustrating generally in what time lapse an emission light amount decrease of part of the light sources provided in the IR illumination section 21, which is depicted in D of FIG. 28 to E of FIG. 28, occurs.

Referring to FIG. 31, the change of the imaging object occurring in the proximity of the bed when the care receiver puts on a piece of bedding occurs as a gradual change from time t2 to time t6. On the other hand, an illuminance decrease caused by a failure of the IR illumination section 21 in FIG. 32 does not occur till time t5 but occurs abruptly at time t6.

The change detection section 415 compares the latest picked up image and the second latest picked up image with each other from among picked up images included in a picked up image stream inputted from the imaging function section 20 every time a new picked up image is inputted. The change detection section 415 then detects whether or not there is a change between the two images. Thus, the change detection section 415 is configured such that it determines in advance a threshold value, which becomes the boundary for determining whether a change of an image has occurred abruptly or has occurred over a certain amount of time, and retains the threshold value. The change detection section 415 decides whether the change of the image is a change occurring over an amount of time exceeding this threshold value or a change occurring in a short period of time equal or shorter than the threshold value, and notifies a result of the decision to the decision section 414.

For example, in the case where a period corresponding to two units of time lapse represented by time ti in FIGS. 31 and 32 is used as the threshold value, since the change when the care receiver puts on a piece of bedding occurring in the picked up images from time t2 to time t6 depicted in FIG. 31 is a change that occurs over four units of the time lapse represented by time ti, it is decided as a change occurring over a period of time exceeding the threshold value. Meanwhile, since the illuminance decrease by a failure of the IR illumination section 21 that occurs in a picked up image between time t5 and time t6 represented in FIG. 32 is a change occurring within one unit of time lapse represented by time ti, it is decided as a change occurring in a short period of time equal to or smaller than the threshold value.

<D. Details of Decision Section 414>

The decision section 414 in the third configuration example uses four inputs, namely, update information of a stable image (information that a new stable image is generated and outputted) from the stable image generation section 40, a decision result by the image comparison section 412, a decision result by the change detection section 415 and information regarding an imaging condition from the imaging controlling section 24 to decide whether or not a failure occurs with the IR illumination section 21, and outputs, in the case where a failure occurs, this fact to a terminal apparatus 300 through the external apparatus 290.

A configuration provided in the decision section 414 in the third configuration example for deciding whether or not a failure occurs with the IR illumination section 21 is described.

The decision section 414 in the third configuration example includes, as a first stage of the configuration for performing the decision described above, a first decision section (not depicted) for deciding whether or not there is a failure of the IR illumination section 21 using an imaging condition and an image processing condition from the imaging controlling section 24. If update information (information that a new stable image is generated and outputted) from the stable image generation section 40 is inputted, then the first decision section decides, on the basis of the information regarding the imaging condition and the image processing condition from the imaging controlling section 24, presence or absence of a change in regard to whether there is a change in the imaging condition of a picked up pixel in the imaging section 22 and the image processing condition in the case where an image process (for example, a process for applying a gain) for a picked up image by the image processing section 23 during a period after imaging of an image pickup image on which the second latest stable image is to be based is started until imaging of a picked up image on which the latest stable image is to be based is ended.

Then, the first decision section decides that a failure occurs with the IR illumination section 21 in the case where, during a period after imaging of a picked up image on which the second latest stable image is to be based is started until imaging of a picked up image on which the latest stable image is to be based is ended, one of the imaging condition and the image processing condition changes by a greater amount than a predetermined threshold value in a direction suitable for imaging of an imaging object of a lower illuminance.

On the other hand, in the case where, during a period after imaging of a picked up image on which the second latest stable image is to be based is started until imaging of a picked up image on which the latest stable image is to be based is ended, one of the imaging condition and the image processing condition changes by a greater amount than a predetermined threshold value in a direction suitable for imaging of an imaging object of a higher illuminance, even if a result of comparison of the images indicates that there is a difference in brightness of part of the subdivision regions 400, the first decision section does not decide this as a failure of the IR illumination section 21 but decides that operation of the IR illumination section 21 is normal.

The decision section 414 in the third configuration example further includes, at a next stage of the first decision section, a second decision section (not depicted) that monitors an imaging condition of a picked up image picked up at determined time every day and decides on the basis of the information whether or not some time dependent abnormality occurs with the IR illumination section 21.

For example, in the case where the second decision section sets the measurement time to 12 o'clock at night, the IR illumination failure detection section 30 sets the imaging condition of a picked up image at 12 o'clock at night on the first day of system operation as an initial value for the imaging condition and compares the imaging condition of a picked up image picked up at 12 o'clock at night every day after that with the initial value. Then, in the case where the imaging condition (for example, exposure time) of the picked up image picked up newly changes by a fixed value or more, for example, by 20% or more, from the initial value, the second decision section can detect this as a failure. Consequently, for example, in the case where the illuminance decreases by time dependent deterioration of the IR light source or the illuminance decreases by continuous accumulation of dust on a glass cover provided in the IR illumination section 21, this can be detected as abnormality. It is to be noted that the setting of an imaging condition that is to be used as an initial value is not limited to the first day of system operation, but, for example, in the case where an inputting switch for resetting the initial value is provided and is depressed by a user of the system, the imaging condition upon imaging later at the next setting time can be made an initial value.

The decision section 414 in the third configuration example further includes, at the following stage of the second decision section, a third decision section (not depicted). The third decision section decides, on the basis of a detection result by the image comparison section 412 and a detection result by the change detection section 415, in the case where a stable image changes, whether or not the change arises from a failure of the IR illumination section 21. The third decision section refers to a decision result by the change detection section 415 in response to a notification of a decision result that the difference of an image is great between the latest stable image and the second latest stable image by a decision using the first and second threshold values by the image comparison section 412. In the case where it is decided by the image comparison section 412 that the stable image changes by a great amount exceeding the threshold value therefor and besides it is detected by the change detection section 415 that the change of the stable image is a change over an amount of time exceeding the threshold value, the third decision section decides that the change of the stable image is a change of the imaging object and does not decide that the change is a failure of the IR illumination section 21. Conversely, in the case where it is decided by the image comparison section 412 that the stable image changes by a great amount exceeding the threshold value therefor and besides it is detected by the change detection section 415 that the change of the stable image is a change in a short period of time shorter than the threshold value, the third decision section decides the change of the stable image arises from a failure of the IR illumination section 21.

It is to be noted that, as a different method by the image comparison section 412 for comparing the brightness of a plurality of stable images, the stable images may be compared without being subdivided similarly as in the case of the first example of the failure decision method in the first embodiment. In particular, for each of stable images to be made a comparison target, a value of an indicator representative of the brightness over an overall stable image may be determined, and such determined indicators may be compared with each other.

<E. Output of Decision Result to Outside>

In the case where one of the first to third decision sections described above decides that a failure occurs with the IR illumination section 21, the decision section 414 in the third configuration example outputs the decision to the transmission controlling section 39. The transmission controlling section 39 outputs the decision result that a failure occurs with the IR illumination section 21 to the terminal apparatus 300 through the external apparatus 290.

<F. Modification>

In the third configuration example of the failure decision section 41, the failure decision section 41 includes the change detection section 415 and detects a change of an image between picked up images included in a picked up image stream inputted from the imaging function section 20.

As a modification to the monitoring sensor apparatus 100, the change detection section 415 may be provided also in the stable image generation section 40 of the monitoring sensor apparatus 100. In this case, the stable image generation section 40 creates a stable image and determines and retains in advance a threshold value that serves as the boundary between a decision that a change of an image occurs abruptly and another decision that a change of an image occurs over an amount of time. Then, the stable image generation section 40 may decide whether the change of a picked up image occurring before each stable image is obtained is a change over an amount of time exceeding the threshold value or occurs in a short period of time shorter than the threshold value, thereby notifying the decision section 414 in the failure decision section 41 of the decision result.

<2-4. Monitoring Sensor Apparatus 100 in which Software Processing is Used>

Before operation by the first to third embodiments of the monitoring sensor apparatus 100 described above is described, various subroutines representative of subdivided operation by the first to third embodiments are described with reference to FIGS. 33 to 42.

<Generation Process of First and Second Picked Up Images>

FIG. 33 is a flow chart illustrating a generation process of first and second picked up images in the case where the first picked up image and the second picked up image are to be compared with each other to decide whether or not there is a failure of the IR illumination section 21 as a first example of a failure decision method by the first embodiment.

At step S1, the IR illumination failure detection section 30 determines a picked up image picked up at first time, an image formed by extracting pixels of the picked up image by thinning or an image formed by resolution conversion of the picked up image as a first picked up image to be used for image comparison.

At step S2, the IR illumination failure detection section 30 determines a picked up image picked up at second time, an image formed by extracting pixels of the picked up image by thinning or an image formed by resolution conversion of the picked up image as a second picked up image to be used for image comparison.

In the first example of the failure decision method by the first embodiment, the first and second picked up images determined in this manner are compared with each other to decide whether or not there is a failure of the IR illumination section 21.

<Generation Process of First and Second Picked Up Images from which Moving Imaging Object is Removed>

Next, FIG. 34 is a flow chart illustrating a generation process of first and second picked up images from which a moving imaging object is removed in the case where a plurality of picked up images from which a moving imaging object is removed are to be compared with each other to decide whether or not there is a failure of the IR illumination section 21 as a second example of a failure decision method by the first embodiment.

At step S11, the IR illumination failure detection section 30 determines an image obtained by deleting a moving imaging object specified by comparing picked up images picked up at first time and time before and after the first time from the picked up image picked up at the first time, an image formed by thinning extraction of pixels of the image obtained by the deletion of the moving imaging object or an image formed by resolution conversion of the image obtained by the deletion of the moving imaging object as a first picked up image to be used for image comparison.

At step S12, the IR illumination failure detection section 30 determines an image obtained by deleting a moving imaging object specified by comparing picked up images picked up at second time and time before and after the second time from the picked up image picked up at the second time, an image formed by thinning extraction of pixels of the image obtained by the deletion of the moving imaging object or an image formed by resolution conversion of the image obtained by the deletion of the moving imaging object as a second picked up image to be used for image comparison.

According to the second example of the failure decision method by the first embodiment, first and second picked up images that are determined in this manner and from which a moving imaging object is removed are compared with each other to decide whether or not there is a failure of the IR illumination section 21.

<Generation Process of First and Second Stable Images>

Next, FIG. 35 is a flow chart illustrating a generation process of first and second stable images by the stable image generation section 40 of the IR illumination failure detection section 30 in the third embodiment.

At step S21, the stable image generation section 40 determines a stable image obtained by monitoring a picked up image stream for a fixed period including first time and collecting data of an imaging object that indicates the least movement and is imaged stably within this period, an image formed by thinning extraction of pixels of the stable image, or an image formed by resolution conversion of the stable image as a first stable image to be used for image comparison.

At step S22, the stable image generation section 40 determines a stable image obtained by monitoring a picked up image stream for a fixed period including second time and collecting data of an imaging object that indicates the least movement and is imaged stably within this period, an image formed by thinning extraction of pixels of the stable image, or an image formed by resolution conversion of the stable image as a second stable image to be used for image comparison.

In the third embodiment, the first and second stable images determined in this manner are compared with each other to decide whether or not there is a failure of the IR illumination section 21.

<Process for Deciding Presence or Absence of Failure of IR Illumination Section 21 Based on Brightness of Plural Picked Up Images>

Next, FIG. 36 is a flow chart illustrating a process for deciding whether or not there is a failure of the IR illumination section 21 on the basis of the brightness of first and second picked up images in the first embodiment.

At step S31, the IR illumination failure detection section 30 calculates an indicator of brightness of an overall image (or an indicator of brightness for each subdivision region) in regard to the first picked up image and the second picked up image.

At step S32, the IR illumination failure detection section 30 decides whether or not the difference between the indicators of brightness of overall images of the first and second picked up images calculated at step S31 (or between the indicators of brightness for each subdivision region) is equal to or greater than a threshold value. In the case where the difference between the images is equal to or greater than the threshold value, the processing is advanced to step S33, at which it is decided that there is a failure in the IR illumination section 21. In contrast, in the case where the difference between the images is smaller than the threshold value, the processing is advanced to step S34, at which it is decided that there is no failure in the IR illumination section 21.

<Report Failure Countermeasure Process>

Next, FIG. 37 is a flow chart illustrating a report failure countermeasure process in the second embodiment.

At step S41, the IR illumination failure detection section 30 acquires an imaging condition and an image processing condition of picked up images (first image and second image) picked up at first time and second time.

At step S42, the IR illumination failure detection section 30 decides whether a change of at least one of the imaging condition and the image processing condition is a change in a direction suitable for imaging of an imaging object of low illuminance and the change amount is equal to or greater than a threshold value. Then, in the case where a result of the decision is in the affirmative, the processing advances to step S43, at which it is decided that there is a failure in the IR illumination section 21. In contrast, in the case where the decision result at step S42 is in the negative, the process at step S43 is skipped.

By performing such a report failure countermeasure process as described above, overlooking of a failure occurring with the IR illumination section 21 can be prevented.

<Misinformation Countermeasure Process>

Next, FIG. 38 is a flow chart illustrating a misinformation countermeasure process in the second embodiment.

At step S51, the IR illumination failure detection section 30 acquires an imaging condition and an image processing condition of picked up images (first image and second image) picked up at first time and second time. It is to be noted that, in the case where the misinformation countermeasure process is performed following the report failure countermeasure process described above, the information acquired at step S41 in the report failure countermeasure process may be diverted.

At step S52, the IR illumination failure detection section 30 decides whether a change of at least one of the imaging condition and the image processing condition is a change in a direction suitable for imaging of an imaging object of high illuminance and the change amount is equal to or greater than a threshold value. Then, in the case where a result of the decision is in the affirmative, the processing is advanced to step S53, at which it is decided that there is no failure in the IR illumination section 21. In contrast, in the case where the decision result at step S52 is in the negative, the process at step S53 is skipped.

By performing such a misinformation countermeasure process as described above, such a situation that it is notified, while a failure does not occur with the IR illumination section 21, that there is a failure can be prevented.

<Time Dependent Deterioration Detection Process>

Next, FIG. 39 is a flow chart illustrating a time dependent deterioration detection process of the IR illumination section 21 in the second embodiment.

At step S61, the IR illumination failure detection section 30 acquires and saves an imaging condition and an image processing condition upon system operation (such conditions are hereafter referred to as first data). At step S62, the IR illumination failure detection section 30 acquires an imaging condition and an image processing condition periodically (such conditions are hereinafter referred to as second data).

At step S63, the IR illumination failure detection section 30 compares the first data and the second data with each other to decide whether or not a change of at least one of the imaging condition and the image processing condition is a change in a direction suitable for imaging of an imaging object of low illuminance and besides the change amount is equal to or greater than a threshold value. In the case where a result of the decision is in the affirmative, the processing advances to step S64, at which it is decided that there is (a failure by) time dependent deterioration in the IR illumination section 21. In contrast, in the case where the decision result at step S63 is in the negative, the process at step S64 is skipped.

By performing the time dependent deterioration detection process described above, a failure of the IR illumination section 21 that occurs little by little over a long period of time, namely, time dependent deterioration, can be detected.

<Process for Deciding Whether or not there is Failure in IR Illumination Section 21 Based on Absolute Value of Brightness of One Picked Up Image>

Next, FIG. 40 is a flow chart illustrating a process for deciding whether or not there is a failure of the IR illumination section 21 on the basis of an absolute value of the brightness of one picked up image.

At step S71, the IR illumination failure detection section 30 compares pixel values of a first picked up image (or a second picked up image) and a threshold value with each other. At step S72, the IR illumination failure detection section 30 decides whether or not pixels having pixel values equal to or lower than the threshold value exist for a fixed region or more. In the case where a result of this decision is in the affirmative, the processing is advanced to step S73, at which it is decided that there is a failure in the IR illumination section 21. In contrast, in the case where the decision result at step S72 is in the negative, the process at step S73 is skipped.

<Process for Deciding Whether or not there is Failure in IR Illumination Section 21 Based on Difference in Characteristic Point Among Plural Stable Images>

Next, FIG. 41 is a flow chart illustrating a process for deciding whether or not there is a failure of the IR illumination section 21 on the basis of a difference in characteristic point between first and second stable images.

At step S81, the decision section 414 decides whether or not the failure decision result by a process at the preceding stage to the present process (for example, by a process for deciding whether or not there is a failure of the IR illumination section 21 on the basis of the brightness of a plurality of picked up images (FIG. 36)) is that there is a failure. In the case where the decision result is in the affirmative, the processing advances to step S82.

At step S82, the characteristic comparison section 413 extracts and compares characteristic points of first and second stable images with each other and notifies a result of the comparison to the decision section 414. At step S83, the comparison section 414 decides whether or not the difference between the characteristic points of the first and second stable images are equal to or greater than a threshold value. In the case where a result of the decision is in the negative, the processing is advanced to step S84, at which it is decided that there is a failure in the IR illumination section 21. In contrast, in the case where the decision result at step S83 is in the affirmative, the processing advances to step S85, at which it is decided that there is no failure in the IR illumination section 21. It is to be noted that, also in the case where the decision result at step S81 is in the negative, the processing is advances to step S85, at which it is decided that there is no failure in the IR illumination section 21.

<Process for Deciding Whether or not there is Failure in IR Illumination Section 21 Based on Speed of Change of Picked Up Image>

Next, FIG. 42 is a flow chart illustrating a process for deciding whether or not there is a failure of the IR illumination section 21 on the basis of the speed of a change of a picked up image.

At step S91, the decision section 414 decides whether or not the failure decision result by a process at the preceding stage to the present process (for example, by the process for deciding whether or not there is a failure of the IR illumination section 21 on the basis of the brightness of a plurality of picked up images (FIG. 36)) is that there is a failure. In the case where a result of the decision is in the affirmative, the processing advances to step S92.

At step S92, the change detection section 415 compares picked up images included in a picked up image stream with each other to detect a change of an image. At step S93, the change detection section 415 decides, on the basis of a result of the detection, whether a change of a stable image inputted from the imaging function section 20 has been generated in a short period of time or generated over a certain amount of time. In the case where a result of the decision is in the affirmative, the processing advances to step S94, at which it is decided that there is a failure in the IR illumination section 21. In contrast, in the case where the decision result at step S93 is in the negative, the processing advances to step S95, at which it is decided that there is no failure in the IR illumination section 21. It is to be noted that, also in the case where the decision result at step S91 is in the negative, the processing is advanced to step S95, at which it is decided that there is no failure in the IR illumination section 21.

<Common Operation by First to Third Embodiments of Monitoring Sensor Apparatus 100>

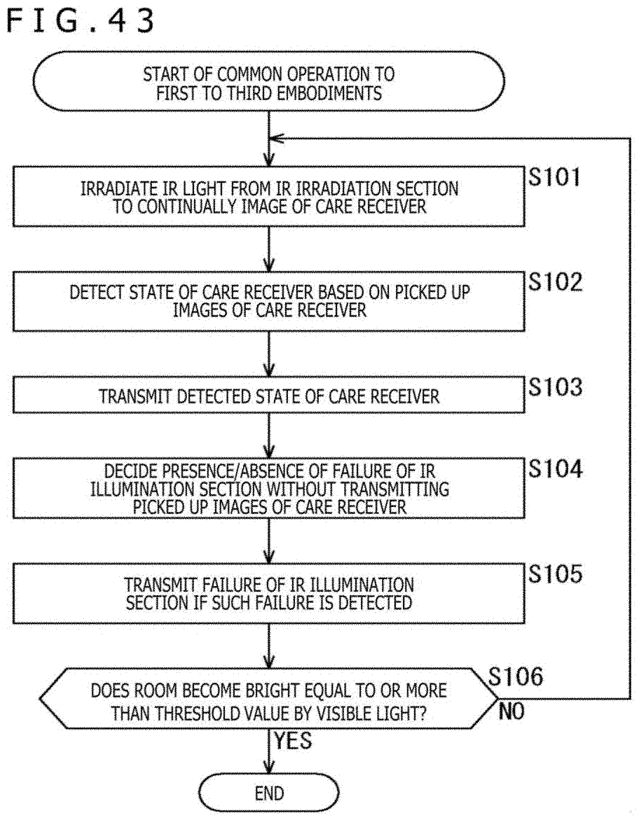

Next, FIG. 43 is a flow chart illustrating common operation by the first to third embodiments of the monitoring sensor apparatus 100. This common operation is started, for example, when the illumination of a room in which a care receiver is turned off.

At step S101, imaging of the room in which the care receiver is started. In particular, the IR illumination section 21 starts irradiation of IR light upon an imaging range 12, and the imaging section 22 successively images the imaging range 12 in accordance with a predetermined frame rate and outputs a moving image stream obtained as a result of the imaging to the image processing section 23. The image processing section 23 performs a predetermined image process for the moving image stream inputted from the imaging section 22 and outputs a result of the image process to the IR illumination failure detection section 30 and the state detection section 38.

At step S102, the state detection section 38 detects a state of the care receiver on the basis of the moving image stream and notifies a result of the detection to the transmission controlling section 39. At step S103, the transmission controlling section 39 notifies the detection result (state of the care receiver) of the state detection section 38 to the external apparatus 290.

At step S104, the IR illumination failure detection section 30 compares a plurality of picked up images included in a picked up image stream outputted from the imaging function section 20 with each other without transmitting the picked up image stream to the external apparatus 290 and the terminal apparatus 300 and decides whether or not there is a failure of the IR illumination section 21 on the basis of a result of the comparison. Then, in the case where it is decided that there is a failure in the IR illumination section 21, the IR illumination failure detection section 30 notifies the decision to the external apparatus 290 and the terminal apparatus 300 through the transmission controlling section 39 at step S105.

At step S106, a visible light illuminance detection section provided in the monitoring sensor apparatus 100 decides whether or not the inside of the room being imaged is made brighter than the threshold value by visible light. In the case where it is decided that the inside of the room being imaged is not brighter than the threshold value by visible light, the processing is returned to step S101 to repeat steps S101 to S106. Thereafter, in the case where it is decided that the inside of the room being imaged becomes brighter than the threshold value by visible light, then the common operation is ended.

<Operation of First Embodiment of Monitoring Sensor Apparatus 100>

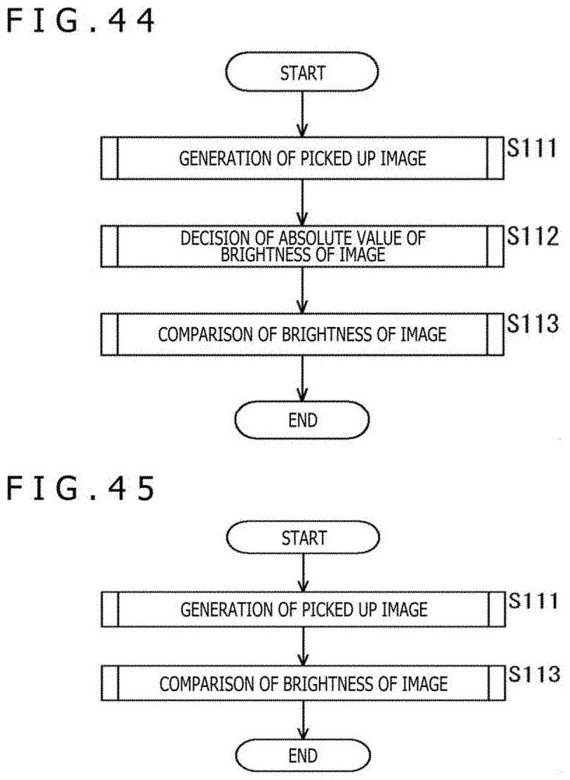

Next, FIG. 44 is a flow chart illustrating operation by the first embodiment of the monitoring sensor apparatus 100 in the process at step S104 of the common operation described above.

At step S111, the imaging function section 20 executes a process for generating a picked up image. Since particulars of the process are such as described hereinabove with reference to FIG. 33 or 34, description of them is omitted.

At step S112, the IR illumination failure detection section 30 executes a process for deciding whether or not there is a failure of the IR illumination section 21 on the basis of the absolute value of the brightness of the picked up image. Since particulars of the process are as described hereinabove with reference to FIG. 40, description of them is omitted.

At step S113, the IR illumination failure detection section 30 executes a process for deciding whether or not there is a failure of the IR illumination section 21 on the basis of the brightness of the picked up image. Since particulars of the process are as described hereinabove with reference to FIG. 36, description of them is omitted.

The description of operation by the first embodiment of the monitoring sensor apparatus 100 in the process at step S104 of the common operation described hereinabove ends therewith.

<Other Operation of First Embodiment of Monitoring Sensor Apparatus 100>

FIG. 45 is a flow chart illustrating other operation by the first embodiment of the monitoring sensor apparatus 100 in the process at step S104 of the common operation described hereinabove.

The other operation depicted in FIG. 45 corresponds to the operation depicted in FIG. 44 from which the process at step S112 is omitted.

The first embodiment of the monitoring sensor apparatus 100 may execute any of the operation depicted in FIG. 44 and the other operation depicted in FIG. 45 in the process at step S104 of the common operation described hereinabove with reference to FIG. 43.

<Operation of Second Embodiment of Monitoring Sensor Apparatus 100>

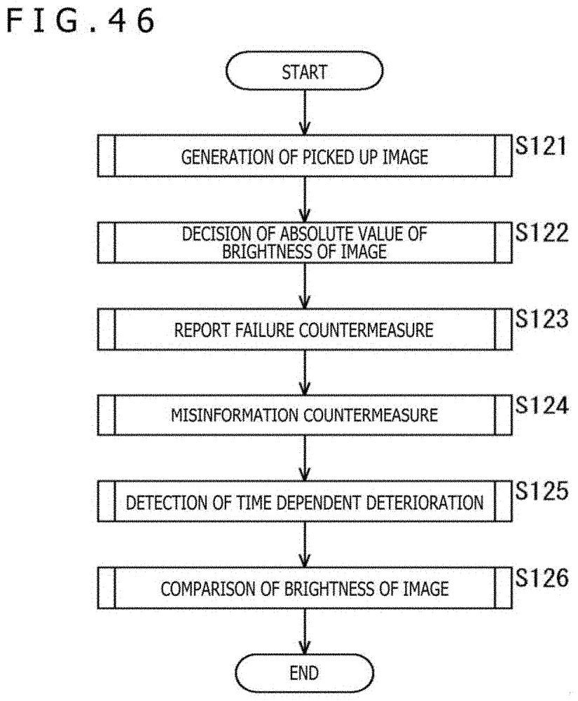

Next, FIG. 46 is a flow chart illustrating operation by the second embodiment of the monitoring sensor apparatus 100 in the process at step S104 of the common operation described hereinabove.

At step S121, the imaging function section 20 executes a process for generating a picked up image. In particular, since the process is such as described hereinabove with reference to FIG. 33 or 34, description of it is omitted.

At step S122, the IR illumination failure detection section 30 executes a process for deciding whether or not there is a failure of the IR illumination section 21 on the basis of the absolute value of the brightness of the picked up image. Since particulars of the process are as described hereinabove with reference to FIG. 40, description of them is omitted.

At step S123, the IR illumination failure detection section 30 executes a report failure countermeasure process. Since particulars of the process are as described hereinabove with reference to FIG. 37, description of them is omitted.

At step S124, the IR illumination failure detection section 30 executes a misinformation countermeasure process. Since particulars of the process are as described hereinabove with reference to FIG. 38, description of them is omitted.

At step S125, the IR illumination failure detection section 30 executes a time dependent deterioration detection process. Since particulars of the process are as described hereinabove with reference to FIG. 39, description of them is omitted.

At step S126, the IR illumination failure detection section 30 executes a process for deciding whether or not there is a failure of the IR illumination section 21 on the basis of the brightness of the picked up image. Since particulars of the process are as described hereinabove with reference to FIG. 36, description of them is omitted.

The description of operation by the second embodiment of the monitoring sensor apparatus 100 in the process at step S104 of the common operation described above ends therewith.

<Other Operation of Second Embodiment of Monitoring Sensor Apparatus 100>

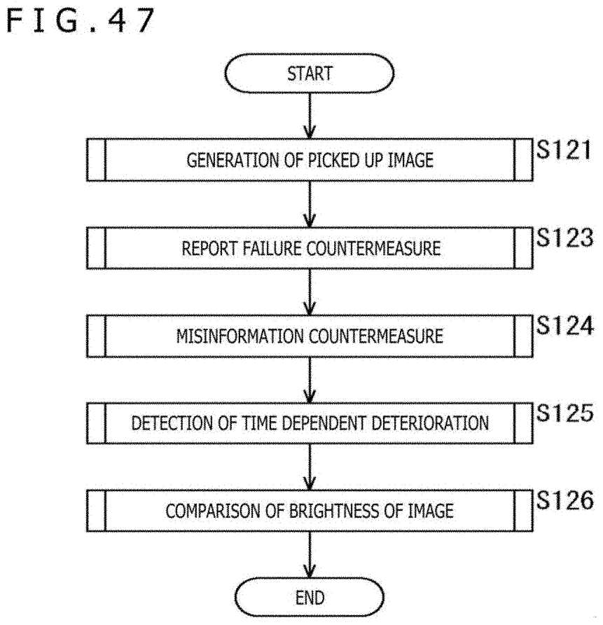

FIG. 47 is a flow chart illustrating other operation by the second embodiment of the monitoring sensor apparatus 100 in the process at step S104 of the common operation described above.

The other operation depicted in FIG. 47 corresponds to the operation depicted in FIG. 46 from which the process at step S122 is omitted.

<Further Operation of Second Embodiment of Monitoring Sensor Apparatus 100>

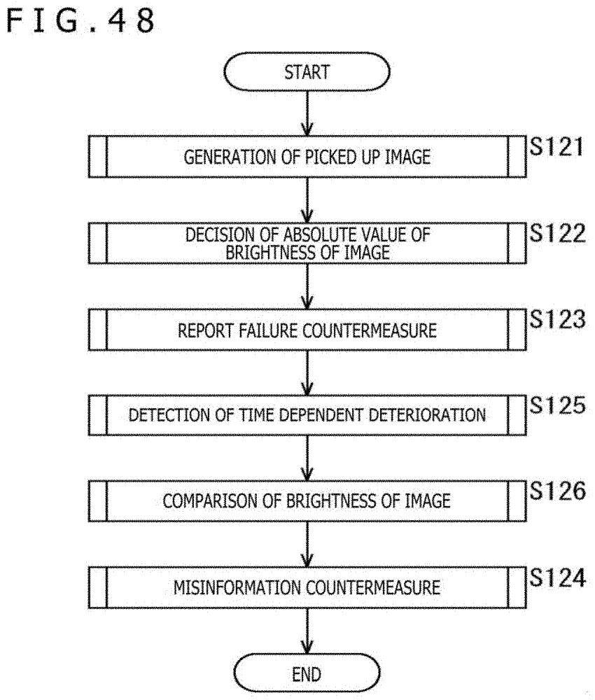

FIG. 48 is a flow chart illustrating further operation by the second embodiment of the monitoring sensor apparatus 100 in the process at step S104 of the common operation described above.

The further operation depicted in FIG. 48 corresponds to the operation depicted in FIG. 46 in which the execution order of the processes at the steps of the operation is changed to the order of S121, S122, S123, S125, S126 and S124.

The second embodiment of the monitoring sensor apparatus 100 may execute, in the process at step S104 of the common operation described hereinabove with reference to FIG. 43, the operation depicted in FIG. 46, the other operation depicted in FIG. 47 or the further operation depicted in FIG. 48.

<Operation in Case where Failure Decision Section 41 in Third Embodiment of Monitoring Sensor Apparatus 100 has First Configuration Example>

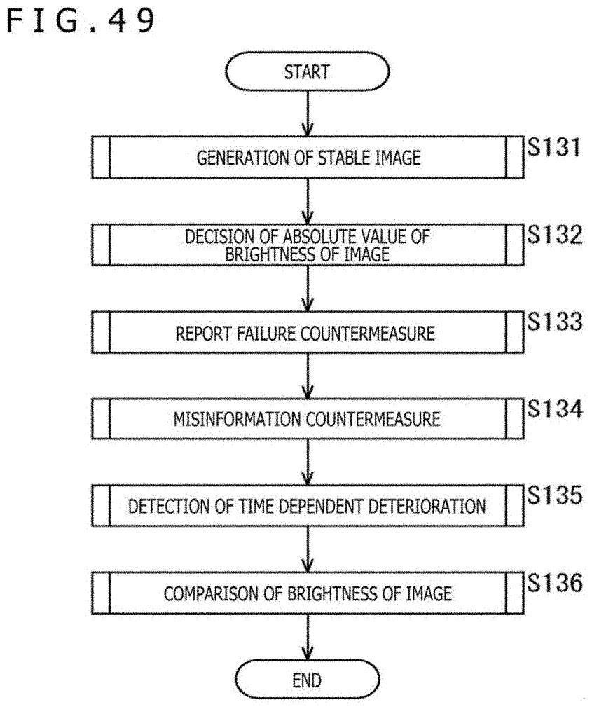

Next, FIG. 49 is a flow chart illustrating operation in the case where the failure decision section 41 in the third embodiment of the monitoring sensor apparatus 100 has the first configuration example in the process at step S104 of the common operation described hereinabove.

At step S131, the stable image generation section 40 executes a process for generating a stable image. Since particulars of the process are as described hereinabove with reference to FIG. 35, description of them is omitted.

At step S132, the IR illumination failure detection section 30 executes a process for deciding whether or not there is a failure of the IR illumination section 21 on the basis of the absolute value of the brightness of the picked up image. Since particulars of the process are as described hereinabove with reference to FIG. 40, description of them is omitted.

At step S133, the IR illumination failure detection section 30 executes a report failure countermeasure process. Since particulars of the process are as described hereinabove with reference to FIG. 37, description of them is omitted.

At step S134, the IR illumination failure detection section 30 executes a misinformation countermeasure process. Since particulars of the process are as described hereinabove with reference to FIG. 38, description of them is omitted.

At step S135, the IR illumination failure detection section 30 executes a time dependent deterioration detection process. Since particulars of the process are as described hereinabove with reference to FIG. 39, description of them is omitted.

At step S136, the IR illumination failure detection section 30 executes a process for deciding whether or not there is a failure of the IR illumination section 21 on the basis of the brightness of a stable image. Since particulars of the process are similar to those described hereinabove with reference to FIG. 36, description of them is omitted.

The description of operation in the case where the failure decision section 41 in the third embodiment of the monitoring sensor apparatus 100 has the first configuration example in the process at step S104 of the common operation described above ends therewith.

<Other Operation in Case where Failure Decision Section 41 in Third Embodiment of Monitoring Sensor Apparatus 100 has First Configuration Example>

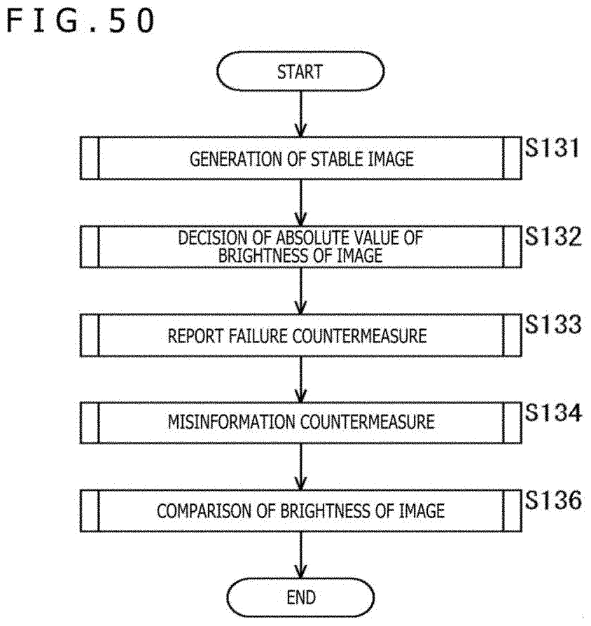

FIG. 50 is a flow chart illustrating other operation in the case where the failure decision section 41 in the third embodiment of the monitoring sensor apparatus 100 has the first configuration example in the process at step S104 of the common operation described hereinabove.

The other operation depicted in FIG. 50 corresponds to the operation depicted in FIG. 49 from which the process at step S135 is omitted.

<Further Operation in Case where Failure Decision Section 41 in Third Embodiment of Monitoring Sensor Apparatus 100 has First Configuration Example>

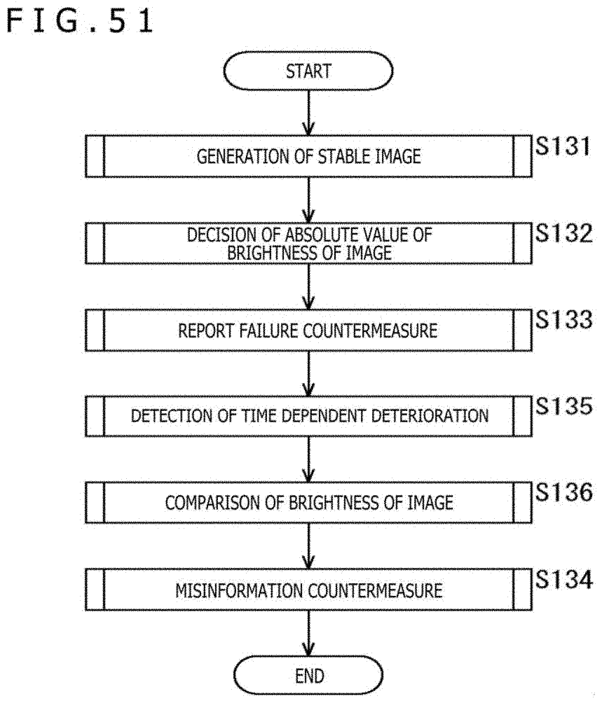

FIG. 51 is a flow chart illustrating further operation in the case where the failure decision section 41 in the third embodiment of the monitoring sensor apparatus 100 has the first configuration example in the process at step S104 of the common operation described above.

The further operation depicted in FIG. 51 corresponds to the operation depicted in FIG. 49 in which the execution order of the processes at the steps of the operation is changed to the order of S131, S132, S133, S135, S136 and S134.

In the case where the failure decision section 41 in the third embodiment of the monitoring sensor apparatus 100 has the first configuration example, the failure decision section 41 may cause execution of, in the process at step S104 of the common operation described hereinabove with reference to FIG. 43, the operation depicted in FIG. 49, the other operation depicted in FIG. 50 or the further operation depicted in FIG. 51.

<Operation in Case where Failure Decision Section 41 in Third Embodiment of Monitoring Sensor Apparatus 100 has Second Configuration Example>

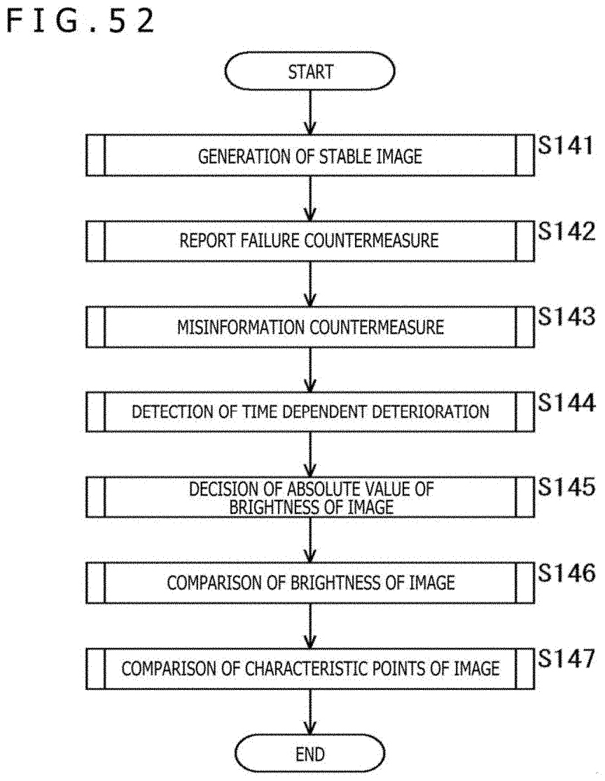

Next, FIG. 52 is a flow chart illustrating operation in the case where the failure decision section 41 in the third embodiment of the monitoring sensor apparatus 100 has the second configuration example in the process at step S104 of the common operation described hereinabove.

At step S141, the stable image generation section 40 executes a process for generating a stable image. Since particulars of the process are as described hereinabove with reference to FIG. 35, description of them is omitted.

At step S142, the IR illumination failure detection section 30 executes a report failure countermeasure process. Since particulars of the process are as described hereinabove with reference to FIG. 37, description of them is omitted.

At step S143, the IR illumination failure detection section 30 executes a misinformation countermeasure process. Since particulars of the process are as described hereinabove with reference to FIG. 38, description of them is omitted.

At step S144, the IR illumination failure detection section 30 executes a time dependent deterioration detection process. Since particulars of the process are as described hereinabove with reference to FIG. 39, description of them is omitted.

At step S145, the IR illumination failure detection section 30 executes a process for deciding whether or not there is a failure of the IR illumination section 21 on the basis of the absolute value of the brightness of a picked up image. Since particulars of the process are as described hereinabove with reference to FIG. 40, description of them is omitted.

At step S146, the IR illumination failure detection section 30 executes a process for deciding whether or not there is a failure of the IR illumination section 21 on the basis of the brightness of a stable image. Since particulars of the process are similar to those described hereinabove with reference to FIG. 36, description of them is omitted.

At step S147, the IR illumination failure detection section 30 executes a process for deciding whether or not there is a failure of the IR illumination section 21 on the basis of the difference between characteristic points of a stable image. Since particulars of the process are similar to those described hereinabove with reference to FIG. 41, description of them is omitted.

The description of operation in the case where the failure decision section 41 in the third embodiment of the monitoring sensor apparatus 100 has the second configuration example in the process at step S104 of the common operation described above ends therewith.

<Other Operation in Case where Failure Decision Section 41 in Third Embodiment of Monitoring Sensor Apparatus 100 has Second Configuration Example>

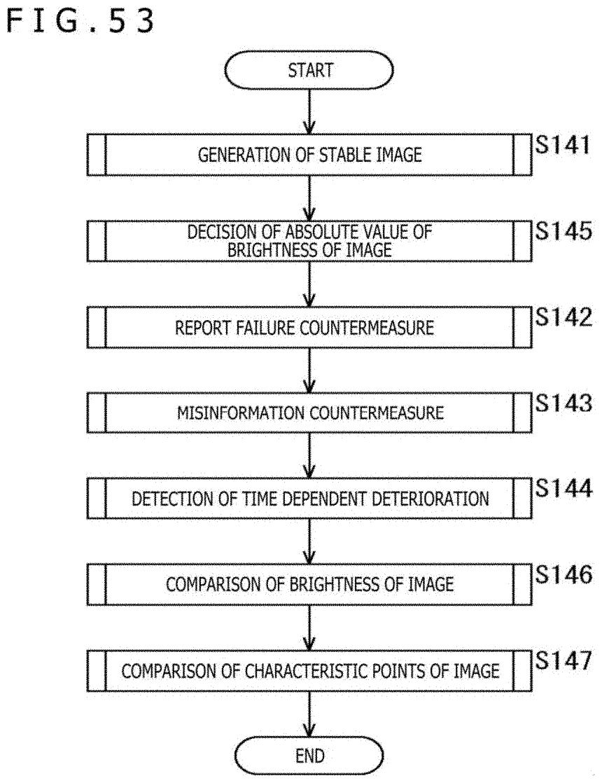

FIG. 53 is a flow chart illustrating other operation in the case where the failure decision section 41 in the third embodiment of the monitoring sensor apparatus 100 has the second configuration example in the process at step S104 of the common operation described hereinabove.

The other operation depicted in FIG. 53 corresponds to the operation depicted in FIG. 52 in which the execution order of the processes at the steps of the operation is changed to the order of S141, S145, S142, S143, S144, S146 and S147.

<Further Operation in Case where Failure Decision Section 41 in Third Embodiment of Monitoring Sensor Apparatus 100 has Second Configuration Example>

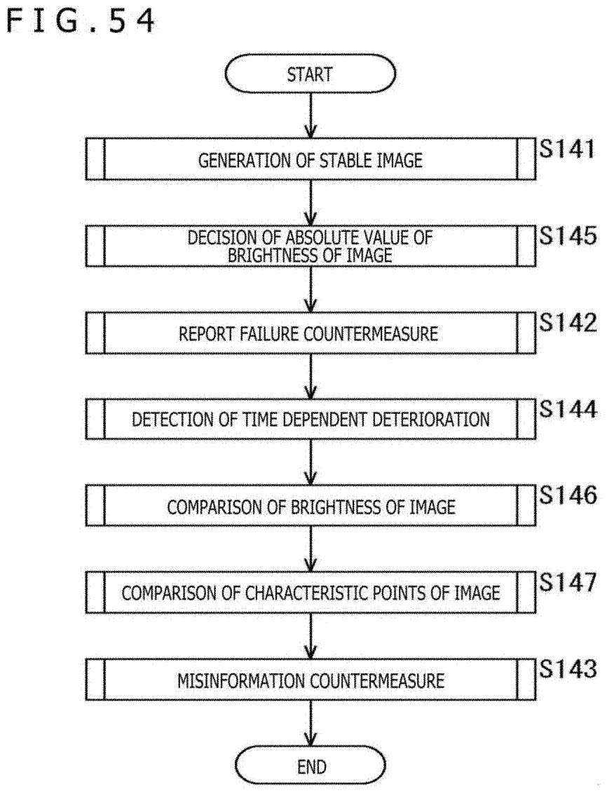

FIG. 54 is a flow chart illustrating further operation in the case where the failure decision section 41 in the third embodiment of the monitoring sensor apparatus 100 has the second configuration example in the process at step S104 of the common operation described above.

The further operation depicted in FIG. 54 corresponds to the operation depicted in FIG. 52 in which the execution order of the processes at the steps of the operation is changed to the order of S141, S145, S142, S144, S146, S147 and S143.

In the case where the failure decision section 41 in the third embodiment of the monitoring sensor apparatus 100 has the second configuration example, the failure decision section 41 may cause execution of, in the process at step S104 of the common operation described hereinabove with reference to FIG. 43, the operation depicted in FIG. 52, the other operation depicted in FIG. 53 or the further operation depicted in FIG. 54.

<Operation in Case where Failure Decision Section 41 in Third Embodiment of Monitoring Sensor Apparatus 100 has Third Configuration Example>

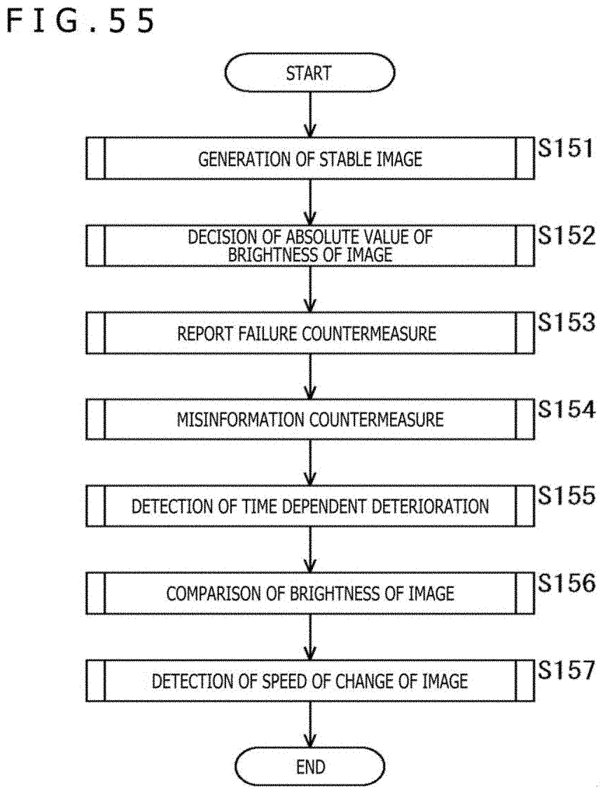

Next, FIG. 55 is a flow chart illustrating operation in the case where the failure decision section 41 in the third embodiment of the monitoring sensor apparatus 100 has the third configuration example in the process at step S104 of the common operation described hereinabove.

At step S151, the stable image generation section 40 executes a process for generating a stable image. Since particulars of the process are as described hereinabove with reference to FIG. 35, description of them is omitted.

At step S152, the IR illumination failure detection section 30 executes a process for deciding whether or not there is a failure of the IR illumination section 21 on the basis of an absolute value of the brightness of a picked up image. Since particulars of the process are as described hereinabove with reference to FIG. 40, description of them is omitted.

At step S153, the IR illumination failure detection section 30 executes a report failure countermeasure process. Since particulars of the process are as described hereinabove with reference to FIG. 37, description of them is omitted.

At step S154, the IR illumination failure detection section 30 executes a misinformation countermeasure process. Since particulars of the process are as described hereinabove with reference to FIG. 38, description of them is omitted.

At step S155, the IR illumination failure detection section 30 executes a time dependent deterioration detection process. Since particulars of the process are as described hereinabove with reference to FIG. 39, description of them is omitted.

At step S156, the IR illumination failure detection section 30 executes a process for deciding whether or not there is a failure of the IR illumination section 21 on the basis of the brightness of a stable image. Since particulars of the process are similar to those described hereinabove with reference to FIG. 36, description of them is omitted.

At step S157, the IR illumination failure detection section 30 executes a process for deciding whether or not there is a failure of the IR illumination section 21 on the basis of the speed of a change of a stable image. Since particulars of the process are similar to those described hereinabove with reference to FIG. 42, description of them is omitted.

The description of operation in the case where the failure decision section 41 in the third embodiment of the monitoring sensor apparatus 100 has the third configuration example in the process at step S104 of the common operation described above ends therewith.

<Other Operation in Case where Failure Decision Section 41 in Third Embodiment of Monitoring Sensor Apparatus 100 has Third Configuration Example>

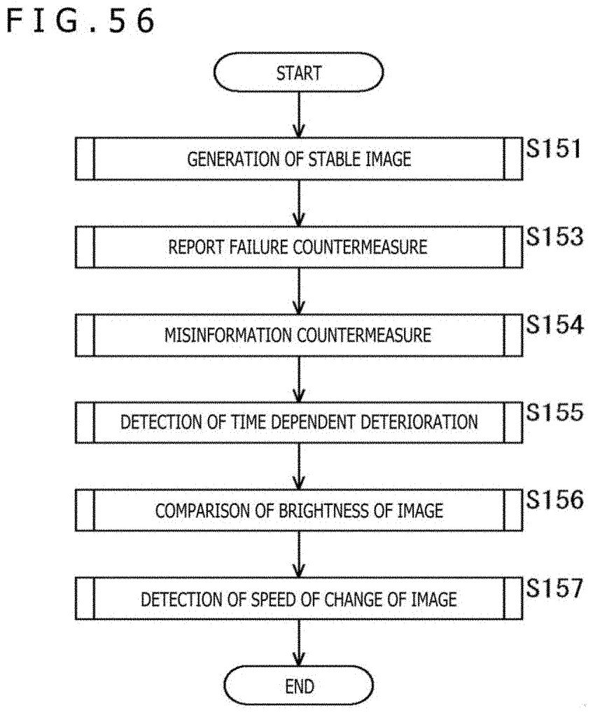

FIG. 56 is a flow chart illustrating other operation in the case where the failure decision section 41 in the third embodiment of the monitoring sensor apparatus 100 has the third configuration example in the process at step S104 of the common operation described hereinabove.

The other operation depicted in FIG. 56 corresponds to the operation depicted in FIG. 55 from which the process at step S152 is omitted.

<Further Operation in Case where Failure Decision Section 41 in Third Embodiment of Monitoring Sensor Apparatus 100 has Third Configuration Example>

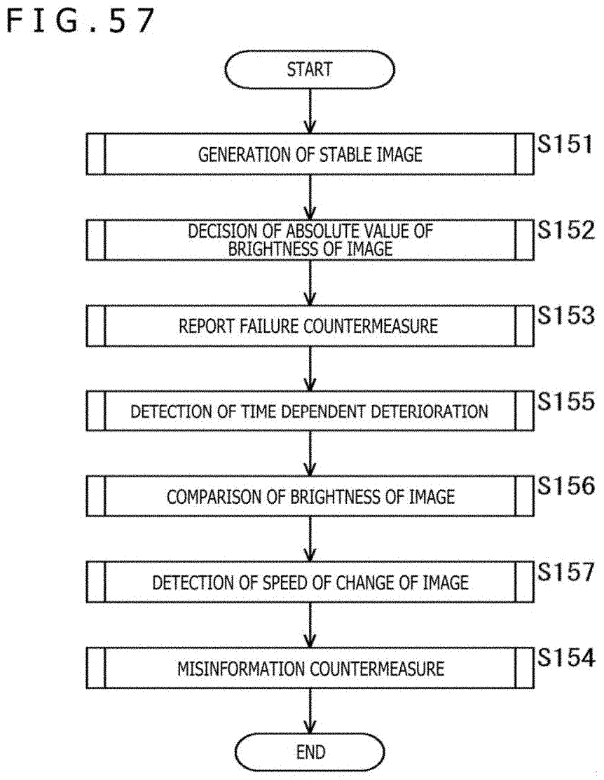

FIG. 57 is a flow chart illustrating further operation in the case where the failure decision section 41 in the third embodiment of the monitoring sensor apparatus 100 has the third configuration example in the process at step S104 of the common operation described above.

The further operation depicted in FIG. 57 corresponds to the operation depicted in FIG. 55 in which the execution order of the processes at the steps of the operation is changed to the order of S151, S152, S153, S155, S156, S157 and S154.

In the case where the failure decision section 41 in the third embodiment of the monitoring sensor apparatus 100 has the third configuration example, the failure decision section 41 may cause execution of, in the process at step S104 of the common operation described hereinabove with reference to FIG. 43, the operation depicted in FIG. 55, the other operation depicted in FIG. 56 or the further operation depicted in FIG. 57.

Incidentally, while the series of processes by the monitoring sensor apparatus 100 described above can be executed by hardware, it may otherwise be executed by software. In the case where the series of processes is executed by software, a program that constructs the software is installed into a computer. Here, the computer includes a computer incorporated in hardware for exclusive use, for example, a personal computer for universal use that can execute various functions by installing various programs, and so forth.

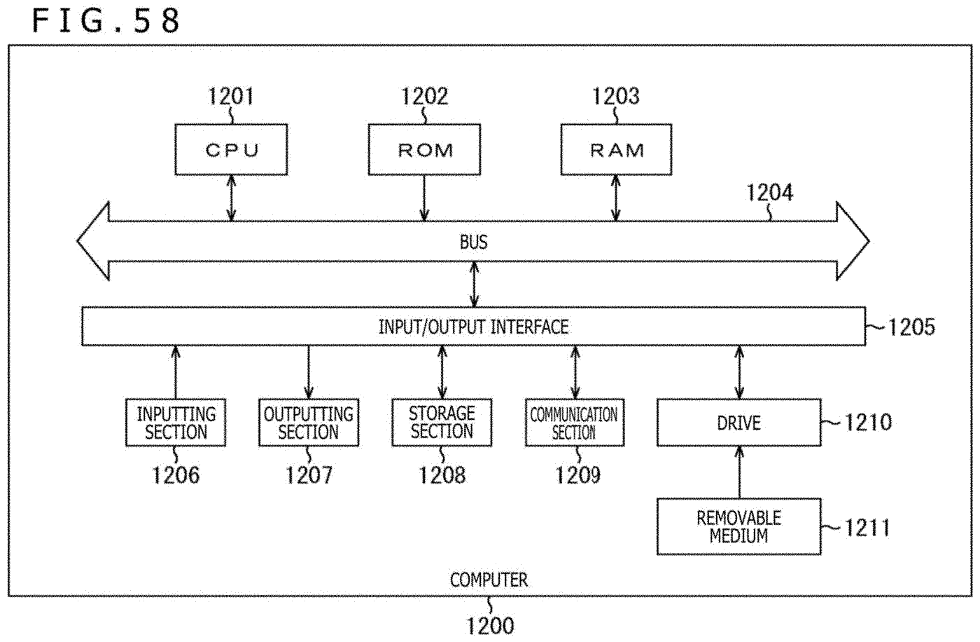

FIG. 58 is a block diagram depicting a configuration example of hardware of a computer that executes the series of processes described hereinabove in accordance with a program.

In the computer 1200, a CPU (Central Processing Unit) 1201, a ROM (Read Only Memory) 1202 and a RAM (Random Access Memory) 1203 are connected to each other by a bus 1204.

To the bus 1204, also an input/output interface 1205 is connected. To the input/output interface 1205, an inputting section 1206, an outputting section 1207, a storage section 1208, a communication section 1209 and a drive 1210 are connected.

The inputting section 1206 is configured, for example, from a keyboard, a mouse, a microphone and so forth. The outputting section 1207 is configured from a display, a speaker and so forth. The storage section 1208 is configured, for example, from a hard disk, a nonvolatile memory and so forth. The communication section 1209 is configured, for example, from a network interface or the like. The drive 1210 drives a removable medium 1211 such as a magnetic disk, an optical disk, a magneto-optical disk, a semiconductor memory or the like.

In the computer 1200 configured in such a manner as described above, the CPU 1201 loads a program stored, for example, in the storage section 1208 into the RAM 1203 through the input/output interface 1205 and the bus 1204 to perform the series of processes described above.

The program that is executed by the computer 1200 (CPU 1201) can be recorded into and provided as the removable medium 1211, for example, as a package medium or the like. Further, the program can be provided through a wired or wireless transmission medium such as a local area network, the Internet, a digital satellite broadcast or the like.

In the computer 1200, the program can be installed into the storage section 1208 through the input/output interface 1205 by loading the removable medium 1211 into the drive 1210. Further, the program can be received by the communication section 1209 through a wired or wireless transmission medium and installed into the storage section 1208. Further, the program can be installed in advance into the ROM 1202 or the storage section 1208.

It is to be noted that the program to be executed by the computer 1200 may be a program whose processes are performed in a time series in accordance with the order described in the present specification or may be a program whose processes are performed in parallel or at a necessary timing such as when it is called.

The embodiment of the present technology is not limited to the embodiments described above but can be changed in various manners without departing from the subject matter of the present technology.

The present technology can assume also such a configuration as described below.

It is to be noted that the present technology can assume also such a configuration as described below.

### (1) (Configuration of Monitoring System, Common to First to Third Embodiments)

A monitoring system, including:

a monitoring sensor apparatus;

a terminal apparatus presenting information acquired by the monitoring sensor apparatus to a user; and

an external apparatus interposed between the monitoring sensor apparatus and the terminal apparatus; in which

the monitoring sensor apparatus includes
an infrared light irradiation section irradiating infrared light to a range within which a monitoring target is capable of existing,
an imaging section having sensitivity to the infrared light and imaging the range within which the monitoring target is capable of existing under the irradiation of the infrared light by the infrared light irradiation section,
a detection section detecting a state of the monitoring target based on the image picked up by the imaging section,
a third transmission controlling section (reference sign 39) including
   a first transmission controlling section controlling presence or absence of execution of first transmission operation for transmitting a result of the detection by the detection section to the external apparatus or the terminal apparatus, and
   a second transmission controlling section controlling presence or absence of execution of second transmission operation for transmitting the image picked up by the imaging section to the external apparatus or the terminal apparatus, and
a failure detection section detecting a failure of the infrared light irradiation section based on a plurality of images picked up by the imaging section and transmits a result of the failure detection to the external apparatus or the terminal apparatus in a state in which execution of the second transmission operation is stopped by the second transmission controlling section.

### (2) (Configuration of Monitoring System, Common to First to Third Embodiments)

The monitoring system according to (1) above, in which

the third transmission controlling section further controls presence or absence of execution of operation for transmitting the result of the failure detection by the failure detection section to the external apparatus or the terminal apparatus.

### (3) (Content to be Monitored by Monitoring System, Common to First to Third Embodiments)

The monitoring system according to (1) or (2) above, in which

the monitoring target is a person who is in a room in which the monitoring sensor apparatus is installed, and

the state is a posture or a physical position of the person.

### (4) (Information to be Transmitted by Monitoring System, Common to First to Third Embodiments)

The monitoring system according to (3) above, in which

the result of the detection to be transmitted to the external apparatus or the terminal apparatus is information of

whether the person of the monitoring target
is in one of a plurality of states defined in advance or
is not in any of the states.

### (5) (Information to be Transmitted by Monitoring System, Common to First to Third Embodiments)

The monitoring system according to (3) above, in which

the result of the detection to be transmitted to the external apparatus or the terminal apparatus is

information of in which one of a plurality of states defined in advance the person of the monitoring target is.

### (6) (Information to be Transmitted by Monitoring System, Common to First to Third Embodiments)

The monitoring system according to (4) or (5) above, in which

one of the states defined in advance is a state in which the person is outside a bed disposed in the room.

### (7) (Information to be Transmitted by Monitoring System, Common to First to Third Embodiments)

The monitoring system according to (4) or (5) above, in which

one of the states defined in advance is a state in which the person is moving in the room.

### (8) (Information to be Transmitted by Monitoring System, Common to First to Third Embodiments)

The monitoring system according to (4) or (5) above, in which

one of the states defined in advance is a state in which the person is a fall state in the room.

### (9) (Configuration Further Included in Monitoring System, Common to First to Third Embodiments)

The monitoring system according to any one of (1) to (8) above, in which

the imaging section has sensitivity also to visible light.

### (10) (Configuration Further Included in Monitoring System, Common to First to Third Embodiments)

The monitoring system according to any one of (1) to (9) above, in which

the monitoring sensor apparatus further includes a visible light illuminance detection section measuring illuminance of visible light within a range that is a target of the imaging.

### (11) (Configuration Further Included in Monitoring System, Common to First to Third Embodiments)

The monitoring system according to (10) above, in which

the result of the detection by the visible light detection section is used for activation or deactivation of the infrared light irradiation section or the failure detection section.

### (12) (Configuration Further Included in Monitoring System, Common to First to Third Embodiments)

The monitoring system according to any one of (1) to (11) above, in which

the monitoring sensor apparatus includes an imaging controlling section performing one of control for activating or deactivating the imaging operation by the imaging section, control of an imaging condition when the imaging is to be performed, or control of a condition for an image process when the image process is to be performed for the picked up image.

### (13) (First Embodiment, Basic Configuration)

The monitoring system according to (12) above, in which

the failure detection section of the monitoring sensor apparatus

detects a failure of the infrared light irradiation section based on a result obtained when brightness of a plurality of images picked up by the imaging section are compared with each other among the plurality of images.

### (14) (First Embodiment, Failure Detection Method)

The monitoring system according to (13) above, in which,

in a case where, as a result when values of an indicator representative of brightness of the plurality of images are compared between the plurality of picked up images, a difference of the indicator representative of the brightness is greater than a threshold value determined in advance, it is detected that a failure occurs with the infrared light irradiation section.

### (15) (First Embodiment, Indicator of Brightness)

The monitoring system according to (13) or (14) above, in which

the comparison of the brightness of the plurality of images is performed by comparison of luminance relating to the plurality of images.

### (16) (First Embodiment, Indicator of Brightness)

The monitoring system according to any one of (13) to (15) above, in which

each of the values of the indicator representative of the brightness of the images

is a value obtained by calculating an average value of the indicator representative of the brightness of each pixel regarding a plurality of pixels included in the image and is an average value of the indicator representative of the brightness of all pixels included in the image.

### (17) (First Embodiment, Indicator of Brightness)

The monitoring system according to any one of (13) to (15) above, in which

each of the values of the indicator representative of the brightness of the images

is a value obtained by calculating an average value of the indicator representative of the brightness of each pixel regarding a plurality of pixels included in the image and is an average value of the indicator representative of the brightness of some pixels extracted from all pixels included in the image.

### (18) (First Embodiment, Indicator of Brightness)

The monitoring system according to any one of (13) to (15) above, in which

each of the values of the indicator representative of the brightness of the images

is a value obtained by calculating an average value of the indicator representative of the brightness of each pixel regarding a plurality of pixels included in an image obtained by converting a resolution of the image and is an average value of the indicator representative of the brightness of all pixels included in the image having the converted resolution.

### (19) (First Embodiment, Indicator of Brightness)

The monitoring system according to any one of (13) to (15) above, in which

each of the values of the indicator representative of the brightness of the images

is a value obtained by calculating an average value of the indicator representative of the brightness of each pixel regarding a plurality of pixels included in an image obtained by converting a resolution of the image and is an average value of the indicator representative of the brightness of some pixels extracted from all pixels included in the image having the converted resolution.

### (20) (First Embodiment, Removal of Moving Imaging Object)

The monitoring system according to any one of (13) to (19) above, in which

the failure detection section of the monitoring sensor apparatus

detects a failure of the infrared light irradiation section based on a result when values of the indicator representative of the brightness of a plurality of images are compared between the plurality of images after a moving imaging object is removed from the images picked up by the imaging section.

### (21) (First Embodiment, Decision of Difference for Each Subdivision Region)

The monitoring system according to any one of (13) to (20) above, in which

the failure detection section of the monitoring sensor apparatus

divides each of a first plurality of picked up images picked up by the imaging section into a second plurality of subdivision regions;

calculates, regarding each of the second plurality of subdivision regions as one image, a value of the indicator representative of the brightness of the image; and

detects a failure of the infrared light irradiation section based on a comparison result when values of the indicator representative of the brightness are compared between the first plurality of picked up images for each of the second plurality of subdivision regions.

### (22) (First Embodiment, Decision of Difference for Each Subdivision Region)

The monitoring system according to (21) above, in which

it is detected that a failure occurs with the infrared light irradiation section in a case where a result when values of the indicator representative of the brightness are compared between the first plurality of picked up images for each of the second plurality of subdivision regions indicates that a difference of the indicator representative of the brightness is greater than a threshold value determined in advance in one of the second plurality of subdivision regions.

(23) (Second Embodiment, Basic Configuration=Information Inputting from Imaging Controlling Section)

The monitoring system according to any one of (12) to (22) above, in which

the monitoring sensor apparatus

has a structure that inputs information from the imaging controlling section to the failure detection section.

(24) (Second Embodiment, Failure Detection Based on Information from Imaging Controlling Section)

The monitoring system according to (23) above, in which

the failure detection section of the monitoring sensor apparatus

detects a failure of the infrared light irradiation section based on information from the imaging controlling section.

(25) (Second Embodiment, Failure Detection Based on Information from Imaging Controlling Section)

The monitoring system according to (24) above, in which

the failure detection section of the monitoring sensor apparatus

detects a failure of the infrared light irradiation section based on a result of comparison when comparison of

an imaging condition when the imaging is performed or a condition for an image process when the image process is performed for the picked up image

is performed between a plurality of images picked up by the imaging section.

### (26) (Second Embodiment, Report Failure Countermeasure)

The monitoring system according to (25) above, in which

the failure detection section of the monitoring sensor apparatus

detects that there is a failure in the infrared light irradiation section in a case where at least one of the imaging condition of a plurality of images picked up by the imaging section or the image processing condition when the image process is applied to the picked up images varies in a direction suitable for an imaging object of lower illuminance.

### (27) (Second Embodiment, Report Failure Countermeasure, Failure Detection Based on Imaging Condition by Imaging Controlling Section)

The monitoring system according to (26) above, in which

the imaging condition is exposure time used for image pickup of the image, imaging sensitivity called ISO sensitivity when the image is picked up, or a size of an aperture when the image is picked up.

### (28) (Second Embodiment, Report Failure Countermeasure, Failure Detection Based on Imaging Condition by Imaging Controlling Section)

The monitoring system according to (27) above, in which

the failure detection section of the monitoring sensor apparatus

detects that there is a failure in the infrared light irradiation section in a case where the exposure time changes in an increasing direction, where the opening of the aperture changes in an increasing direction in size, or where the imaging sensitivity called ISO sensitivity changes in an increasing direction as an imaging condition between a plurality of images picked up by the imaging section.

### (29) (Second Embodiment, Report Failure Countermeasure, Failure Detection Based on Image Processing Condition by Imaging Controlling Section)

The monitoring system according to (26) above, in which

the condition of the image process is a magnitude of a gain to be applied to the picked up image.

### (30) (Second Embodiment, Report Failure Countermeasure, Failure Detection Based on Image Processing Condition by Imaging Controlling Section)

The monitoring system according to (29) above, in which

the failure detection section of the monitoring sensor apparatus

detects that there is a failure in the infrared light irradiation section in a case where the gain to be applied to the picked up image changes in an increasing direction as an image processing condition between a plurality of images picked up by the imaging section.

### (31) (Second Embodiment, Misinformation Countermeasure)

The monitoring system according to (25) above, in which

the failure detection section of the monitoring sensor apparatus

detects that there is no failure in the infrared light irradiation section in a case where at least one of an imaging condition and an image processing condition of a plurality of images picked up by the imaging section changes in a direction suitable for an imaging object of higher illuminance.

### (32) (Second Embodiment, Misinformation Countermeasure, Failure Detection Based on Imaging Condition by Imaging Controlling Section)

The monitoring system according to (31) above, in which

the imaging condition is exposure time used in image pickup of an image, imaging sensitivity called ISO sensitivity when the image is picked up, or a magnitude of an aperture when the image is picked up.

### (33) (Second Embodiment, Misinformation Countermeasure, Failure Detection Based on Imaging Condition by Imaging Controlling Section)

The monitoring system according to (32) above, in which

the failure detection section of the monitoring sensor apparatus

detects that there is no failure in the infrared light irradiation section in a case where the exposure time changes in a decreasing direction, where the opening of the aperture changes in a decreasing direction in size, or where the imaging sensitivity called ISO sensitivity changes in a decreasing direction as an imaging condition between a plurality of images picked up by the imaging section.

### (34) (Second Embodiment, Misinformation Countermeasure, Failure Detection Based on Image Processing Condition by Imaging Controlling Section)

The monitoring system according to (31) above, in which the condition of the image process is a magnitude of a gain to be applied to the picked up image.

### (35) (Second Embodiment, Misinformation Countermeasure, Failure Detection Based on Image Processing Condition by Imaging Controlling Section)

The monitoring system according to (34) above, in which

the failure detection section of the monitoring sensor apparatus

detects that there is a failure in the infrared light irradiation section in a case where the gain to be applied to the picked up image changes in a decreasing direction as an image processing condition between a plurality of images picked up by the imaging section.

### (36) (Second Embodiment, Detection of Time Dependent Deterioration)

The monitoring system according to (25) above, in which

the failure detection section of the monitoring sensor apparatus compares,

between an image picked up by the imaging section at specific date and time set in advance and images picked up periodically later,

at least one of an imaging condition when the image pickup is performed or a condition of an image process when the image process is applied to the picked up image and detects that there is a failure in the infrared light irradiation section in a case where at least one of the imaging condition and the image processing condition changes in a direction suitable for an imaging object of low illuminance.

### (37) (Second Embodiment, Detection of Time Dependent Deterioration)

The monitoring system according to (36) above, in which

the specific date and time is time of day determined in advance on the first day when the system operates.

### (38) (Third Embodiment, Basic Configuration=Stable Image Generation Section)

The monitoring system according to (12) above, in which

the monitoring sensor apparatus further includes a generation section generating a stable image.

### (39) (Third Embodiment, Basic Configuration=Stable Image Generation Section)

The monitoring system according to (38) above, in which

the stable image is an image of an imaging object that indicates a small amount of movement and is imaged stably among images of a picked up image stream picked up for a fixed period by the imaging section.

### (40) (Third Embodiment, Failure Detection Method) (Corresponding to First Embodiment (13))

The monitoring system according to (39) above, in which

the failure detection section of the monitoring sensor apparatus

detects a failure of the infrared light irradiation section based on a result obtained when brightness of a plurality of stable images generated by the stable image generation section are compared with each other among the plurality of stable images.

### (41) (Third Embodiment, Failure Detection Method) (Corresponding to First Embodiment (14))

The monitoring system according to (40) above, in which,

in a case where, as a result when values of an indicator representative of brightness of the plurality of stable images are compared between the plurality of stable images, a difference of the indicator representative of the brightness is greater than a threshold value determined in advance, it is detected that a failure occurs with the infrared light irradiation section.

### (42) (Third Embodiment, Indicator of Brightness) (Corresponding to First Embodiment (15))

The monitoring system according to (40) or (41) above, in which

the comparison of the brightness of the plurality of stable images is performed by comparison of luminance relating to the plurality of stable images.

### (43) (Third Embodiment, Indicator of Brightness) (Corresponding to First Embodiment (16))

The monitoring system according to any one of (40) to (42) above, in which

each of the values of the indicator representative of the brightness of the stable images

is a value obtained by calculating an average value of the indicator representative of the brightness of each pixel regarding a plurality of pixels included in the stable image and is an average value of the indicator representative of the brightness of all pixels included in the stable image.

### (44) (Third Embodiment, Indicator of Brightness) (Corresponding to First Embodiment (17))

The monitoring system according to any one of (40) to (42) above, in which

each of the values of the indicator representative of the brightness of the stable images

is a value obtained by calculating an average value of the indicator representative of the brightness of each pixel regarding a plurality of pixels included in the stable image and is an average value of the indicator representative of the brightness of some pixels extracted from all pixels included in the stable image.

### (45) (Third Embodiment, Indicator of Brightness) (Corresponding to First Embodiment (18))

The monitoring system according to any one of (40) to (42) above, in which

each of the values of the indicator representative of the brightness of the stable images

is a value obtained by calculating an average value of the indicator representative of the brightness of each pixel regarding a plurality of pixels included in an image obtained by converting a resolution of the stable image and is an average value of the indicator representative of the brightness of all pixels included in the image having the converted resolution.

### (46) (Third Embodiment, Indicator of Brightness) (Corresponding to First Embodiment (19))

The monitoring system according to any one of (40) to (42) above, in which

each of the values of the indicator representative of the brightness of the stable images

is a value obtained by calculating an average value of the indicator representative of the brightness of each pixel regarding a plurality of pixels included in an image obtained by converting a resolution of the stable image and is an average value of the indicator representative of the brightness of some pixels extracted from all pixels included in the image having the converted resolution.

### (47) (Third Embodiment, Decision of Difference for Each Subdivision Region) (Corresponding to First Embodiment (21))

The monitoring system according to any one of (40) to (46) above, in which

the failure detection section of the monitoring sensor apparatus

divides each of a first plurality of stable images generated by the stable image generation section into a second plurality of subdivision regions;

calculates, regarding each of the second plurality of subdivision regions as one image, a value of the indicator representative of the brightness of the image; and

detects a failure of the infrared light irradiation section based on a comparison result when values of the indicator representative of the brightness are compared between the first plurality of stable images for each of the second plurality of subdivision regions.

### (48) (Third Embodiment, Decision of Difference for Each Subdivision Region) (Corresponding to First Embodiment (22))

The monitoring system according to (47) above, in which

it is detected that a failure occurs with the infrared light irradiation section in a case where a result when values of the indicator representative of the brightness are compared between the first plurality of stable images for each of the second plurality of subdivision regions indicates that a difference of the indicator representative of the brightness is greater than a threshold value determined in advance in one of the second plurality of subdivision regions.

(49) (Third Embodiment, Information Inputting from Imaging Controlling Section) (Corresponding to Second Embodiment (23))

The monitoring system according to any one of (40) to (48) above, in which

the monitoring sensor apparatus

further has a structure that inputs information from the imaging controlling section to the failure detection section.

(50) (Third Embodiment, Failure Detection Based on Information from Imaging Controlling Section) (Corresponding to Second Embodiment (24))

The monitoring system according to (49) above, in which

the failure detection section of the monitoring sensor apparatus

detects a failure of the infrared light irradiation section based on information from the imaging controlling section.

(51) (Third Embodiment, Failure Detection Based on Information from Imaging Controlling Section) (Corresponding to Second Embodiment (25))

The monitoring system according to (50) above, in which

the failure detection section of the monitoring sensor apparatus

detects a failure of the infrared light irradiation section based on a result of comparison when comparison of an imaging condition when image pickup of each image included in a picked up image stream based on which the stable image is created is performed or a condition for an image process when the image process is performed for the picked up image

is performed between a plurality of stable images generated by the stable image generation section.

### (52) (Third Embodiment, Report Failure Countermeasure) (Corresponding to Second Embodiment (26))

The monitoring system according to (51) above, in which

the failure detection section of the monitoring sensor apparatus

detects that there is a failure in the infrared light irradiation section in a case where at least one of an imaging condition when image pickup of each image included in a picked up image stream based on which the stable image is created is performed or a condition for an image process when the image process is applied to the picked up image varies in a direction suitable for an imaging object of low illuminance.

### (53) (Third Embodiment, Report Failure Countermeasure, Failure Detection Based on Imaging Condition by Imaging Controlling Section) (Corresponding to Second Embodiment (27))

The monitoring system according to (52) above, in which

the imaging condition is exposure time used for image pickup of the image, imaging sensitivity called ISO sensitivity when the image is picked up, or a size of an aperture when the image is picked up.

### (54) (Third Embodiment, Report Failure Countermeasure, Failure Detection Based on Imaging Condition by Imaging Controlling Section) (Corresponding to Second Embodiment (28))

The monitoring system according to (53) above, in which

the failure detection section of the monitoring sensor apparatus

detects that there is a failure in the infrared light irradiation section,

in a case where the exposure time changes in an increasing direction, where the opening of the aperture changes in an increasing direction in size, or where the imaging sensitivity called ISO sensitivity changes in an increasing direction as an imaging condition when image pickup of each image included in a picked up image stream based on which the stable image is created is performed, between a plurality of stable images generated by the stable image generation section.

### (55) (Third Embodiment, Report Failure Countermeasure, Failure Detection Based on Image Processing Condition by Imaging Controlling Section) (Corresponding to Second Embodiment (29))

The monitoring system according to (52) above, in which

the condition of the image process is a magnitude of a gain to be applied to the picked up image.

### (56) (Third Embodiment, Report Failure Countermeasure, Failure Detection Based on Image Processing Condition by Imaging Controlling Section) (Corresponding to Second Embodiment (30))

The monitoring system according to (55) above, in which

the failure detection section of the monitoring sensor apparatus

detects that there is a failure in the infrared light irradiation section in a case where, between a plurality of stable images generated by the stable image generation section, the gain to be applied to each image changes in an increasing direction as a condition for an image process when the image process is applied to each image included in a picked up image stream based on which the stable image is created.

### (57) (Third Embodiment, Misinformation Countermeasure) (Corresponding to Second Embodiment (31))

The monitoring system according to (51) above, in which

the failure detection section of the monitoring sensor apparatus

detects that there is no failure in the infrared light irradiation section in a case where at least one of an imaging condition when pickup of each image included in a picked up image stream based on which the stable image is created is performed or a condition for an image process when the image process is applied to the picked up images changes in a direction suitable for an imaging object of high illuminance.

### (58) (Third Embodiment, Misinformation Countermeasure, Failure Detection Based on Imaging Condition by Imaging Controlling Section) (Corresponding to Second Embodiment (32))

The monitoring system according to (57) above, in which

the imaging condition is exposure time used in image pickup of an image, imaging sensitivity called ISO sensitivity when the image is picked up, or a magnitude of an aperture when the image is picked up.

### (59) (Third Embodiment, Misinformation Countermeasure, Failure Detection Based on Imaging Condition by Imaging Controlling Section) (Corresponding to Second Embodiment (33))

The monitoring system according to (58) above, in which

the failure detection section of the monitoring sensor apparatus

detects that there is no failure in the infrared light irradiation section,

in a case where the exposure time changes in a decreasing direction, where the opening of the aperture changes in a decreasing direction in size, or where the imaging sensitivity called ISO sensitivity changes in a decreasing direction as an imaging condition when image pickup of each image included in a picked up image stream based on which the stable image is created is performed, between a plurality of stable images generated by the stable image generation section.

### (60) (Third Embodiment, Misinformation Countermeasure, Failure Detection Based on Image Processing Condition by Imaging Controlling Section) (Corresponding to Second Embodiment (34))

The monitoring system according to (57) above, in which

the condition of the image process is a magnitude of a gain to be applied to the picked up image.

### (61) (Third Embodiment, Misinformation Countermeasure, Failure Detection Based on Image Processing Condition by Imaging Controlling Section) (Corresponding to Second Embodiment (35))

The monitoring system according to (60) above, in which

the failure detection section of the monitoring sensor apparatus

detects that there is no failure in the infrared light irradiation section in a case where, between a plurality of stable images generated by the stable image generation section, as a condition for an image process when the image process is applied to each image included in a picked up image stream based on which the stable image is created, the gain to be applied to the images changes in a decreasing direction.

### (62) (Third Embodiment, Detection of Time Dependent Deterioration) (Corresponding to Second Embodiment (36))

The monitoring system according to (51) above, in which

the failure detection section of the monitoring sensor apparatus compares,

between a stable image generated by the stable image generation section at specific date and time set in advance and stable images generated periodically later by the stable image generation section,

at least one of an imaging condition when the image pickup of each image included in a picked up image stream based on which the stable image is created is performed or a condition of an image process when the image process is applied to the picked up image, and

detects that there is a failure in the infrared light irradiation section in a case where at least one of the imaging condition and the image processing condition changes in a direction suitable for an imaging object of low illuminance.

### (63) (Third Embodiment, Time Dependent Deterioration) (Corresponding to Second Embodiment (37))

The monitoring system according to (62) above, in which

the specific date and time is time of day determined in advance on the first day when the system operates.

### (64) (Third Embodiment, First Configuration Example, Third Threshold Value)

The monitoring system according to any one of (38) to (51) above, in which

the failure detection section of the monitoring sensor apparatus

includes a threshold value determined in advance for the brightness of the stable image, and

detects, in a case where the value of the indicator representative of the brightness of the stable image generated by the stable image generation section is lower than the threshold value, that a failure occurs with the infrared light irradiation section.

### (65) (Third Embodiment, First Configuration Example, Decision Method by Failure Decision Section)

The monitoring system according to any one of (38) to (51) above, in which

the failure detection section of the monitoring sensor apparatus detects, based on

a result when values of the indicator representative of the brightness of stable images generated by the stable image generation section are compared with a first threshold value determined in advance,

a comparison result when, between a plurality of stable images generated by the stable image generation section, the brightness of the plurality of stable images are compared, and

a comparison result when, between the plurality of stable images for which the comparison is to be performed, an imaging condition of each of images included in a picked up image stream based on which the plurality of stable images are created or a condition for an image process when the image process is applied to each of the images is compared,

that a failure occurs with the infrared light irradiation section in any of

A) a case in which the value of the indicator indicative of the brightness of each of the stable images is lower than the first threshold value determined in advance,

B) a case in which one of the imaging condition of each of the images or the condition for the image process is changing in a direction suitable for imaging of an imaging object of lower illuminance, and

C) a case in which a result when the values of the indicator representative of the brightness of the stable images are compared indicates that a difference of the indicator representative of the brightness is greater than a second threshold value determined in advance and besides none of the imaging condition of each of the images and the condition for the image process is changing in a direction suitable for imaging of an imaging object of higher illuminance.

### (66) (Third Embodiment, Second Configuration Example, Characteristic Point)

The monitoring system according to any one of (38) to (51) above, in which

the monitoring sensor apparatus further includes

a characteristic comparison section extracting, from each of the stable images, a characteristic of an imaging object in the stable image and detects a failure of the infrared light irradiation section based on a result when the characteristic is compared between a plurality of stable images.

### (67) (Third Embodiment, Second Configuration Example, Characteristic Point)

The monitoring system according to (66) above, in which

the characteristic of the imaging object is a contour of the imaging object.

### (68) (Third Embodiment, Second Configuration Example, Decision Method by Decision Section)

The monitoring system according to (66) or (67) above, in which

the failure detection section of the monitoring sensor apparatus detects, based on

a result when values of the indicator representative of the brightness of stable images generated by the stable image generation section are compared with a first threshold value determined in advance,

a comparison result when, between a plurality of stable images generated by the stable image generation section, the brightness of the plurality of stable images are compared,

a comparison result when, between the plurality of stable images for which the comparison is to be performed, an imaging condition of each of images included in a picked up image stream based on which the plurality of stable images are created or a condition for an image process when the image process is applied to each of the images is compared, and

a comparison result when characteristics of an imaging object in the stable images are extracted from the stable images and compared between the plurality of stable images,

that a failure occurs with the infrared light irradiation section in any of

A) a case in which the value of the indicator indicative of the brightness of each of the stable images is lower than the first threshold value determined in advance,

B) a case in which one of the imaging condition of each of the images or the condition for the image process is changing in a direction suitable for imaging of an imaging object of lower illuminance,

C) a case in which a result when the values of the indicator representative of the brightness of the stable images are compared indicates that a difference of the indicator representative of the brightness is greater than a second threshold value determined in advance and besides none of the imaging condition of each of the images and the condition for the image process is changing in a direction suitable for imaging of an imaging object of higher illuminance, and

D) a case in which the result when the values of the indicator representative of the brightness of the stable images are compared indicate that the difference of the indicator representative of the brightness does not arise from a change of the characteristic points of the stable images.

### (69) (Third Embodiment, Third Configuration Example, Change Speed)

The monitoring system according to any one of (38) to (51) above, in which

the monitoring sensor apparatus

further includes a change detection section detecting how much time is required for occurrence of a change of the imaging object, which occurs between a latest stable image and a second latest stable image outputted from the stable image generation section.

### (70) (Third Embodiment, Third Configuration Example, Decision Method by Decision Section)

The monitoring system according to (69) above, in which

the failure detection section of the monitoring sensor apparatus detects, based on

a result when values of the indicator representative of the brightness of stable images generated by the stable image generation section are compared with a first threshold value determined in advance,

a comparison result when, between a plurality of stable images generated by the stable image generation section, the brightness of the plurality of stable images are compared,

a comparison result when, between the plurality of stable images for which the comparison is to be performed, an imaging condition of each of images included in a picked up image stream based on which the plurality of stable images are created or a condition for an image process when the image process is applied to each of the images is compared, and

a result when it is detected how much time is required for occurrence of a change of the imaging object, which occurs between the latest stable image and the second latest stable image outputted from the stable image generation section and the time is compared with a threshold value for a period of time for a change determined in advance,

that a failure occurs with the infrared light irradiation section in any of

A) a case in which the value of the indicator indicative of the brightness of each of the stable images is lower than the first threshold value determined in advance,

B) a case in which one of the imaging condition of each of the images or the condition for the image process is changing in a direction suitable for imaging of an imaging object of lower illuminance,

C) a case in which a result when the values of the indicator representative of the brightness of the stable images are compared indicates that a difference of the indicator representative of the brightness is greater than a second threshold value determined in advance and besides none of the imaging condition of each of the images and the condition for the image process is changing in a direction suitable for imaging of an imaging object of higher illuminance, and

D) a case in which the change of the imaging object, which occurs between the latest stable image and the second latest stable image occurs in a short period of time than the threshold value for a period of time for a change determined in advance.

### (71) (First Operation Mode)

The monitoring system according to any one of (1) to (70) above, in which

the first transmission controlling section of the monitoring sensor apparatus

causes first transmission operation to be executed in a first operation mode, the first transmission operation transmitting a detection result of the detection section or a detection result of the failure detection section to the external apparatus or the terminal apparatus.

### (72) (Second Operation Mode)

The monitoring system according to any one of (1) to (71) above, in which

the second transmission controlling section of the monitoring sensor apparatus

causes sound to be transmitted to and from the external apparatus or the terminal apparatus in a second operation mode.

### (73) (Third Operation Mode)

The monitoring system according to any one of (1) to (72) above, in which

the second transmission controlling section of the monitoring sensor apparatus

causes second transmission operation to be executed in a third operation mode, the second transmission operation transmitting the image picked up by the imaging section to the external apparatus or the terminal apparatus.

### (74) (Fourth Operation Mode)

The monitoring system according to any one of (1) to (73) above, in which

the second transmission controlling section of the monitoring sensor apparatus

causes the image picked up by the imaging section and accumulated to be transmitted to the external apparatus or the terminal apparatus in a fourth operation mode.

### (75) (Transition of Operation Mode)

The monitoring system according to any one of (72) to (74) above, in which

the operation mode is caused to transition from the first operation mode to an operation mode different from the first operation mode taking execution of the first transmission operation in the first operation mode, in which a detection result of the detection section or a detection result of the failure detection section is transmitted to the monitoring sensor apparatus the external apparatus or the terminal apparatus, as a trigger.

### (76) (Monitoring Sensor Apparatus)

A monitoring sensor apparatus, including:

an infrared light irradiation section irradiating infrared light to a range within which a monitoring target is capable of existing;

an imaging section having sensitivity to the infrared light and imaging the range within which the monitoring target is capable of existing under the irradiation of the infrared light by the infrared light irradiation section;

a detection section detecting a state of the monitoring target based on the image picked up by the imaging section;

a first transmission controlling section controlling presence or absence of execution of first transmission operation for transmitting a result of the detection by the detection section to a different apparatus;

a second transmission controlling section controlling presence or absence of execution of second transmission operation for transmitting the image picked up by the imaging section to the different apparatus; and

a failure detection section detecting a failure of the infrared light irradiation section based on a comparison result when a plurality of images picked up by the imaging section are compared in a state in which execution of the second transmission operation is stopped by the second transmission controlling section.

### (77) (Method)

A monitoring method of a monitoring sensor apparatus, including, by the monitoring sensor apparatus:

an infrared light irradiation step of irradiating infrared light to a range within which a monitoring target is capable of existing;

an imaging step of having sensitivity to the infrared light and imaging the range within which the monitoring target is capable of existing under the irradiation of the infrared light by the infrared light irradiation section;

a detection step of detecting a state of the monitoring target based on the image picked up by the imaging step;

a first transmission controlling step of controlling presence or absence of execution of first transmission operation for transmitting a result of the detection by the detection section to a different apparatus;

a second transmission controlling step of controlling presence or absence of execution of second transmission operation for transmitting the image picked up by the imaging section to the different apparatus; and

a failure detection step of detecting a failure of the infrared light irradiation section based on a comparison result when a plurality of images picked up by the imaging step are compared in a state in which execution of the second transmission operation is stopped by the second transmission controlling step.

### (78) (Program)

A program causing a computer to function as:

an infrared light irradiation section irradiating infrared light to a range within which a monitoring target is capable of existing;

an imaging section having sensitivity to the infrared light and imaging the range within which the monitoring target is capable of existing under the irradiation of the infrared light by the infrared light irradiation section;

a detection section detecting a state of the monitoring target based on the image picked up by the imaging section;

a first transmission controlling section controlling presence or absence of execution of first transmission operation for transmitting a result of the detection by the detection section to a different apparatus;

a second transmission controlling section controlling presence or absence of execution of second transmission operation for transmitting the image picked up by the imaging section to the different apparatus; and

a failure detection section detecting a failure of the infrared light irradiation section based on a comparison result when a plurality of images picked up by the imaging section are compared in a state in which execution of the second transmission operation is stopped by the second transmission controlling section.

### REFERENCE SIGNS LIST

20 Imaging function section, 21 IR illumination section, 22 Imaging section, 23 Image processing section, 24 Imaging controlling section, 30 IR illumination failure detection section, 37 Storage section, 38 State detection section, 39 Transmission controlling section, 40 Stable image generation section, 41 Failure decision section, 100 Monitoring sensor apparatus, 280 Information transmission section, 290 External apparatus, 300 Terminal apparatus, 200 Imaging range, 400 Subdivision region, 411 Image storage section, 412 Image comparison section, 413 Characteristic comparison section, 414 Decision section, 415 Change detection section, 1000 Monitoring system, 1200 Computer

1. A monitoring system, comprising:
a monitoring sensor apparatus;
a terminal apparatus presenting information acquired by the monitoring sensor apparatus to a user; and
an external apparatus interposed between the monitoring sensor apparatus and the terminal apparatus; wherein
the monitoring sensor apparatus includes
an infrared light irradiation section irradiating infrared light to a range within which a monitoring target is capable of existing,
an imaging section having sensitivity to the infrared light and imaging the range within which the monitoring target is capable of existing under the irradiation of the infrared light by the infrared light irradiation section,
a detection section detecting a state of the monitoring target based on the image picked up by the imaging section,
a third transmission controlling section including
a first transmission controlling section controlling presence or absence of execution of first transmission operation for transmitting a result of the detection by the detection section to the external apparatus or the terminal apparatus, and
a second transmission controlling section controlling presence or absence of execution of second transmission operation for transmitting the image picked up by the imaging section to the external apparatus or the terminal apparatus, and
a failure detection section detecting a failure of the infrared light irradiation section based on a plurality of images picked up by the imaging section in a state in which execution of the second transmission operation is stopped by the second transmission controlling section.

2. The monitoring system according to claim 1, wherein
the third transmission controlling section further controls presence or absence of execution of operation for transmitting a result of the failure detection by the failure detection section to the external apparatus or the terminal apparatus.

3. The monitoring system according to claim 2, wherein
the monitoring sensor apparatus further includes an imaging controlling section performing at least one of
control for activating or deactivating the imaging operation by the imaging section,
control of an imaging condition when the imaging is to be performed by the imaging section, or
control of a condition for an image process when
the image process is to be performed for the picked up image.

4. The monitoring system according to claim 3, wherein
the monitoring sensor apparatus has a structure that inputs information from the imaging controlling section to the failure detection section.

5. The monitoring system according to claim 4, wherein
the failure detection section of the monitoring sensor apparatus detects a failure of the infrared light irradiation section based on information from the imaging controlling section.

6. The monitoring system according to claim 5, wherein
the monitoring sensor apparatus further includes a stable image generation section, and
the stable image generation section compares, in regard to a plurality of picked up images included in a picked up image stream picked up for a fixed period by the imaging section, a change of imaging objects in the picked up images between the images and outputs a stable image that is an image including an imaging object that indicates a smaller amount of change.

7. The monitoring system according to claim 6, wherein
the imaging controlling section performs control of an imaging condition when the imaging section performs imaging and besides the failure detection section compares, between a plurality of stable images outputted from the stable image generation section, imaging conditions when image pickup of each of images included in a picked up image stream on which the stable images are based is performed and detects a failure of the infrared light irradiation section based on a result of the comparison,
or
the imaging controlling section performs control of an image processing condition when an image process is applied to an image picked up by the imaging section and besides the failure detection section compares, between a plurality of stable images outputted from the stable image generation section, conditions of the image process applied to each of images included in a picked up image stream on which the stable images are based and detects a failure of the infrared light irradiation section based on a result of the comparison.

8. The monitoring system according to claim 7, wherein
the imaging controlling section performs control of an imaging condition when the imaging section performs imaging and besides the failure detection section detects that a failure occurs with the infrared light irradiation section in a case where, between a plurality of stable images outputted from the stable image generation section, an imaging condition when image pickup of each of images included in a picked up image stream on which the stable images are based is performed changes in a direction suitable for an imaging object of lower illuminance,
or
the imaging controlling section performs control of an image processing condition when an image process is applied to an image picked up by the imaging section and besides the failure detection section detects that a failure occurs with the infrared light irradiation section in a case where, between a plurality of stable images outputted from the stable image generation section, a condition for the image process applied to each of images included in a picked up image stream on which the stable images are based changes in a direction suitable for an imaging object of lower illuminance.

9. The monitoring system according to claim 8, wherein
the failure detection section detects a failure of the infrared light irradiation section based
on a result when, between a first plurality of stable images outputted from the stable image generation section, brightness of the first plurality of stable images are compared or
on a result when each of the first plurality of stable images outputted from the stable image generation section is divided into a second plurality of subdivision regions and, for each of the second plurality of subdivision regions, brightness of images included in the subdivision region are compared.

10. The monitoring system according to claim 9, wherein
the failure detection section detects that a failure occurs with the infrared light irradiation section
in a case where, between a first plurality of stable images outputted from the stable image generation section, brightness of the first plurality of stable images are compared and a result of the comparison indicates that a difference of an indicator representative of the brightness is greater than a threshold value determined in advance or
in a case where each of the first plurality of stable images outputted from the stable image generation section is divided into a second plurality of subdivision regions and, for each of the second plurality of subdivision regions, brightness of images included in the subdivision region are compared, and a result of the comparison indicates that a difference of the indicator representative of the brightness is greater than a threshold value determined in advance.

11. The monitoring system according to claim 10, wherein
the failure detection section detects that a failure occurs with the infrared light irradiation section in a case where, in regard to a stable image outputted from the stable image generation section, a value of the indicator representative of the brightness of the stable image is lower than a threshold value determined in advance.

12. The monitoring system according to claim 11, wherein
the failure detection section detects, based on
a result when values of the indicator representative of the brightness of stable images outputted by the stable image generation section are compared with a first threshold value determined in advance,
a comparison result when, between a plurality of stable images outputted by the stable image generation section, the brightness of the plurality of stable images are compared, and
a comparison result when, between the plurality of stable images for which the comparison is to be performed, an imaging condition of each of images included in a picked up image stream on which the plurality of stable images are based or a condition for an image process when the image process is applied to each of the images is compared,
that a failure occurs with the infrared light irradiation section in a case where at least one of conditions (A) to (C) given below is satisfied:
condition (A) the value of the indicator indicative of the brightness of each of the stable images is lower than the first threshold value determined in advance;
condition (B) at least one of the imaging condition of each of the images or the condition for the image process is changing in a direction suitable for an imaging object of lower illuminance; and
condition (C) a result when the values of the indicator representative of the brightness of the stable images are compared indicates that a difference of the indicator representative of the brightness is greater than a second threshold value determined in advance and besides any of the imaging condition of each of the images and the condition for the image process is not changing in a direction suitable for an imaging object of higher illuminance.

13. The monitoring system according to claim 10, wherein
the monitoring sensor apparatus further includes
a characteristic comparison section extracting, from each of the stable images, a characteristic of an imaging object in the stable image and comparing the characteristic between a plurality of the stable images.

14. The monitoring system according to claim 13, wherein
the characteristic of the imaging object is a contour of the imaging object.

15. The monitoring system according to claim 14, wherein
the failure detection section detects, based on
a result when values of the indicator representative of the brightness of stable images outputted by the stable image generation section are compared with a first threshold value determined in advance,
a comparison result when, between a plurality of stable images outputted by the stable image generation section, the brightness of the plurality of stable images are compared,
a comparison result when, between the plurality of stable images for which the comparison is to be performed, an imaging condition of each of images included in a picked up image stream on which the plurality of stable images are based or a condition for an image process when the image process is applied to each of the images is compared, and
a result when, from each of the stable images, a characteristic of an imaging object in the stable image is extracted and the characteristic is compared between the plurality of stable images,
that a failure occurs with the infrared light irradiation section in a case where at least one of conditions (A) to (C) given below is satisfied:
condition (A) the value of the indicator indicative of the brightness of each of the stable images is lower than the first threshold value determined in advance;
condition (B) at least one of the imaging condition of each of the images or the condition for the image process is changing in a direction suitable for an imaging object of lower illuminance; and
condition (C) a result when the values of the indicator representative of the brightness of the stable images are compared indicates that a difference of the indicator representative of the brightness is greater than a second threshold value determined in advance and besides any of the imaging condition of each of the images and the condition for the image process is not changing in a direction suitable for an imaging object of higher illuminance and the difference of the indicator representative of the brightness does not arise from a change of a characteristic point of the stable images.

16. The monitoring system according to claim 10, wherein
the monitoring sensor apparatus further includes a change detection section detecting how much time is required for occurrence of a change of the imaging object, which occurs between a latest stable image and a second latest stable image outputted from the stable image generation section.

17. The monitoring system according to claim 16, wherein
the failure detection section detects, based on
a result when values of the indicator representative of the brightness of stable images outputted by the stable image generation section are compared with a first threshold value determined in advance,
a comparison result when, between a plurality of stable images outputted by the stable image generation section, the brightness of the plurality of stable images are compared,
a comparison result when, between the plurality of stable images for which the comparison is to be performed, an imaging condition of each of images included in a picked up image stream on which the plurality of stable images are based or a condition for an image process when the image process is applied to each of the images is compared, and
a result when it is detected how much time is required for occurrence of a change of the imaging object, which occurs between the latest stable image and the second latest stable image outputted from the stable image generation section and the time is compared with a threshold value for a period of time for a change determined in advance,
that a failure occurs with the infrared light irradiation section in a case where at least one of conditions (A) to (C) given below is satisfied:
condition (A) the value of the indicator indicative of the brightness of each of the stable images is lower than the first threshold value determined in advance;
condition (B) at least one of the imaging condition of each of the images or the condition for the image process is changing in a direction suitable for an imaging object of lower illuminance; and
condition (C) a result when the values of the indicator representative of the brightness of the stable images are compared indicates that a difference of the indicator representative of the brightness is greater than a second threshold value determined in advance and besides any of the imaging condition of each of the images and the condition for the image process is not changing in a direction suitable for an imaging object of higher illuminance and a change of an imaging object occurring between the latest stable image and the second latest stable image occurs in a shorter period of time than the threshold value for the change time.

18. A monitoring sensor apparatus comprising:
an infrared light irradiation section irradiating infrared light to a range within which a monitoring target is capable of existing;
an imaging section having sensitivity to the infrared light and imaging the range within which the monitoring target is capable of existing under the irradiation of the infrared light by the infrared light irradiation section;
a detection section detecting a state of the monitoring target based on the image picked up by the imaging section;
a first transmission controlling section controlling presence or absence of execution of first transmission operation for transmitting a result of the detection by the detection section to a different apparatus;
a second transmission controlling section controlling presence or absence of execution of second transmission operation for transmitting the image picked up by the imaging section to the different apparatus; and
a failure detection section detecting a failure of the infrared light irradiation section based on a comparison result when a plurality of images picked up by the imaging section are compared in a state in which execution of the second transmission operation is stopped by the second transmission controlling section.

19. A monitoring method of a monitoring sensor apparatus, comprising, by the monitoring sensor apparatus:
an infrared light irradiation step of irradiating infrared light to a range within which a monitoring target is capable of existing;
an imaging step of having sensitivity to the infrared light and imaging the range within which the monitoring target is capable of existing under the irradiation of the infrared light by the infrared light irradiation section;
a detection step of detecting a state of the monitoring target based on the image picked up by the imaging step;
a first transmission controlling step of controlling presence or absence of execution of first transmission operation for transmitting a result of the detection by the detection section to a different apparatus;
a second transmission controlling step of controlling presence or absence of execution of second transmission operation for transmitting the image picked up by the imaging section to the different apparatus; and
a failure detection step of detecting a failure of the infrared light irradiation section based on a comparison result when a plurality of images picked up by the imaging step are compared in a state in which execution of the second transmission operation is stopped by the second transmission controlling step.

20. A program causing a computer to function as:
an infrared light irradiation section irradiating infrared light to a range within which a monitoring target is capable of existing;
an imaging section having sensitivity to the infrared light and imaging the range within which the monitoring target is capable of existing under the irradiation of the infrared light by the infrared light irradiation section;
a detection section detecting a state of the monitoring target based on the image picked up by the imaging section;
a first transmission controlling section controlling presence or absence of execution of first transmission operation for transmitting a result of the detection by the detection section to a different apparatus;
a second transmission controlling section controlling presence or absence of execution of second transmission operation for transmitting the image picked up by the imaging section to the different apparatus; and
a failure detection section detecting a failure of the infrared light irradiation section based on a comparison result when a plurality of images picked up by the imaging section are compared in a state in which execution of the second transmission operation is stopped by the second transmission controlling section.
